(19) United States
(12) Patent Application Publication
(10) Pub. No.: US 2002/0050518 A1
(43) Pub. Date: May 2, 2002

(54) Sensor array

(76) Inventor: Alexander R. Roustaei, La Jolla, CA (US)

Correspondence Address: Mitchell P. Brook, Baker & McKenzie, 101 Broadway, 12th Floor, San Diego, CA, 92101, US

(21) Appl. No.: 09/776,340

(22) Filed: Feb. 2, 2001

Related U.S. Application Data
(62) Division of application No. 09/208,284, filed on Dec. 8, 1998.
Application No. 09/208,284 is a continuation-in-part of application No. 09/073,501, filed on May 5, 1998, now Pat. No. 6,123,261.
(60) Provisional application No. 60/067,913, filed on Dec. 8, 1997.
(60) Provisional application No. 60/070,043, filed on Dec. 30, 1997.
(60) Provisional application No. 60/072,418, filed on Jan. 24, 1998.

(51) Int. Cl. G06K 7/10; G06K 7/14

(52) U.S. Cl. 235/454

(57) ABSTRACT

An integrated system and method for reading image data. An optical scanner/image reader is provided for Grabbing Images, Storing Data And/Or Decoding Optical Information or Code, Including One And Two Dimensional Symbologies, At Variable depth Of Field, Featuring “On-Chip” Intelligent Including Sensor And Processing.

### BACKGROUND OF THE INVENTION

Industries such as assembly processing, grocery and food processing, transportation, and multimedia utilize an identification system in which the products are marked with an widths, or other type of symbols consisting of series of contrasting markings. These codes are generally known as two-dimensional symbologies. A number of different optical code readers and laser scanning systems are capable of decoding the optical pattern and translating it into a multiple digit representation for inventory, production tracking, check out or sales. Some optical reading devices are also capable of taking pictures and displaying, storing, or transmitting real time images to another system.

Optical readers or scanners are available in a variety of configurations. Some are built into a fixed scanning station while others are portable. Portable optical reading devices provide a number of advantages, including the ability to take inventory of products on shelves and to track items such as files or small equipment. A number of these portable reading devices incorporate laser diodes to scan the symbology at variable distances from the surface on which the optical code is imprinted. Laser scanners are expensive to manufacture, however, and can not reproduce the image of the targeted area by the sensor, thereby limiting the field of use of optical code reading devices. Additionally, laser scanners typically require a raster scanning technique to read and decode a two dimensional optical code.

Another type of optical code reading device is known as a scanner or imager. These devices use light emitting diodes (“LEDs”) as a light source and charge coupled devices (“CCDs”) or Complementary Metal Oxide Silicon (“CMOS”) sensors as detectors. This class of scanners or imagers is generally known as “CCD scanners” or “CCD imagers.” Common types of CCD scanners take a picture of the optical code and store the image in a frame memory. The image is then scanned electronically, or processed using software to convert the captured image into an output signal.

One type of CCD scanner is disclosed in earlier patents of the present inventor, Alexander Roustaei. These patents include U.S. Pat. Nos. 5,291,009, 5,349,172, 5,354,977, 5,532,467, and 5,627,358. While known CCD scanners have the advantage of being less expensive to manufacture, the scanners produced prior to these inventions were typically limited by requirements that the scanner either contact the surface on which the optical code was imprinted or maintain a distance of no more than one and one-half inches away from the optical code. This created a further limitation that the scanner could not read optical codes larger than the window or housing width of the reading device. The CCD scanner disclosed in U.S. Pat. No. 5,291,009 and subsequent patents descending from it introduced the ability to read symbologies which are wider than the physical width and height of the scanner housing at distances as much as twenty inches from the scanner or imager.

Considerable attention has been directed toward the scanning of two-dimensional symbologies, which can store about 100 times more information than a one-dimensional symbology occupying the same space. In two-dimensional symbologies, rows of lines and spaces either stack upon each other or form matrices of black and white squares and rectangular or hexagon cells. The symbologies or optical codes are read by scanning a laser across each row in the case of stacked symbology, or in a zigzag pattern in the case of matrix symbology. A disadvantage of this technique is the risk of loss of vertical synchronization due to the time required to scan the entire optical code. A second disadvantage is its requirement of a laser for illumination and moving part for generating the zigzag pattern. This makes the scanner more expensive and less reliable due to mechanical parts.

CCD sensors containing an array of more than 500×500 active pixels, each smaller or equal to 12 micrometer square, have also been developed with progressive scanning techniques. However, there is still a need for machine vision, multimedia and digital imagers and other imaging devices capable of better and faster image grabbing(or capturing) and processing.

Various camera-on-a-chip products are believed to include image sensors with on-chip analog-to-digital converters (“ADCs”), digital signal processing (“DSP”) and timing and clock generator. A known camera-on-a-chip system is the single-chip NTSC color camera, known as model no. VV6405 from VLSI Vision, Limited (San Jose, Calif.).

In all types of optical codes, whether one-dimensional, two-dimensional or even three-dimensional (multi-color superimposed symbologies), the performance of the optical system needs to be optimized to provide the best possible results with respect to resolution, signal-to-noise ratio, contrast and response. These and other parameters can be controlled by selection of, and adjustments to, the optical system's components, including the lens system, the wavelength of illuminating light, the optical and electronic filtering, and the detector sensitivity.

Applied to two-dimensional symbologies, known raster laser scanning techniques require a large amount of time and image processing power to capture the image and process it. This also requires increased microcomputer memory and a faster duty-cycle processor. Further, known raster laser scanners require costly high-speed processing chips that generate heat and occupy space.

### SUMMARY OF THE INVENTION

In its preferred embodiment, the present invention is an integrated system, capable of scanning target images and then processing those images during the scanning process. An optical scanning head includes one or more LEDs mounted on the sides of an imaging device's nose. The imaging device can be on a printed circuit board to emit light at different angles. These LEDs then create a diverging beam of light.

A progressive scanning CCD is provided in which data can be read one line after another and stored in the memory or register, providing simultaneous Binary and Multi-bit data. At the same time, the image processing apparatus identifies both the area of interest, and the type and nature of the optical code or information that exists within the frame.

The present invention provides an optical reading device for reading both optical codes and one or more one- or two-dimensional symbologies contained within a target image field. This field has a first width, wherein said optical reading device includes at least one printed circuit board with a front edge of a second width and an illumination means for projecting an incident beam of light onto said target image field, using a coherent or incoherent light, in visible or invisible spectrum. The optical reading device also includes: an optical assembly, comprising a plurality of lenses disposed along an optical path for focusing reflected light at a focal plane; a sensor within said optical path, including a plurality of pixel elements for sensing illumination level of said focused light; processing means for processing said sensed target image to obtain an electrical signal proportional to said illumination levels; and output means for converting said electrical signal into output data. This output data describes a Multi-bit illumination level for each pixel element that is directly related to discrete points within the target image field, while the processing means is capable of communicating with either a host computer or other unit designated to use the data collected and or processed by the optical reading device. Machine-executed means, the memory in communication with the processor, and the glue logic for controlling the optical reading device, process the targeted image onto the sensor to provide decoded data, and raw, stored or life images of the optical image targeted onto the sensor.

An optical scanner or imager is provided for reading optically encoded information or symbols. This scanner or imager can be used to take pictures. Data representing these pictures is stored in the memory of the device and/or can be transmitted to another receiving unit by a communication means. For example, a data line or network can connect the scanner or imager with a receiving unit. Alternatively, a wireless communications link or a magnetic media may be used.

Individual fields are decoded and digitally scanned back onto the image field. This increases throughput speed of reading symbologies. High speed sorting is one area where fast throughput is desirable as it involves processing symbologies containing information (such as bar codes or other symbologies) on packages moving at speeds of 200 feet per minute or higher.

A light source, such as LED, ambient, or flash light is also used in conjunction with specialized smart sensors. These sensors have on-chip signal processing capability to provide raw picture data, processed picture data, or decoded information contained in a frame. Thus, an image containing information, such as a symbology, can be located at any suitable distance from the reading device.

The present invention provides an optical reading device that can capture in a single snapshot and decode one or more than one of one-dimensional and/or two-dimensional symbols, optical codes and images. It also provides an optical reading device that decodes optical codes (such as symbologies) having a wide range of feature sizes. The present invention also provides an optical reading device that can read optical codes omnidirectionally. All of these components of an optical reading device, can be included in a single chip (or alternatively multiple chips) having a processor, memory, memory buffer, ADC, and image processing software in an ASIC or FPGA.

Numerous advantages are achieved by the present invention. For example, the optical reading device can efficiently use the processor's (i.e. the microcomputer's) memory and other integrated sub-systems, without excessively burdening its central processing unit. It also draws a relatively lower amount of power than separate components would use.

Another advantage is that processing speed is enhanced, while still achieving good quality in the image processing. This is achieved by segmenting an image field into a plurality of images.

As understood herein, the term “optical reading device” includes any device that can read or record an image. An optical reading device in accordance with the present invention can include a microcomputer and image processing software, such as in an ASIC or FPGA.

Also as understood herein, the term “image” includes any form of optical information or data, such as pictures, graphics, bar codes, other types of symbologies, or optical codes, or “glyphs” for encoding machine readable data onto any information containing medium, such as paper, plastics, metal, glass and so on.

These and other features and advantages of the present invention will be appreciated from review of the following detailed description of the invention and the accompanying figures in which like reference numerals refer to like parts throughout.

### BRIEF DESCRIPTION OF THE DRAWINGS

FIG. 1 is a block diagram illustrating an embodiment of an optical scanner or imager in accordance with the present invention;

FIG. 2 illustrates a target to be scanned in accordance with the present invention;

FIG. 3 illustrates image data corresponding to the target, in accordance with the present invention;

FIG. 4 is a simplified representation of a conventional pixel arrangement on a sensor;

FIG. 5 is a diagram of an embodiment in accordance with the present invention;

FIG. 6 illustrates an example of a floating threshold curve used in an embodiment of the present invention;

FIG. 7 illustrates an example of vertical and horizontal line threshold values, such as used in conjunction with mapping a floating threshold curve surface, as illustrated in FIG. 6 in accordance with the present invention;

FIG. 8 is a diagram of an apparatus in accordance with the present invention;

FIG. 9 is a circuit diagram of an apparatus in accordance with the present invention;

FIG. 10 illustrates clock signals as used in an embodiment of the present invention;

FIG. 11 illustrates illumination sources in accordance with the present invention;

FIG. 12 illustrates a laser light illumination pattern and apparatus, using a holographic diffuser, in accordance with the present invention;

FIG. 13 illustrates a framing locator mechanism utilizing a beam splitter and a mirror or diffractive optical element that produces two spots in accordance with the present invention;

FIG. 14 illustrates a generated pattern of a frame locator in accordance with the present invention;

FIG. 15 illustrates a generalized pixel arrangement for a foveated sensor in accordance with the present invention;

FIG. 16 illustrates a generalized pixel arrangement for a foveated sensor in accordance with the present invention;

FIG. 17 illustrates a side slice of a CCD sensor and a back-thinned CCD in accordance with the present invention;

FIG. 18 illustrates a flow diagram in accordance with the present invention;

FIG. 19 illustrates an embodiment showing a system on a chip in accordance with the present invention;

FIG. 20 illustrates multiple storage devices in accordance with an embodiment of the present invention;

FIG. 21 illustrates multiple coils in accordance with the present invention;

FIG. 22 shows a radio frequency activated chip in accordance with the present invention;

FIG. 23 shows batteries on a chip in accordance with the present invention;

FIG. 24 is a block diagram illustrating a multi-bit image processing technique in accordance with the present invention;

FIG. 25 illustrates pixel projection and scan line in accordance with the present invention.

FIG. 26 illustrates a flow diagram in accordance with the present invention;

FIG. 27 is an exemplary one-dimensional symbology in accordance with the present invention;

FIGS. 28-30 illustrate exemplary two-dimensional symbologies in accordance with the present invention;

FIG. 31 is an exemplary location of I-23 cells in accordance with the present invention;

FIG. 32 illustrates an example of the location of direction and orientation cells D1-4 in accordance with the present invention;

FIG. 33 illustrates an example of the location of white guard S1-23 in accordance with the present invention;

FIG. 34 illustrates an example of the location of code type information and other information (structure) or density and ration information C1-3, number of row X1-5, number of column Y1-5 and error correction information E1-2 in accordance with the present invention; cells R1-2 are reserved and can be used as X6 and Y6 if the number of row and column exceeds 32 (between 32 and 64);

FIG. 35 illustrates an example of the location of the cells, indicating the position of the identifier within the data field in X-axis Z1-5 and in Y-axis W1-5, information relative to the shape and topology of the optical code T1-3 and information relative to print contrast and color P1-2 in accordance with the present invention;

FIG. 36 illustrates one version of an identifier in accordance with the present invention;

FIGS. 37, 38, 39 illustrate alternative examples of a Chameleon code identifier in accordance with the present invention;

FIG. 40 illustrates an example of the PDF-417 code structure using Chameleon identifier in accordance with the present invention;

FIG. 41 indicates an example of identifier being positioned in a VeriCode® Symbology of 23 rows and 23 columns, at Z=12, and W=09 (in this example, Z and W indicate the center cell position of the identifier), printed with a black and white color with no error correction and with a contrast superior of 60%, having a “D” shape, and normal density;

FIG. 42 illustrates an example of a DataMatrix™ or VeriCode code structure using a Chameleon identifier in accordance with the present invention;

FIG. 43 illustrates two-dimensional symbologies embedded in a logo using the Chameleon identifier.

FIG. 44 illustrates an example of VeriCode code structure, using Chameleon identifier, for a “D” shape symbology pattern, indicating the data field, contour or periphery and unused cells in accordance with the present invention;

FIG. 45 illustrates an example chip structure for a “System on a Chip” in accordance with the present invention;

FIG. 46 illustrates an exemplary architecture for a CMOS sensor imager in accordance with the present invention;

FIG. 47 illustrates an exemplary photogate pixel in accordance with the present invention;

FIG. 48 illustrates an exemplary APS pixel in accordance with the present invention;

FIG. 49 illustrates an example of a photogate APS pixel in accordance with the present invention;

FIG. 50 illustrates the use of a linear sensor in accordance with the present invention;

FIG. 51 illustrates the use of a rectangular array sensor in accordance with the present invention;

FIG. 52 illustrates microlenses deposited above pixels on a sensor in accordance with the present invention;

FIG. 53 is a graph of the spectral response of a typical CCD sensor with anti-blooming and a typical CMOS sensor in accordance with the present invention;

FIG. 54 illustrates a cut-away view of a sensor pixel with a microlens in accordance with the present invention;

FIG. 55 is a block diagram of a two-chip CMOS set-up in accordance with the present invention;

FIG. 56 is a graph of the quantum efficiency of a back-illuminated CCD, a front-illuminated CCD and a Gallium Arsenide photo-cathode in accordance with the present invention;

FIGS. 57 and 58 illustrates pixel interpolation in accordance with the present invention;

FIGS. 59-61 illustrate exemplary imager component configurations in accordance with the present invention;

FIG. 62 illustrates an exemplary viewfinder in accordance with the present invention;

FIG. 63 illustrates an exemplary of an imager configuration in accordance with the present invention;

FIG. 64 illustrates an exemplary imager headset in accordance with the present invention;

FIG. 65 illustrates an exemplary imager configuration in accordance with the present invention;

FIG. 66 illustrates a color system using three sensors in accordance with the present invention;

FIG. 67 illustrates a color system using rotating filters in accordance with the present invention;

FIG. 68 illustrates a color system using per-pixel filters in accordance with the present invention;

FIG. 69 is a table listing representative CMOS sensors for use in accordance with the present invention;

FIG. 70 is a table comparing representative CCD, CMD and CMOS sensors in accordance with the present invention;

FIG. 71 is a table comparing different LCD displays in accordance with the present invention; and

FIG. 72 illustrates a smart pixel array in accordance with the present invention.

### DETAILED DESCRIPTION OF THE PREFERRED EMBODIMENTS

Referring to the figures, the present invention provides an optical scanner or imager 100 for reading optically encoded information and symbols, which also has a picture taking feature and picture storage memory 160 for storing the pictures. In this description, “optical scanner”, “imager” and “reading device” will be used interchangeably for the integrated scanner on a single chip technology described in this description.

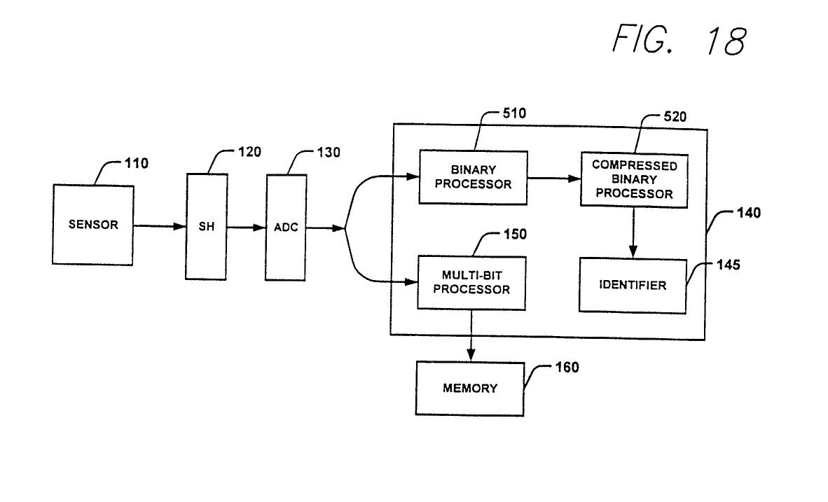

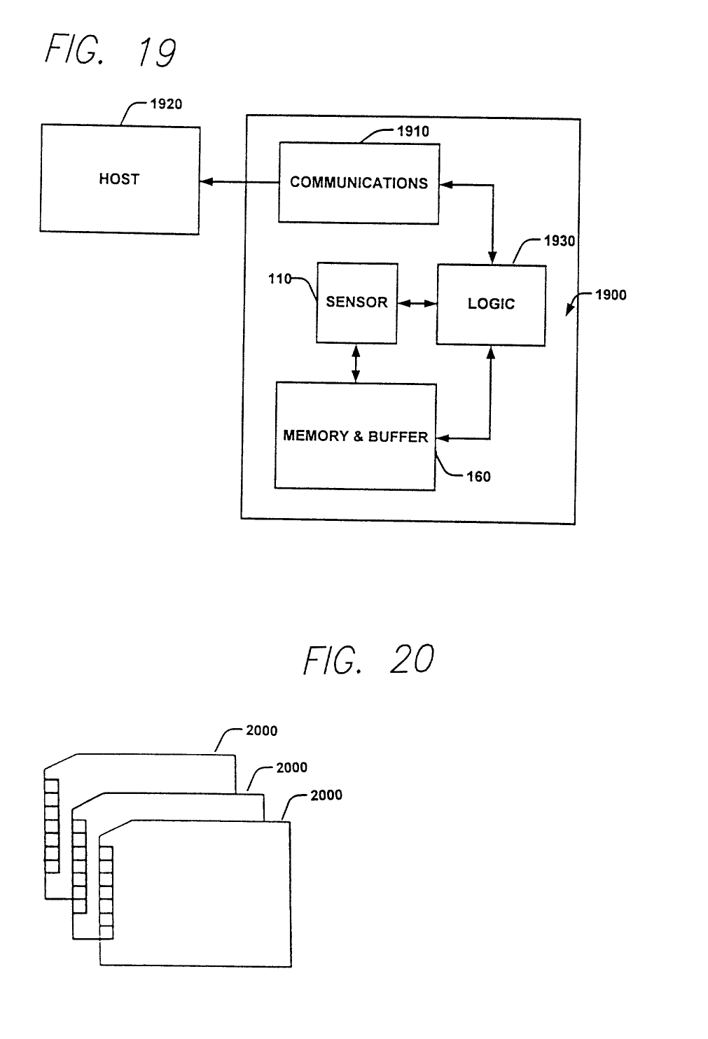

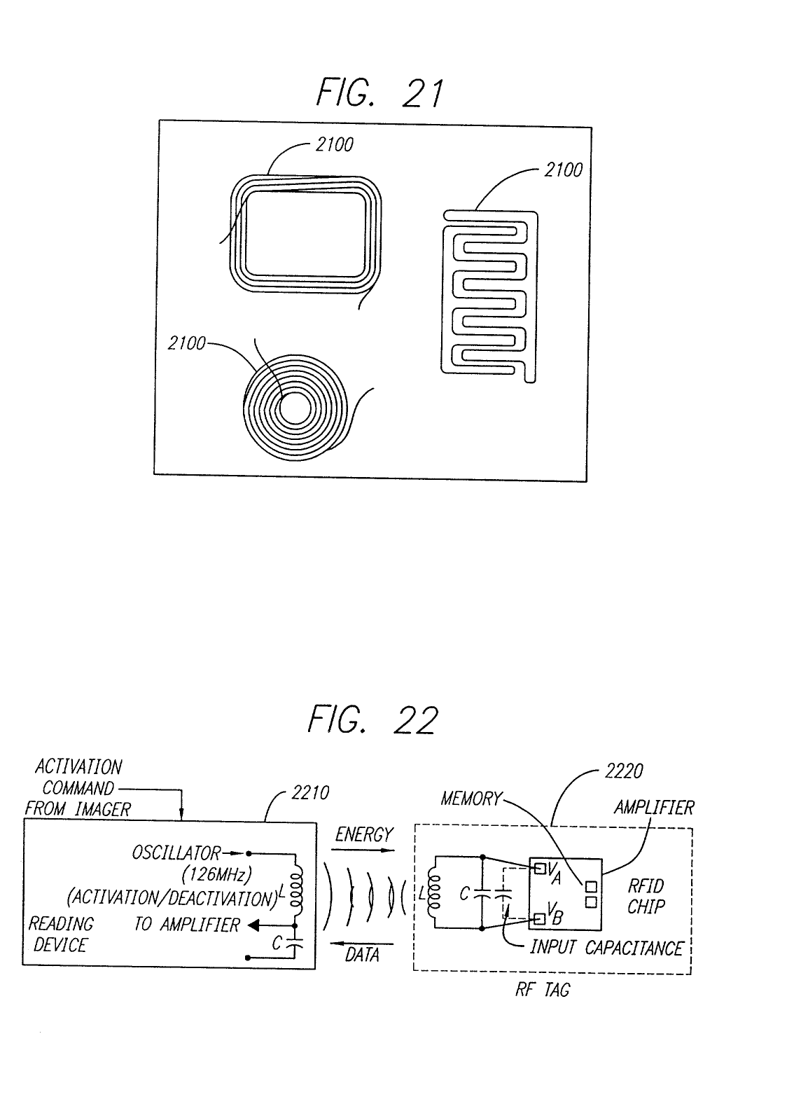

The optical scanner or imager 100 preferably includes an output system 155 for conveying images via a communication interface 1910 (illustrated in FIG. 19) to any receiving unit, such as a host computer 1920. It should be understood that any device capable of receiving the images may be used. The communications interface 1910 may provide for any form of transmission of data, such as such as cabling, infra-red transmitter/receiver, RF transmitter/receiver or any other wired or wireless transmission system.

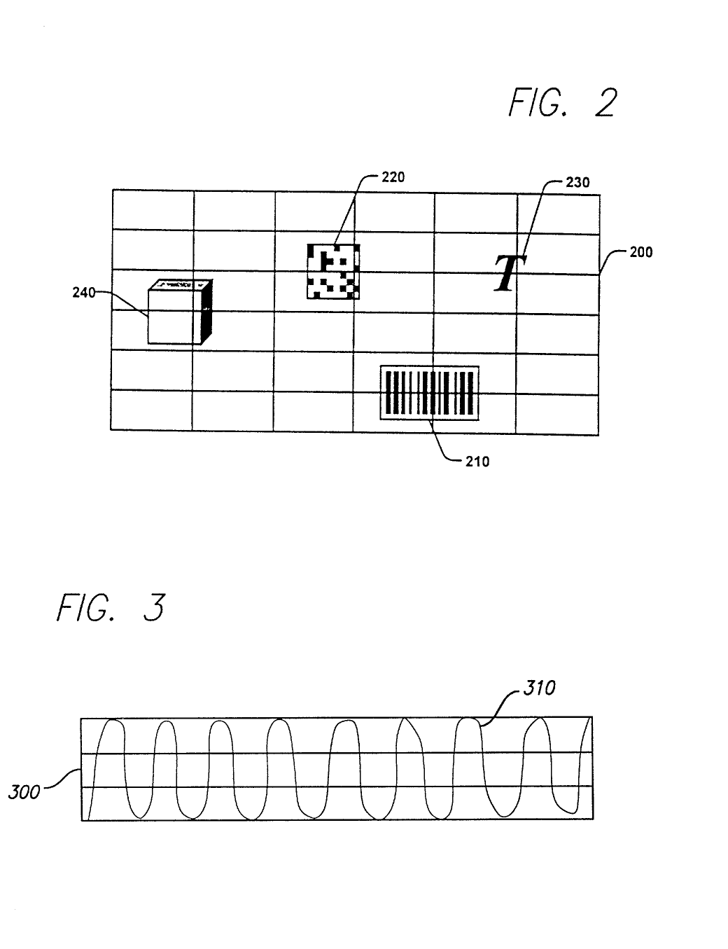

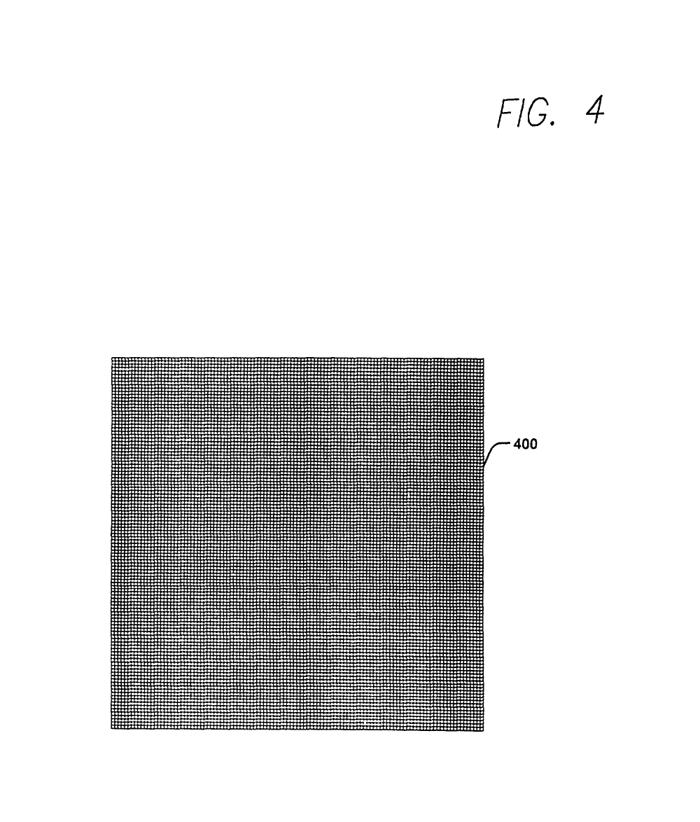

FIG. 2 illustrates a target 200 to be scanned in accordance with the present invention. The target alternately includes one-dimensional images 210, two-dimensional images 220, text 230, or three-dimensional objects 240. These are examples of the type of information to be scanned or captured. FIG. 3 also illustrates an image or frame 300, which represents digital data 310 corresponding to the scanned target 200, although it should be understood that any form of data corresponding to scanned target 200 may be used. It should also be understood that in this application the terms “image” and “frame” (along with “target” as already discussed) are used to indicate a region being scanned.

In operation, the target 200 can be located at any distance from the optical reading device 100, so long as it is within the depth of field of the imaging device 100. Any form of light source 1100 providing sufficient illumination may be used. For example, an LED light source 1110, halogen light 1120, strobe light 1130 or ambient light may be used. As shown in FIG. 19, these may be used in conjunction with specialized smart sensors, which have an on-chip sensor 110 and signal processor 150 to provide raw picture or decoded information corresponding to the information contained in a frame or image 300 to the host computer 1920. The optical scanner 100 preferably has real time image processing technique capabilities, using one or a combination of the methods and apparatus discussed in more detail below, providing improved scanning abilities.

### Hardware Image Processing

Various forms of hardware-based image processing may be used in the present invention. One such form of hardware-based image processing utilizes active pixel sensors, as described in U.S. patent application Ser. No. 08/690,752, issued as U.S. Pat. No. 5,756,981 on May 26, 1998, which was invented by the present inventor.

Another form of hardware-based image processing is a Charge Modulation Device (“CMD”) in accordance with the present invention. A preferred CMD 110 provides at least two modes of operation, including a skip access mode and/or a block access mode allowing for real-time framing and focusing with an optical scanner 100. It should be understood that in this embodiment, the optical scanner 100 is serving as a digital imaging device or a digital camera. These modes of operation become specifically handy when the sensor 110 is employed in systems that read optical information (including one and two dimensional symbologies) or process images i.e., inspecting products from the captured images as such uses typically require a wide field of view and the ability to make precise observations of specific areas. Preferably, the CMD sensor 110 packs a large pixel count (more than 600×500 pixels) and provides three scanning modes, including full-readout mode, block-access mode, and skip-access mode. The full-readout mode delivers high-resolution images from the sensor 110 in a single readout cycle. The block-access mode provides a readout of any arbitrary window of interest facilitating the search of the area of interest (a very important feature in fast image processing techniques). The skip-access mode reads every “n/th” pixel in horizontal and vertical directions. Both block and skip access modes allow for real-time image processing and monitoring of partial and a whole image. Electronic zooming and panning features with moderate and reasonable resolution also are feasible with the CMD sensors without requiring any mechanical parts.

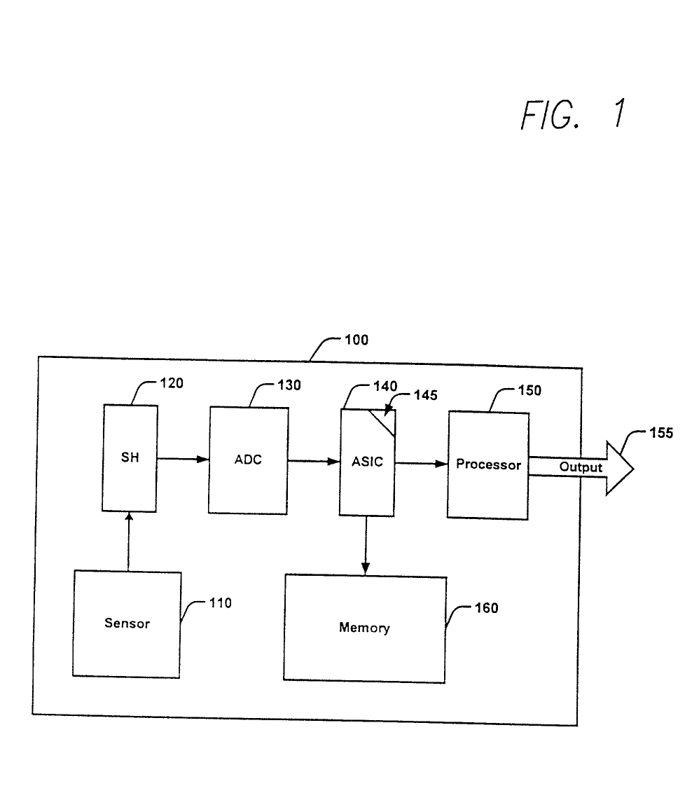

FIG. 1 illustrates a system having a glue logic chip or programmable gate array 140, which also will be referred to as ASIC 140 or FPGA 140. The ASIC or FPGA 140 preferably includes image processing software stored in a permanent memory therein. For example the ASIC or FPGA 140 preferably includes a buffer 160 or other type of memory and/or a working RAM memory providing memory storage. A relatively small size (such as around 40K) memory can be used, although any size can be used as well. As a target 200 is read by sensor 110, image data 310 corresponding to the target 200 is preferably output in real time by the sensor. The read out data preferably indicates portions of the image 300, which may contain useful data distinguishing between, for example, one dimensional symbologies (sequences of bars and spaces) 210, text (uniform shape and clean gray) 230, and noise (depending to other specified feature i.e., abrupt transition or other special features) (not shown). Preferably as soon as the sensor 110 read of the image data is completed, or shortly thereafter, the ASIC 140 outputs indicator data 145. The indicator data 145 includes data indicating the type of optical code (for example one or two dimensional symbology) and other data indicating the location of the symbology within the image frame data 310. As a portion of the data is read (preferably around 20 to 30%, although other proportions may be selected as well) the ASIC 140 (software logic implemented in the hardware) can start a multi-bit image processing in parallel with the Sensor 110 data transfer (called “Real Time Image Processing”). This can happen either at some point during data transfer from Sensor 110, or afterwards. This process is described in more detail below in the Multi-Bit Image Processing section of this description.

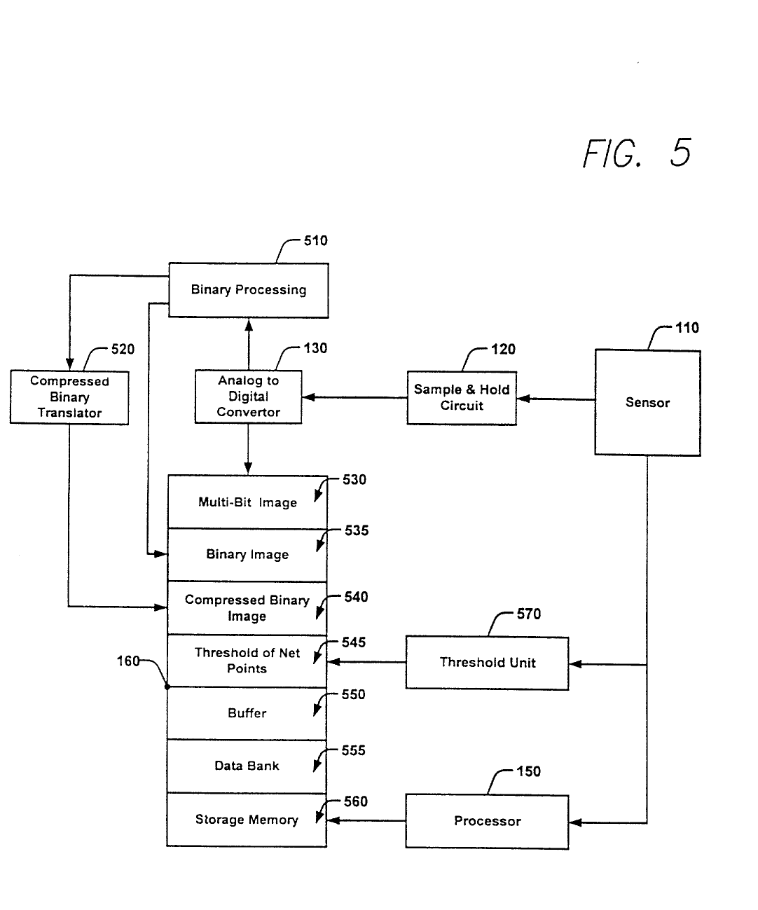

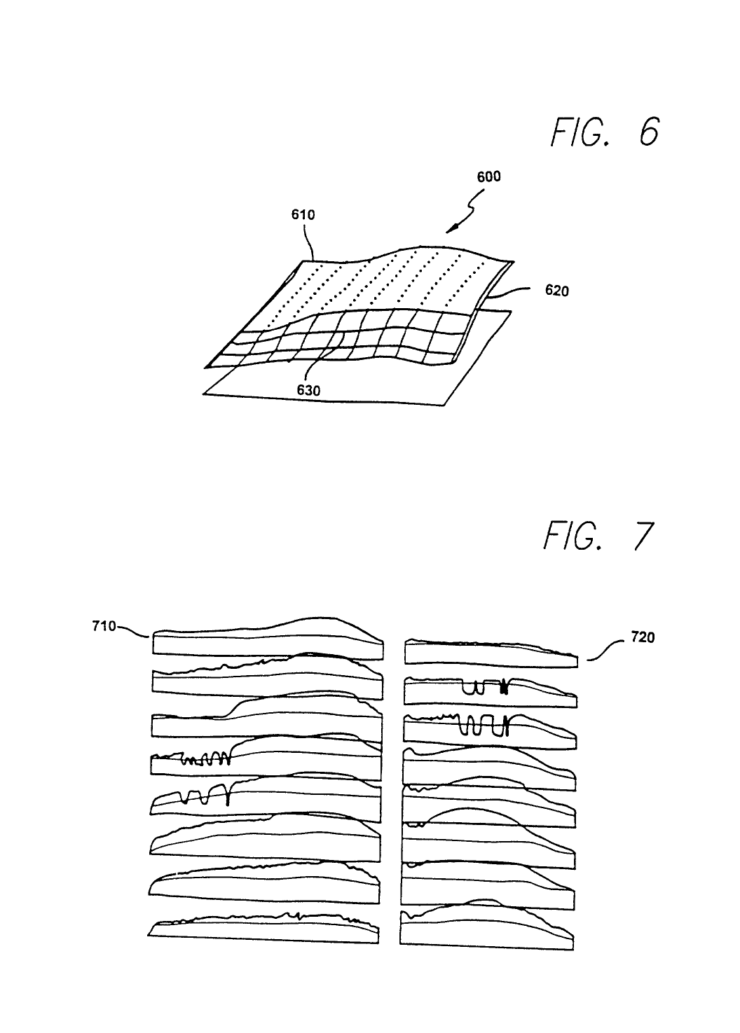

During image processing, or as data is read out from the sensor 110, the ASIC 140, which preferably has the image processing software encoded within its hardware, scans the data for special features of any symbology or the optical code that an image grabber 100 is supposed to read through the set-up parameters. For instance if a number of Bars and Spaces together are observed, it will determine that the symbology present in the frame 300 may be a one dimensional 2700 or a PDF-417 symbology 2900 or if it sees organized and consistent shape/pattern it can easily identify that the current reading is text 230. Before the data transfer from the CCD 110 is completed the ASIC 140 preferably has identified the type of the symbology or the optical code within the image data 310 and its exact position and can call the appropriate decoding routine for the decode of the optical code. This method increases considerably the response time of the optical scanner 100. In addition, the ASIC 140 (or processor 150) preferably also compresses the image data 310 output from the Sensor 110. This data may be stored as an image file in a databank, such as in memory 160, or alternatively in on-board memory within the ASIC 140. The databank may be stored at a memory location indicated diagrammatically in FIG. 5 with box 555. The databank preferably is a compressed representation of the image data 310, having a smaller size than the image 300. In one example, the databank is 5 to 20 times smaller than the corresponding image data 310. The databank is used by the image processing software to locate the area of interest in the image without analyzing the image data 310 pixel by pixel or bit by bit. The databank preferably is generated as data is read from the sensor 110. As soon as the last pixel is read out from the sensor (or shortly thereafter), the databank is also completed. By using the databank, the image processing software can readily identify the type of optical information represented by the image data 310 and then it may call for the appropriate portion of the processing software to operate, such as an appropriate subroutine. In one embodiment, the image processing software includes separate subroutines or objects associated with processing text, one-dimensional symbologies 210 and two-dimensional symbologies 220, respectively.

In a preferred embodiment of the invention, the imager is a hand-held device. A trigger (not shown) is depressible to activate the imaging apparatus to scan the target 200 and commence the processing described herein. Once the trigger is activated, the illumination apparatus 1110, 1120 and/or 1130 is optionally is activated illuminating the image 300. Sensor 110 reads in the target 200 and outputs corresponding data to ASIC or FPGA 140. The image 300, and the indicator data 145 provide information relative to the image content, type, location and other useful information for the image processing to decide on the steps to be taken. Alternatively, the compressed image data may be used to provide such information. In one example if the image content is a DataMatrix two-dimensional symbology 2800, the identifier will be positioned so that the image processing software understands that the decode software to be used in this case is a DataMatrix decoding module and that the symbology is located at a location, reference by X and Y. After the decode software is called, the decoded data is outputted through communication interface 1910 to the host computer 1920.

In one example, for a CCD readout time of approximately 30 milliseconds for a 500×700 pixels CCD (approximately) the total Image Processing time to identify and locate the optical code would be around 33 milliseconds, meaning that almost instantly after the CCD readout the appropriate decoding software routine could be called to decode the optical code in the frame. The measured decode time for different symbologies depends on their respective decoding routines and decode structures. In another example, experimentation indicated that it would take about 5 milliseconds for a one-dimensional symbology and between 20 to 80 milliseconds for a two-dimensional symbology depending on their decode software complexity.

FIG. 18 shows a flow chart illustrating processing steps in accordance with these techniques. As illustrated in FIG. 18, data from the CCD sensor 110 preferably goes to a single or double sample and hold (“SH”) circuit 120 and ADC circuit 130 and then to the ASIC 140, in parallel to its components the multi-bit processor 150 and the series of binary processor 510 and run length code processor 520. The combined binary data (“CBD”) processor 520 generates indicator data 145, which either is stored in ASIC 140 (as shown), or can be copied into memory 560 for storage and future use. The multi-bit processor 150 outputs pertinent multi-bit image data 310 to a memory 530, such as an SDRAM.

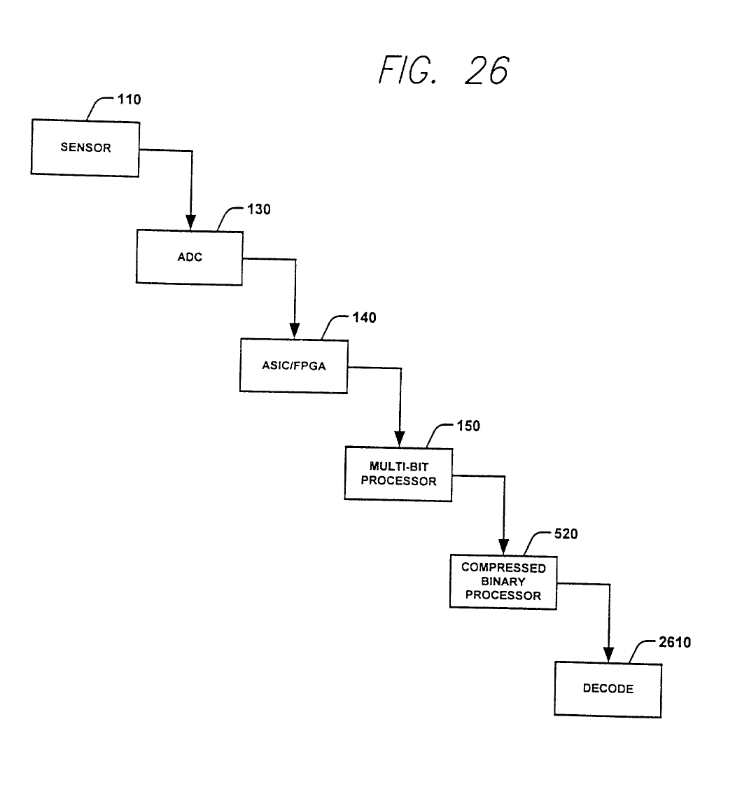

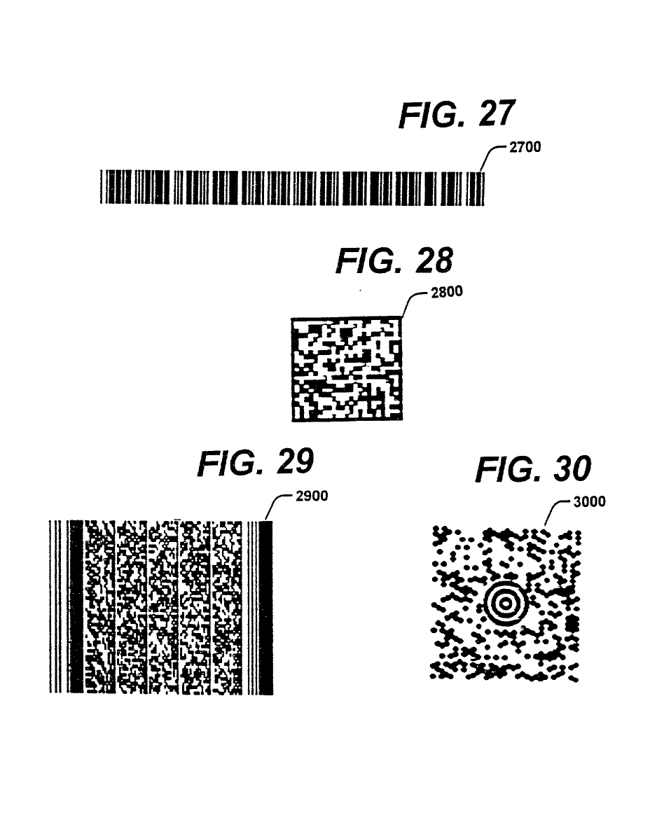

Another system for high integration is illustrated in FIG. 19. This preferred system can include the CCD sensor 110, a logic processing unit 1930 (which performs functions performed by SH 120, ADC 130, and ASIC 140), memory 160, communication interface 1910, all preferably integrated in a single computer chip 1900, which I call a System On A Chip (“SOC”) 1900. This system reads data directly from the sensor 110. In one embodiment, the sensor 110 is integrated on chip 1900, as long as the sensing technology used is compatible with inclusion on a chip, such as a CMOS sensor. Alternatively, it is separate from the chip if the sensing technology is not capable of inclusion on a chip. The data from the sensor is preferably processed in real time using logic processing unit 1930, without being written into the memory 160 first, although in an alternative embodiment a portion of the data from sensor 110 is written into memory 160 before processing in logic 1930. The ASIC 140 optionally can execute image processing software code. Any sensor 110 may be used, such as CCD, CMD or CMOS sensor 110 that has a full frame shutter or a programmable exposure time. The memory 160 may be any form of memory suitable for integration in a chip, such as data memory and/or buffer memory 550. In operating this system, data is read directly from the sensor 110, which increases considerably the processing speed. After all data is transferred to the memory 160, the software can work to extract data from both multi-bit image data 310 and CBD in CBD memory 540, in one embodiment using the databank data 555 and indicator data 145, before calling the decode software 2610, illustrated diagrammatically in FIG. 26 and also described in U.S. applications and patents, including: Ser. No. 08/690,752, issued as U.S. Pat. No. 5,756,981 on May 26, 1998, application Ser. No. 08/569,728 filed Dec. 8, 1995 (issued as U.S. Pat. No. 5,786,582, on Jul. 28, 1998); application Ser. No. 08/363,985, filed Dec. 27, 1994, application Ser. No. 08/059,322, filed May 7, 1993, application Ser. No. 07/965,991, filed Oct. 23, 1992, now issued as U.S. Pat. No. 5,354,977, application Ser. No. 07/956,646, filed Oct. 2, 1992, now issued as U.S. Pat. No. 5,349,172, application Ser. No. 08/410,509, filed Mar. 24, 1995, U.S. Pat. No. 5,291,009, application Ser. No. 08/137,426, filed Oct. 18, 1993 and issued as U.S. Pat. No. 5,484,994, application Ser. No. 08/444,387, filed May 19, 1995, and application Ser. No. 08/329,257, filed Oct. 26, 1994. One difference between these patents and applications and the present invention is that the image processing of the present invention does not use the binary data exclusively. Instead, the present invention also considers data extracted from a “double taper” data structure (not shown) and data bank 555 to locate the area of interests and it also uses the multi-bit data to enhance the decodability of the symbol found in the frame as shown in FIG. 26 (particularly for one dimensional and stacked symbologies) using the sub-pixel interpolation technique as described in the image processing section. The double taper data structure is created by interpolating a small portion of the CBD and then using that to identify areas of interest that are then extracted from the full CBD.

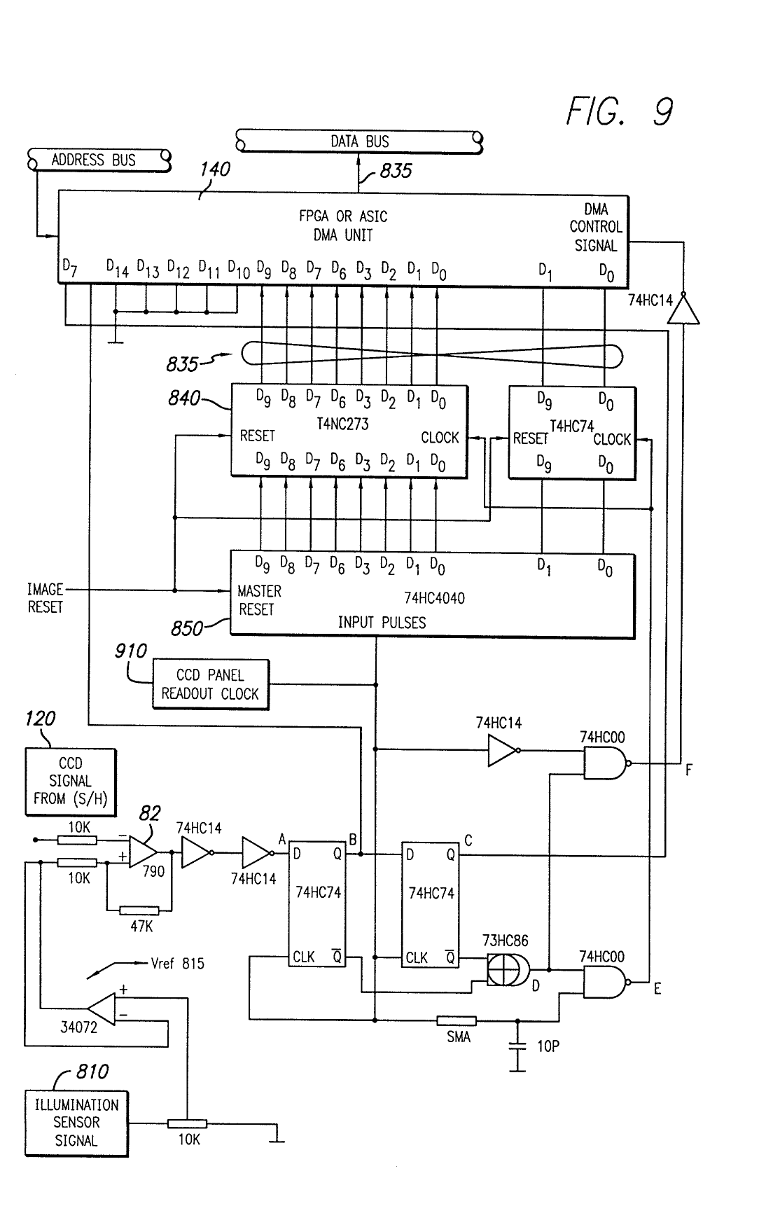

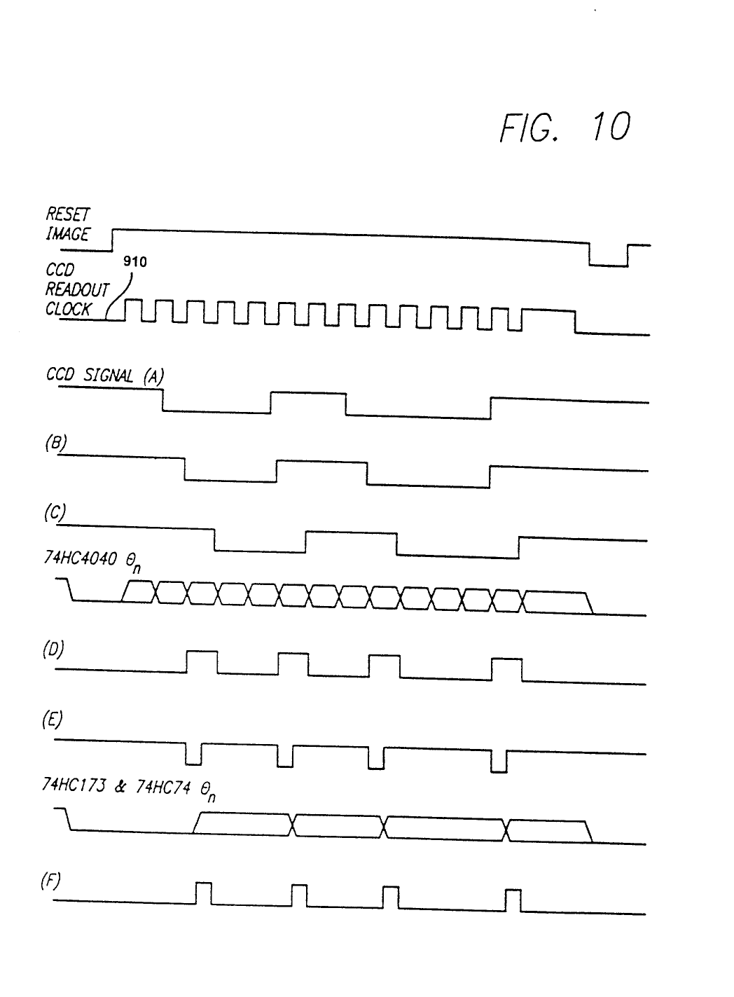

FIGS. 5 and 9 illustrate one embodiment of a hardware implementation of a binary processing unit 120 and a translating CBD unit 520. It is noted that the binary-processing unit 120, may be integrated on a single unit, as in SOC 1900, or may be constructed of a greater number of components. FIG. 9 provides an exemplary circuit diagram of binary processing unit 120 and a translating CBD unit 520. FIG. 10 illustrates a clock timing diagram corresponding to FIG. 9.

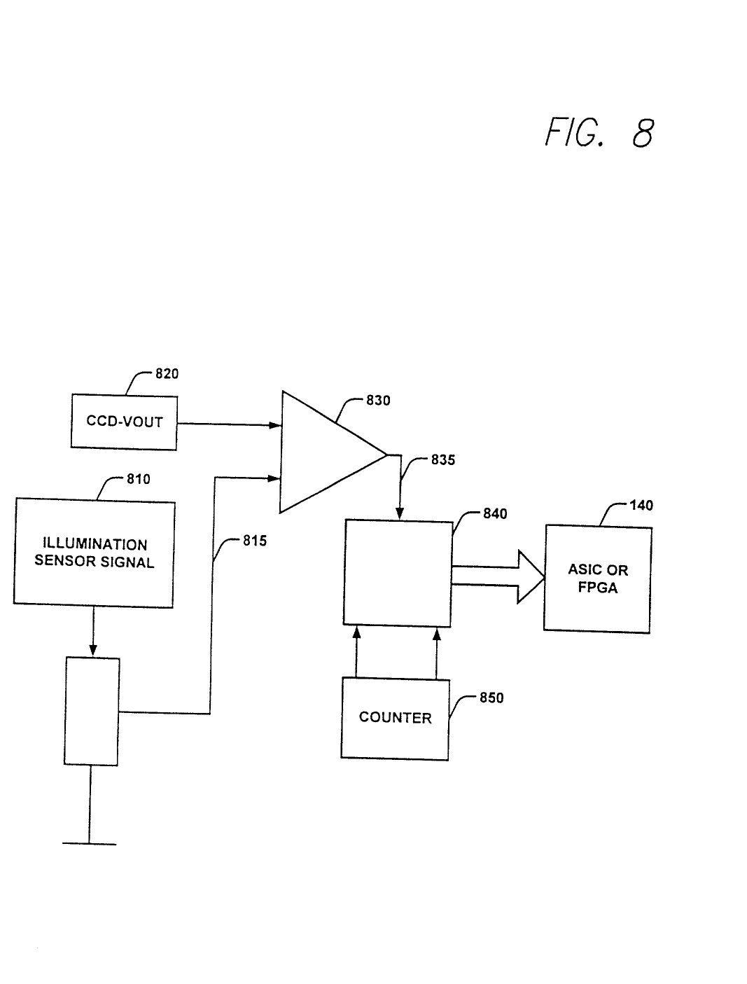

The binary processing unit 120 receives data from sensor (i.e. CCD) 110. With reference to FIG. 8, an analog signal from the sensor 110 (Vout 820) is provided to a sample and hold circuit 120. A Schmitt Comparator 830 is provided in an alternative embodiment to provide the CBD at the direct memory access (“DMA”) sequence into the memory as shown in FIG. 8. In operation, the counter 850 transfers numbers, representing X number of pixels of 0 or 1 at the DMA sequence instead of “0” or “1” for each pixel, into the memory 160 (which in one embodiment is a part of FPGA or ASIC 140). The Threshold 570 and CBD 520 functions preferably are conducted in real time as the pixels are read (the time delay will not exceed 30 nanoseconds). The example, using Fuzzy Logic software, uses CBD to read DataMatrix code. This method takes 125 milliseconds. If we change the Fuzzy Logic method to use pixel by pixel reading from the known offset addresses which will reduce the time to approximately 40 milliseconds in this example. This example is based on an apparatus using a SH-2 micro-controller from Hitachi with a clock at around 27 MHz and does not include any optimization both functional and time, by module. Diagrams corresponding to this example provided in FIGS. 5, 9 and 10, which are described in greater detail below. FIG. 5 illustrates a hardware implementation of a binary processing unit 120 and a translating CBD unit 520. An example of circuit diagram of binary processing unit 120 outputting data to binary image memory 535, and a translating CBD unit 520 is presented in FIG. 9, outputting data represented with reference number 835. FIG. 10 illustrates a clock-timing diagram for FIG. 9.

By way of further description, the present invention preferably simultaneously provides multi-bit data 310, to determine the threshold value by using the Schmitt comparator 830 and to provide CBD 81. In one example, the measured time by doing the experimentation verified that the multi-bit data, threshold value determination and CBD calculation could be all accomplished in 33.3 millisecond, during the DMA time.

A multi-bit value is the digital value of a pixel's analog value, which can be between 0 and 255 levels for an 8 bit gray-scale ADC 130. The multi-bit data value is obtained after the analog Vout 820 of sensor 110 is sampled and held by a double sample and hold device 120 (“DSH”). The analog signal is converted to multi-bit data by passing through ADC 130 to the ASIC or FPGA 140 to be transferred to memory 160 during the DMA sequence.

A binary value is the digital representation of a pixel's multi-bit value, which can be “0” or “1” when compared to a threshold value. A binary image 535 can be obtained from the multi-bit image data 310, after the threshold unit 570 has calculated the threshold value.

CBD is a representation of a succession of multiple number of pixels with a value of “0” or “1”. It is easily understandable that memory space and processing time can be considerably optimized if CBD can take place at the same time that pixel values are read and DMA is taking place. FIG. 5 represents an alternative for the binary processing and CBD translating units for a high-speed optical scanner 100. The analog pixel values are read from sensor 110 and after passing through DSH 120 and ADC 130 are stored in memory 160. At the same time, during the DMA, the binary processing unit 120 receives the data and calculates the threshold of net-points (a non-uniform distribution of the illumination from the target 200, causes a non-even contrast and light distribution represented in the image data 310). Therefore the traditional real floating threshold binary algorithm, as described in the CIP Ser. No. 08/690,752, filed Aug. 1, 1996, now issued as U.S. Pat. No. 5,756,981, will take a long time. To overcome this poor distribution of light, particularly in a hand held optical scanner or imaging device, it is an advantage of present invention to use a floating threshold curve surface technique, as is known in the art. The multi-bit image data 310 includes data representing “n” scan lines, vertically 610 and “m” scan lines horizontally 620 (for example, 20 lines, represented by 10 rows and 10 columns). There is the same space between each two lines. Each intersection of vertical and horizontal line 630 is used for mapping the floating threshold curve surface 600. A deformable surface is made of a set of connected square elements. Square elements were chosen so that a large range of topological shapes could be modeled. In these transformations the points of the threshold parameter are mapped to corners in the deformed 3-space surface. The threshold unit 570 uses the multi-bit values on the line for obtaining the gray sectional curve and then it looks at the peak and valley curve of the gray section. The middle curve of the peak curve and the valley curve would be the threshold curve for this given line. The average value of the vertical 710 and horizontal 720 threshold on the crossing point would be the threshold parameter for mapping the threshold curve surface 600. Using the above-described method, the threshold unit 570 calculates the threshold of net-points 545 for the image data 310 and stores them in a memory 160 at the location 535. It should be understood that any memory device 160 may be used, for example, a register.

After the value of the threshold is calculated for different portion of the image data 310, the binary processing unit 120 generates the binary image 535, by thresholding the multi-bit image data 310. At the same time, the translating CBD unit 520 creates the CBD to be stored in location 540.

FIG. 9 represents an alternative for obtaining CBD in real time. The Schmitt comparator 830 receives the signal from DSH 120 on its negative input and the Vref. 815 representing a portion of the signal that from the illumination value of the target 200, captured by illumination sensor 810, on its positive output. Vref. 815 would be representative of the target illumination, which depends on the distance of the optical scanner 100 from the target 200. Each pixel value is compared with the threshold value and will result to a “0” or “1” compared to a variable threshold value which is the average target illumination. The counter 850 will count (it will increment its value at each CCD pixel clock 910) and transfer to the latch 840, each total number of pixel, representing “0” or “1” to the ASIC 140 at the DMA sequence instead of “0” or “1” for each pixel. FIG. 10 is the timing diagram representation of circuitry defined in FIG. 9.

### Multi-Bit Image Processing

The Depth of Field (“DOF”) charting of an optical scanner 100 is defined by a focused image at the distances where a minimum of less than one (1) to three (3) pixels is obtained for a Minimum Element Width (“MEW”) for a given dot used to print a symbology, where the difference between a black and a white is at least 50 points in a gray scale. This dimensioning of a given dot alternatively may be characterized in units of dots per inch. The sub-pixel interpolation technique lowers the decode of a MEW to less than one (1) pixel instead of 2 to 3 pixels, providing a perception of “Extended DOF”.

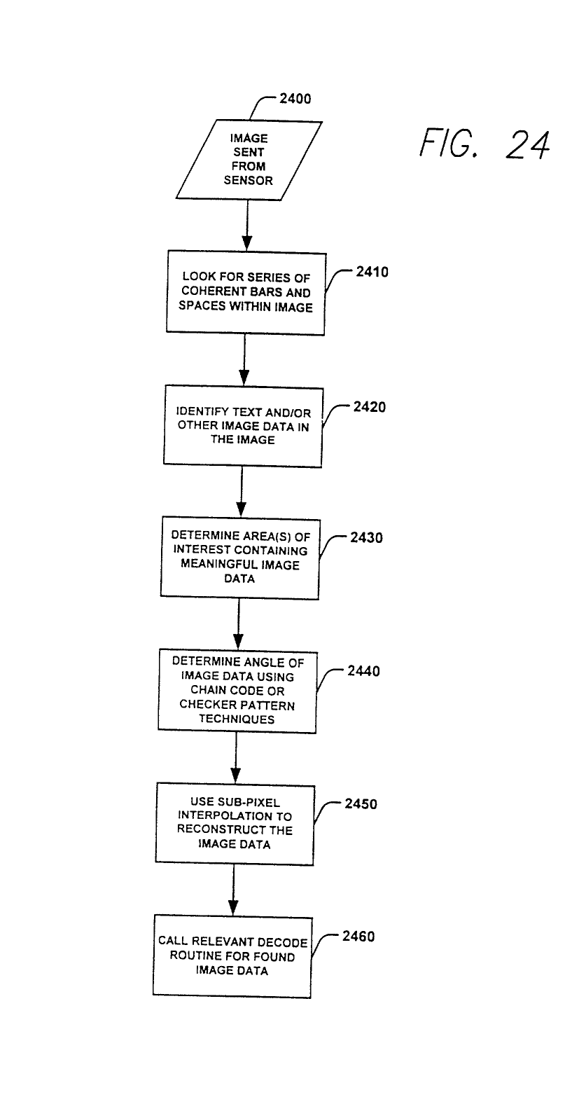

An example of operation of the present invention is described with reference to FIGS. 24 and 25. As a portion of the data from the CCD 110 is read, as illustrated in step 2400, the system looks for a series of coherent bars and spaces, as illustrated with step 2410. The system then identifies text and/or other type of data in the image data 310, as illustrated with step 2420. The system then determines an area of interest, containing meaningful data, in step 2430. In step 2440, the system determines the angle of the symbology using a checker pattern technique or a chain code technique, such as finding the slope or the orientation of the symbology 210 or 220, or text 230 within the target 200. The checker pattern technique is known in the art. A sub-pixel interpolation technique is then utilized to reconstruct the optical code or symbology code in step 2450. In exemplary step 2460 a decoding routine is then run. An exemplary decoding routine is described in commonly invented U.S. patent application Ser. No. 08/690,752 (issued as U.S. Pat. No. 5,756,981).

At all times, data inside of the Checker Pattern Windows 2500 are preferably conserved to be used to identify other 2D symbologies or text if needed. The Interpolation Technique uses the projection of an angled bar 2510 or space by moving x number of pixels up or down to determine the module value corresponding to the MEW and to compensate for the convolution distortion as represented by reference number 2520. This method can be used to reduce the MEW of pixels to less than 1.0 pixels for the decode algorithm. Without using this method the MEW is higher, such as in the two to three pixel range.

Another technique involves a preferably non-clocked and X-Y addressed random-access imaging readout CMOS sensor, called also Asynchronous Random Access MOS Image Sensor (“ARAMIS”) along with ADC 130, memory 160, processor 150 and communication device such as Universal Serial Bus (“USB”) or parallel port on a single chip. FIG. 45 provides an example of connecting cores and blocks and the different number of layers of interconnect for the separate blocks of a system on a SOC imaging device. This exact structure selected is largely dependent on the fabrication process used. In the illustrated example, a sensor 110, such as a CMOS sensor and analog logic 4530, are included on the chip towards the end of the fabrication process. However it should be understood that they can also be included on the chip in an earlier step. In the illustrated example, the processor core 4510, SRAM 4540, and ROM 4590 are incorporated on the same layers. Although in the illustrated example, the DRAM 4550 is shown separated by a layer from these elements, it alternatively can be in the same layer, along with the peripherals and communications interface 4580. The interface 4580 may optionally include a USB interface. The DSP 4560, ASIC 4570 and control logic 4520 are embedded at the same time or after the processor 4510, SRAM 4540 and ROM 4950, or alternatively can be embedded in a later step. Once the process of fabrication is finished, the wafer preferably is tested, and later each SOC contained on the wafer is cut and packaged.

### Image Sensor Technology

The imaging sensor of the present invention can be made using either passive or active photodiode pixel technologies.

In the case of the former, passive photodiode photon energy 4720 converts to free electrons 4710 in the pixels. After photocharge integration, an access transistor 4740 relays the charge to the column bus 4750. This occurs when the array controller turns on the access transistor 4740. The transistor 4740 transfers the charge to the capacitance of the column bus 4750, where a charge-integrating amplifier at the end of the bus 4750 senses the resulting voltage. The column bus voltage resets the photodiode 4730, and the controller then turns off the access transistor 4740. The pixel is then ready for another integration period.

The passive photodiode pixel achieves high “quantum efficiency” for two reasons. First, the pixel typically contains only one access transistor 4740. This results in a large fill factor which, in turn, results in high quantum efficiency. Second, there is rarely a need for a light-restricting polysilicon cover layer, which would reduce quantum efficiency in this type of pixel.

With passive pixels, the read noise can be relatively high and it is difficult to increase the array's size without increasing noise levels. Ideally, the sense amplifier at the bottom of the column bus would sense each pixel's charge independent of that pixel's position on the bus. Realistically, however, low charge levels from far off pixels provide insufficient energy to charge the distributed capacitance of the column bus. Matching access transistors 4740 also can be an issue with passive pixels. The turn-on thresholds for the access transistors 4740 vary throughout the array, giving a non-uniform response to identical light levels. These threshold variations are another cause of fixed-pattern noise (“FPN”).

Both solid-state CMOS sensors and CCDs depend on the photovoltaic response that results when silicon is exposed to light. Photons in the visible and near infrared regions of the spectrum have sufficient energy to break covalent bonds in silicon. The number of electrons released is proportional to the light intensity. Even though both technologies use the same physical properties, analog CCDs tend to be more prevalent in vision applications because of their superior dynamic range, low FPN, and high sensitivity to light.

Adding transistors to create active CCD pixels provides CCD sensitivity with CMOS power and cost savings. The combined performance of CCD and the manufacturing advantages of CMOS offer price and performance advantages. One known CMOS that can be used with the present invention is the VV6850 from VLSI Vision, Limited of San Jose, Calif.

FIG. 46 illustrates an example of the architecture of a CMOS sensor imager that can be used in conjunction with the present invention. In this illustrated embodiment, the sensor 110 is integrated on a chip. Vertical data 4692 and horizontal data 4665 provide vertical clocks 4690 and horizontal clocks 4660 to the vertical register 4685 and horizontal register 4655, respectively. The data from the sensor 110 is buffered in buffer 4650 and then can be transferred to the video output buffer 4635. The custom logic 4620 calculates the threshold value and runs the image processing algorithms in real time to provide an identifier 4630 to the image processing software (not shown) through the bus 4625. As soon as the last pixel from the sensor 110 is transferred to the output device 4645, as indicated by arrow 4640, the processor optionally can process the imaging information in any desired fashion as the identifier 4630 preferably contains all pertinent information relative to an image that has been captured. In an alternative embodiment a portion of the data from sensor 20 is written into memory 60 before processing in logic 4620. The USB 4680, or equivalent structure, controls the serial flow of data 4696 through the data line(s) indicated by reference numeral 4694, as well as for serial commands to control register 4675. Preferably the control register 4675 also sends and receives data from the bidirectional unit 4670 representing the decoded information. The control circuit 4605 can receive data through lines 4610, which data contains control program 4615 and variable data for various desired custom logic applications, executed in the custom logic 4620.

The support circuits for the photodiode array and image processing blocks constitute also can be included on the chip. Vertical shift registers control the reset, integrate, and readout cycle for each line of the array. The horizontal shift register controls the column readout. A two-way serial interface 4696 and internal register 4675 provide control, monitoring, and several operating modes for the camera or imaging functions.

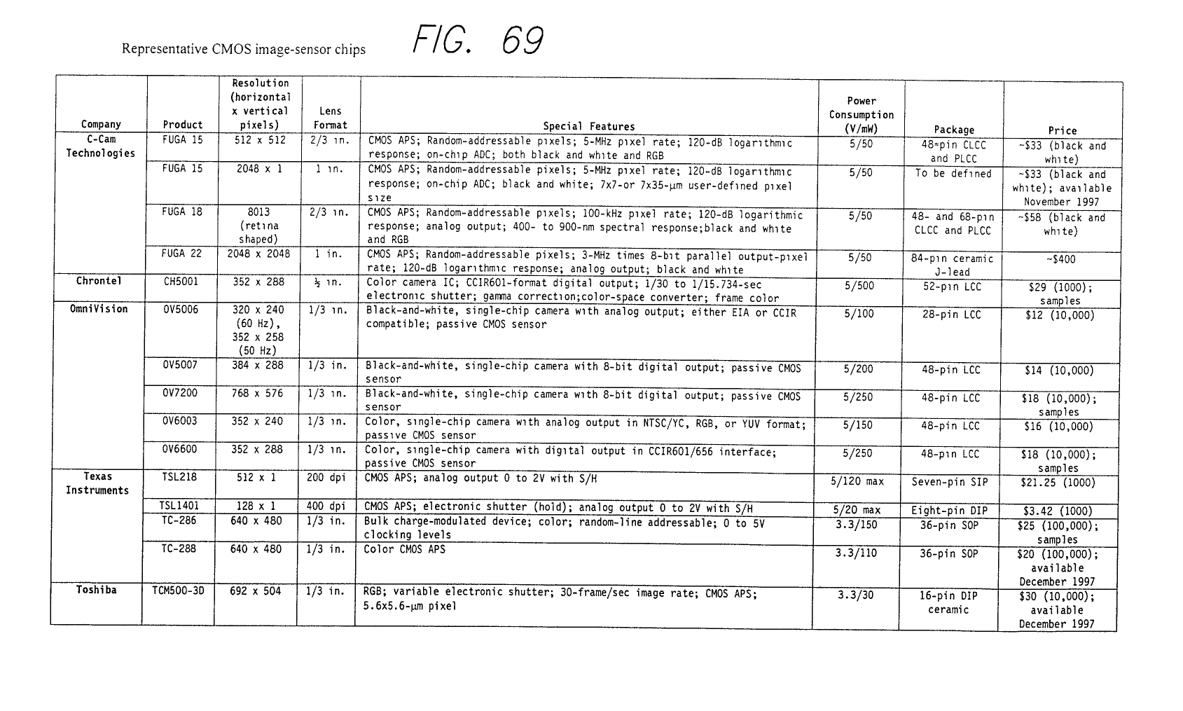

Passive pixels, such as those available from OmniVision Technologies, Inc., Sunnyvale, Calif. (as listed in FIG. 69), for example, can work to reduce the noise of the imager. Integrated analog signal processing mitigates FPN. Analog processing combines correlated double sampling and proprietary techniques to cancel noise before the image signal leaves the sensor chip. Further, analog noise cancellation circuits use less chip area than do digital circuits.

OmniVision's pixels obtain a 70 to 80% fill factor. This on-chip sensitivity and image processing provides high quality images, even in low light conditions.

The simplicity and low power consumption of the passive pixel array is an advantage in the imager of the present invention. The deficiencies of passive pixels can be overcome by adding transistors to each pixel. Transistors 4740 buffer and amplify the photocharge onto the column bus 4750. Such CMOS Active-pixel sensors (“APS”) alleviate readout noise and allow for a much larger image array. One example of an APS array is found in the TCM 500-3D, as listed in FIG. 69.

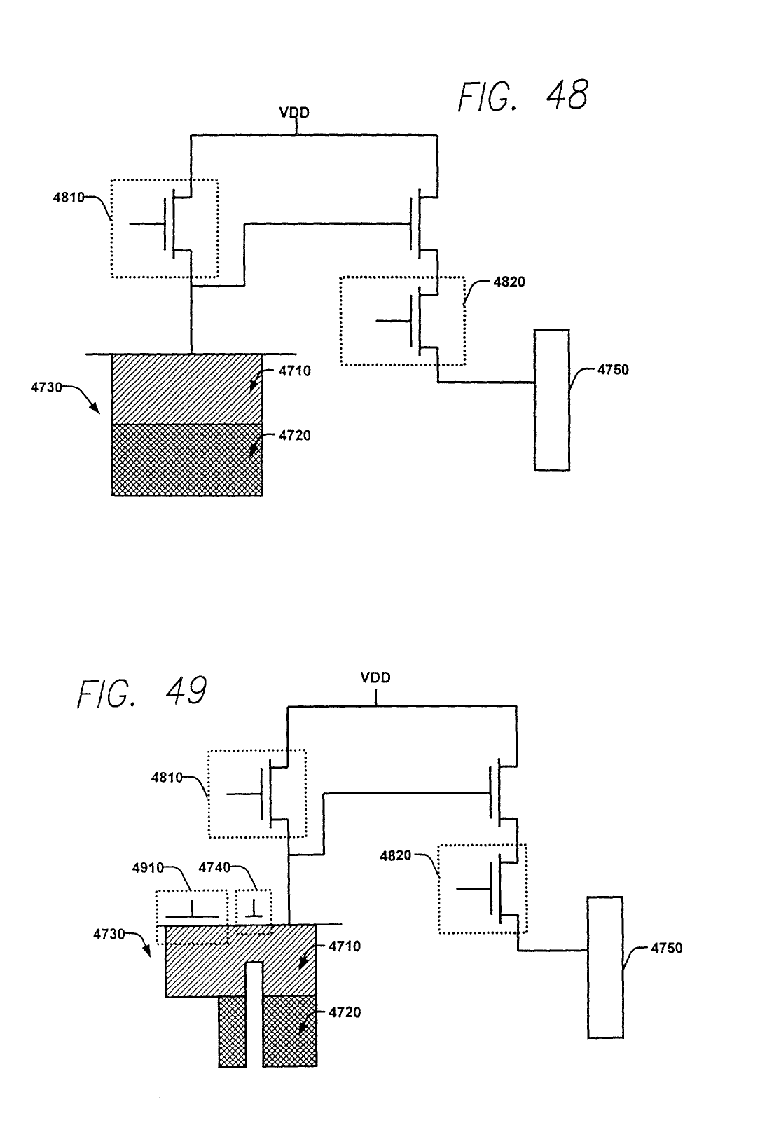

The imaging sensor at the present can also be made using active photodiode 4730 pixel technologies. Active circuits in each pixel provide several benefits. In addition to the source-follower transistor 4740 that buffers the charge onto the bus 4750, additional active circuits are the reset 4810 and row selection transistors 4820 (FIG. 48). The buffer transistor 4740 provides current to charge and discharge the bus capacitance more quickly. The faster charging and discharging allow the bus length to increase. This increased bus length, in turn, increases the array size. The reset transistor 4810 controls integration time and, therefore, provides for electronic shutter control. The row select transistor 4820 gives half the coordinate readout capability to the array.

However, the APS has some drawbacks. More pixels and more transistors per pixel aggravate threshold matching problems and, therefore, FPN. Adding active circuits to each pixel also reduces fill factor. APSs typically have a 20 to 30% fill factor, which is about equal to interline CCD technology. To counter the low fill factor, the APS can use microlenses 5210 to capture light that would otherwise strike the pixel's insensitive areas, as illustrated in FIG. 52. The microlenses 5210 focus the incident light onto the sensitive area and can also substantially increase the effective fill factor. In manufacture, depositing the microlens on the CMOS image-sensor wafer is one of the final steps.

Integrating analog and digital circuitry to suppress noise from readout, reset, and FPN enhances the image quality that these sensor arrays provide. APS pixels, such as those in the Toshiba TCM500-3D, shown in FIG. 69 are as small as 5.6 μm².

A photogate APS uses a charge transfer technique to enhance the CMOS sensor array's image quality. The photocharge 4710 occurring under a photogate 4910 is illustrated in FIG. 49. The active circuitry then performs a double sampling readout. First, the array controller resets the output diffusion, and the source follower buffer 4810 reads the voltage. Then, a pulse on the photogate 4910 and access transistor 4740 transfers the charge to the output diffusion (not shown) and a buffer senses the charge voltage. This correlated double sampling technique enables fast readout and mitigates FPN by resetting noise at the source.

A photogate APS builds on photodiode APSs by adding noise control at each pixel. This is achieved, however, at the expense of greater complexity and less fill factor. Exemplary imagers are available from Photobit of La Crescenta, Calif. (Model Nos. PB-159 and PB-720), such as having readout noise as low as 5 electrons rms using a photogate APS. The noise levels for such imagers are even lower than those of commercial CCDs (typically having 20 electrons rms read noise). Read noise on a photodiode passive pixel, in contrast, can be 250 electrons rms and 100 electrons rms on a photodiode APS in conjunction with the present invention. Even though low readout noise is possible on a photogate APS sensor array, analog and digital signal processing circuits on the chip are necessary to get the image off the chip.

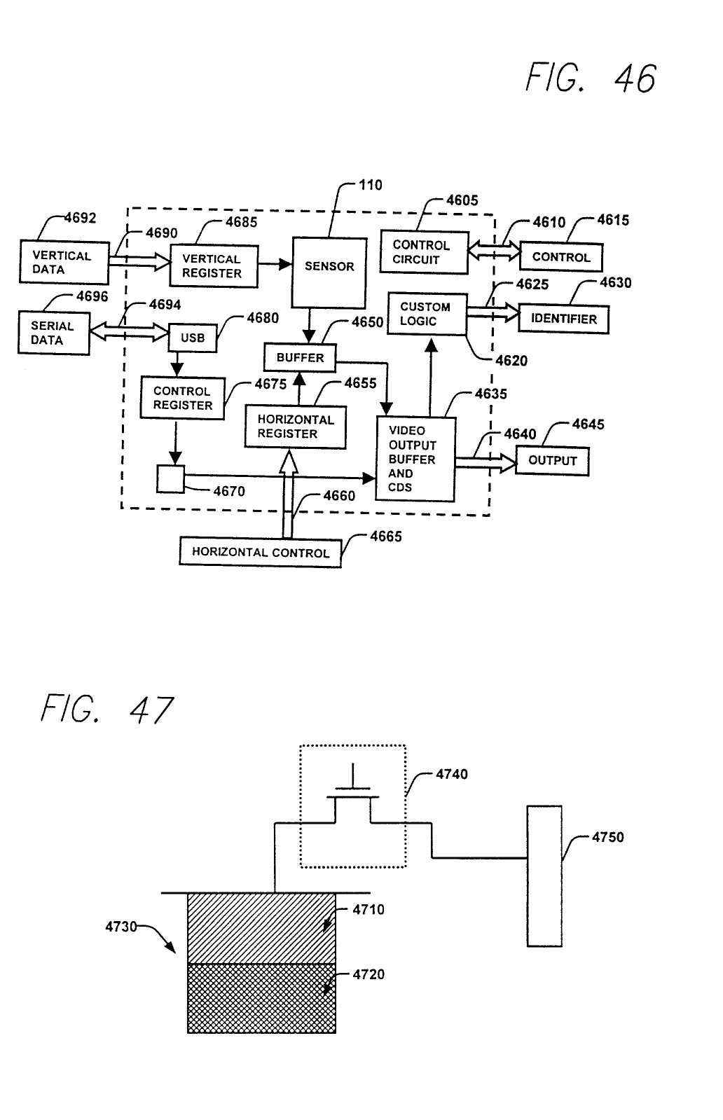

CMOS pixel-array construction uses active or passive pixels. APSs include amplification circuitry in each pixel. Passive pixels use a photodiode to collect the photocharge, and active pixels can be photodiode or photogate pixels (FIG. 47).

### Sensor Types

Various forms of sensors are suitable for use in conjunction with the imager/reader of the present invention. These include the following examples:

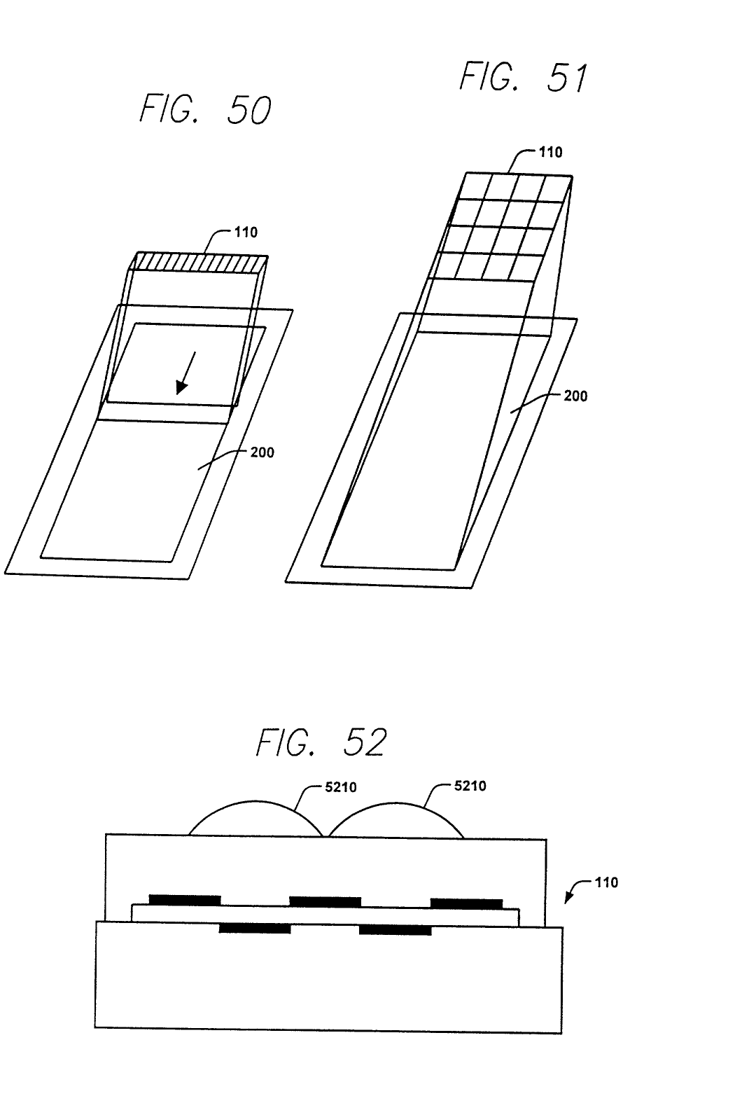

1. Linear sensors, which also are found in digital copiers, scanners, and fax machines. These tend to offer the best combination of low cost and high resolution. An imager using linear sensors will sequentially sense and transfer each pixel row of the image to an on-chip buffer. Linear-sensor-based imagers have relatively long exposure times, therefore, as they either need to scan the entire scene, or the entire scene needs to pass in front of them. These sensors are illustrated in FIG. 50, where reference numeral 110 refers to the linear sensor.

2. Full-frame-area sensors have high area efficiency and are much quicker, simultaneously capturing all of the image pixels. In most camera applications, full-frame-area sensors require a separate mechanical shutter to block light before and immediately after an exposure. After exposure, the imager transfers each cell's stored charge to the ADC. In imagers used in the industrial applications, the sensor is equipped with an electronic shutter. An exemplary full-frame sensor is illustrated in FIG. 51, where reference numeral 110 refers to the full-frame sensor.

3. The third and most common type of sensor is the interline-area sensor. An interline-area sensor contains both charge-accumulation elements and corresponding light-blocked, charge-storage elements for each cell. Separate charge-storage elements remove the need for a costly mechanical shutter and also enable slow-frame-rate video display on the LCD of the imager. However, the area efficiency is low, causing a decrease in either sensitivity or resolution, or both for a given sensor size. Also, a portion of the light striking the sensor does not actually enter a cell unless the sensor contains microlenses (FIG. 52).

4. The last and most suitable sensor type for industrial imagers is the progressive area sensor where lines of pixels are scanned so that analysis can begin as soon as the image begins to emerge.

5. There is also a new generation of sensors, called “clock-less, X-Y Addressed Random Access Sensor”, designed mostly for industrial and vision applications.

Regardless of which sensor type is used, still-image sensors have far more stringent requirements than their motion-image alternatives used in the video camera market. Video includes motion, which draws our attention away from low image resolution, inaccurate color balance, limited dynamic range, and other shortcomings exhibited by many video sensors. With still images and still cameras, these errors are immediately apparent. Video scanning is interlaced, while still-image scanning is ideally progressive. Interlaced scanning with still-image photography can result in pixel rows with image information shifted relative to each other. This shifting is due to subject motion, a phenomenon more noticeable in still images than in video imaging.

Cell dimensions are another fundamental difference between still and video applications. Camcorder sensor cells are rectangular (often with 2-to-1 horizontal-to-vertical ratios), corresponding to television and movie screen dimensions. Still pictures look best with square pixels 400, analogous to film “grain”.

Camera manufacturers often use sensors with rectangular pixels. Interpolation techniques also are commonly used. Interpolation suffers greater loss of resolution in the horizontal direction than in the vertical but otherwise produces good results. Although low-end cameras or imagers may not produce images comparable to 35 mm film images if we enlarge the images to 5×7 inches or larger, imager manufacturers carefully consider their target customers' usage when making feature decisions. Many personal computers (including the Macintosh from Apple Computer Corp.) have monitor resolutions on the order of 72 lines/inch, and many images on World Wide Web sites and e-mail images use only a fraction of the personal computer display and a limited color palette.

However, in industrial applications and especially in optical code reading devices, the MEW of a decodable optical code, imaged into the sensor, is a function of both the lens magnification and the distance of the target from the imagers (especially for high density symbologies). Thus, an enlarged frame representing the targeted area usually requires a “one million-pixel” or higher resolution image sensor.

### CMOS, CMD and CCD sensors

The process of CMOS image-sensor closely resembles those of microprocessors and ASICs because of similar diffusion and transistor structures, with several metal layers and two-layer polysilicon producing optimal image sensors. The difference between CMOS image-sensor processes and more advanced ASIC processes is that decreasing feature size works well for the logic circuits of ASIC processes but does not benefit pixel construction. Smaller pixels mean lower light sensitivity and smaller dynamic range; thus, even though the logic circuits decrease in area. Thus, the photosensitivity area can shrink only so far before diminishing the benefit of decreasing silicon area. FIG. 45 illustrates an example of a full-scale integration on a chip for an intelligent sensor.

Despite the mainstream nature of the CMOS process, most foundries require implant optimization to produce quality CMOS image-sensor arrays. Mixed signal capability is also important for producing both the analog circuits for transferring signals from the array and the analog processing for noise cancellation. A standard CMOS process also lacks processing steps for color filtering and microlens deposition. Most CMOS foundries also exclude optical packaging. Optical packaging requires clean rooms and flat glass techniques that make up much of the cost of CCDs. Although both CMOS and CCDs can be used in conjunction with the present invention, there are various advantages related to using CMOS sensors. For example:

1) CMOS imagers require only one supply voltage while CCDs require three or four. CCDs need multiple supplies to transfer charge from pixel to pixel and to reduce dark current noise using “surface state pinning” which is partially responsible for CCDs' high sensitivity and dynamic range. Eventually, high quality CMOS sensors may revert to this technique to increase sensitivity.

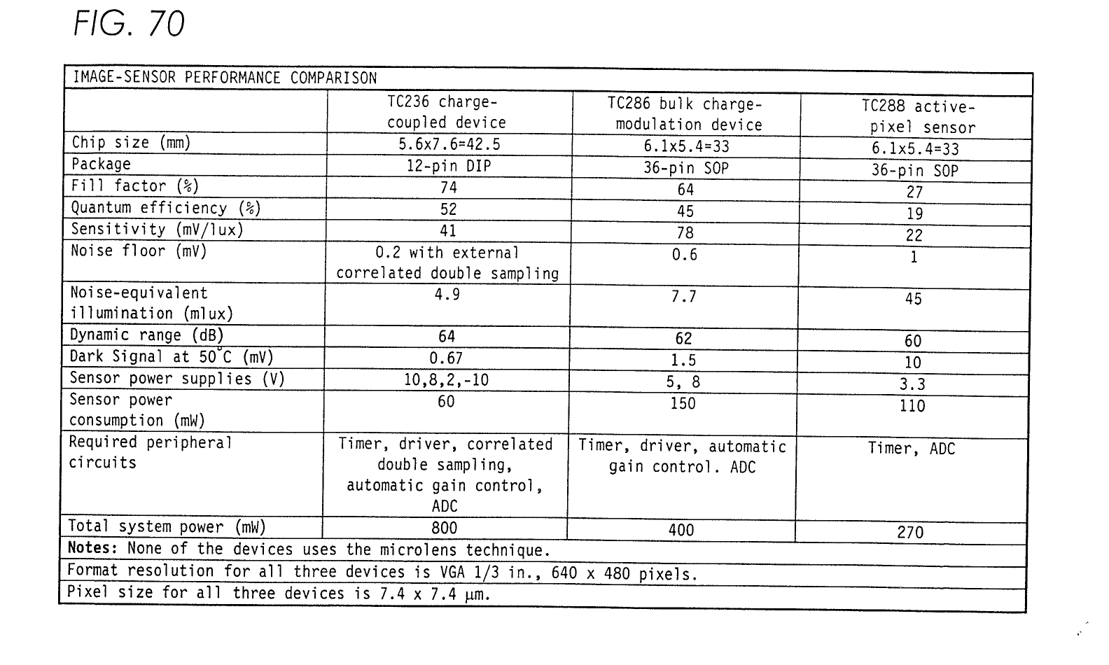

2) Estimates of CMOS power consumption range from one third to 100 times less than that of CCDs. A CCD sensor chip actually uses less power than the CMOS, but the CCD support circuits use more power, as illustrated in FIG. 70. Embodiments that depend on batteries can benefit from CMOS image sensors.

3) The architecture of CMOS image arrays provides an X-Y coordinate readout. Such a readout facilitates windowed and scanning readouts that can increase the frame rate at the expense of resolution or processed area and provide electronic zoom functionality. CMOS image arrays can also perform accelerated readouts by skipping lines or columns to do such tasks as viewfinder functions. This is done by providing a fully clock-less and X-Y addressed random-access imaging readout sensor known as an ARAMIS. CCDs, in contrast, perform a readout by transferring the charge from pixel to pixel, reading the entire image frame.

4) Another advantage to CMOS sensors is their ability to integrate DSP. Integrated intelligence is useful in devices for high-speed applications such as two dimensional optical code reading; or digital fingerprint and facial identification systems that compare a fingerprint or facial features with a stored pattern to determine authenticity. An integrated DSP leads to a low-cost and smaller product. These criteria outweigh sensitivity and dynamic response in this application. However, mid-performance and high-end-performance applications can more efficiently use two chips. Separating the DSP or accelerators in an ASIC and the microprocessor from the sensor protects the sensor from the heat and noise that digital logic functions generate. A digital interface between the sensor and the processor chips requires digital circuitry on the sensor.

5) One of the most often-cited advantages of CMOS APS is the simple integration of sensor-control logic, DSP and microprocessor cores, and memory with the sensor.

Digital functions add programmable algorithm processing to the device. Such tasks as noise filtering, compression, output-protocol formatting, electronic-shutter control, and sensor-array control enhance the device, as does the integration of ARAMIS along with ADC, memory, processor and communication device such as a USB or parallel port on a single chip. FIG. 45 provides an example of connecting cores and blocks and the different number of layers of interconnect for the separate blocks of a SOC imaging device.

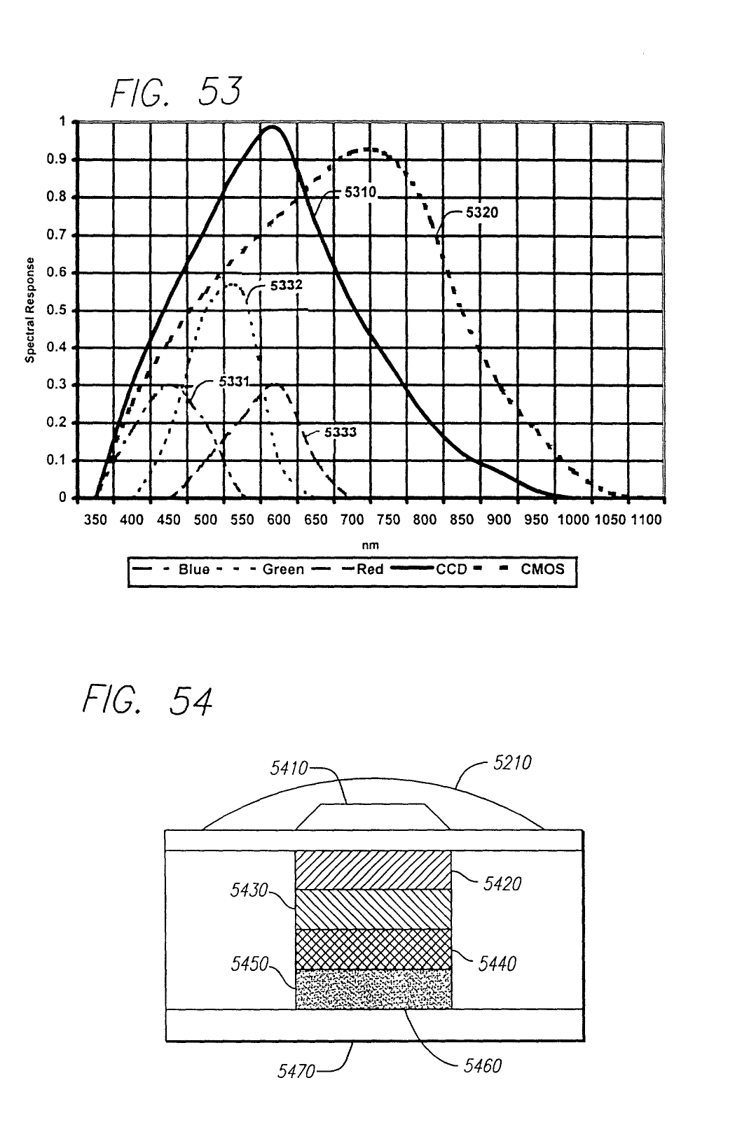

6) The spectral response of CMOS image sensors goes beyond the visible range and into the infrared (IR) range, opening other application areas. The spectral response is illustrated in FIG. 53, where line 5310 refers to the response in a typical CCD, 5320 refers to a typical response in a CMOS, line 5333 refers to red, line 5332 refers to and line 5331 refers to blue. These lines also show the spectral response of visible light versus IR light. IR vision applications include better visibility for automobile drivers during fog and night driving, and security imagers and baby monitors that “see” in the dark.

CMOS pixel arrays have some disadvantages as well. CMOS pixels that incorporate active transistors have reduced sensitivity to incident light because of a smaller light-sensitive area. Less light sensitivity reduces the quantum efficiency to far less than that of CCDs of the same pixel size. The added transistors overcome the higher signal-to-noise (“S/N”) ratio during readout but introduce some problems of their own. The CMOS APS has readout-noise problems because of uneven gain from mismatched transistor thresholds, and CMOS pixels have a problem with dark or leakage current.

FIG. 70 provides a performance comparison of a CCD (model no. TC236), a bulk CMD (model no. TC286) (“BCMD”) with two transistors per pixel, and a CMOS APS with four transistors per pixel (model no. TC288), all from Texas Instruments. This figure illustrates the performance characteristics of each technology. All three devices have the same resolution and pixel size. The CCD chip is larger, because it is a frame-transfer CCD, which includes an additional light-shielded frame-storage CCD into which the image quickly transfers for readout so the next integration period can begin.

The varying fill factors and quantum efficiencies show how the APS sensitivity suffers from having active circuits and associated interconnects. As mentioned, microlenses would double or triple the effective fill factor but would add to the device's cost. The BCMD's sensitivity is much higher than that of the other two sensor arrays because of the gain from active circuits in the pixel. If we divide the noise floor, which is the noise generated in the pixel and signal-processing electronics, by the sensitivity, we arrive at the noise-equivalent illumination. This factor shows that the APS device needs 10 times more light to produce a usable signal from the pixel. The small difference between dynamic ranges points out the flexibility for designing BCMD and CMOS pixels. We can trade dynamic range for light sensitivity. By shrinking the photodiode, the sensitivity increases but the dynamic range decreases.

CCD and BCMD devices have much less dark current because they employ surface-state pinning. The pinning keeps the electrons 4710 released under dark conditions from interfering with the photon-generated electrons. The dark signal is much higher in the APS device because it does not employ surface-state pinning. However, pinning requires a voltage above or below the normal power-supply voltage; thus, the BCMD needs two voltage supplies.

Current CMOS-sensor products collect electrons released by infrared energy better than most, but not all, CCD sensors. This fact is not a fundamental difference between the technologies, however. The spectral response of a photodiode 5470 depends on the silicon-impurity doping and junction depth in the silicon. The lower frequency, longer wavelength photons penetrate deeper in the silicon (see FIG. 54). As illustrated in FIG. 54, element 5210 corresponds to the microlens, which is situated in proximity to substrate 5410. In such a frequency-dependent penetration as this, the visible spectrum causes the photovoltaic reaction within the first 2.2 μm of the photon's entry surface (illustrated with elements 5420, 5430 and 5440, corresponding to blue, green and red, although any ordering of these elements may be used as well), whereas the IR response happens deeper (as indicated in element 5450). The interface between these reactive layers is indicated with reference number 5460. In one embodiment, a CCDs that is less IR-sensitive can be used in which the vertical antiblooming overflow structure acts to sink electrons from an over saturated pixel. The structure sits between the photosite and the substrate to attract overflow electrons. It also reduces the photosite's thickness, thereby prohibiting the collection of IR-generated electrons. CMOS and BCMD photodiodes 4730 go the full depth (about 5 to 10 μm) to the substrate and therefore collect electrons that IR energy releases. CCD pixels that use no vertical-overflow antiblooming structures also have usable IR response.

The best image sensors require analog-signal processing to cancel noise before digitizing the signal. The charge-integration amplifier, S/H circuits, and correlated-double-sampling circuits (“CDS”) are examples of required analog devices that can also be integrated on one chip as part of “on-chip” intelligence.

The digital-logic integration requires an on-chip ADC to match the performance of the intended application. Consider that the high-definition-television format of 720×1280-pixel progressive scan at 60 frames/sec requires 55.3M samples/sec, and we can see the ADC-performance requirements. In addition, the ADC creates no substrate noise or heat that interferes with the sensor array.

These considerations lead to process modifications. For example, the Motorola MOS12 fabrication line is adding enhancements to create the ImageMOS technology platform. ImageMOS begins with the 0.5 μm, 8 inches wafer line that produces DSPs and microcontrollers. ImageMOS has mixed-signal modules to ensure that circuits are available for analog-signal processing. Also, by adding the necessary masks and implants, we can produce quality sensor arrays from an almost-standard process flow. ImageMOS enhancements include color-filter-array and microlens-deposition steps. A critical factor in adding these enhancements is ensuring that they do not impact the fundamental digital process. This undisturbed process maintains the digital core libraries that create custom and standard image sensors from the CMOS process.

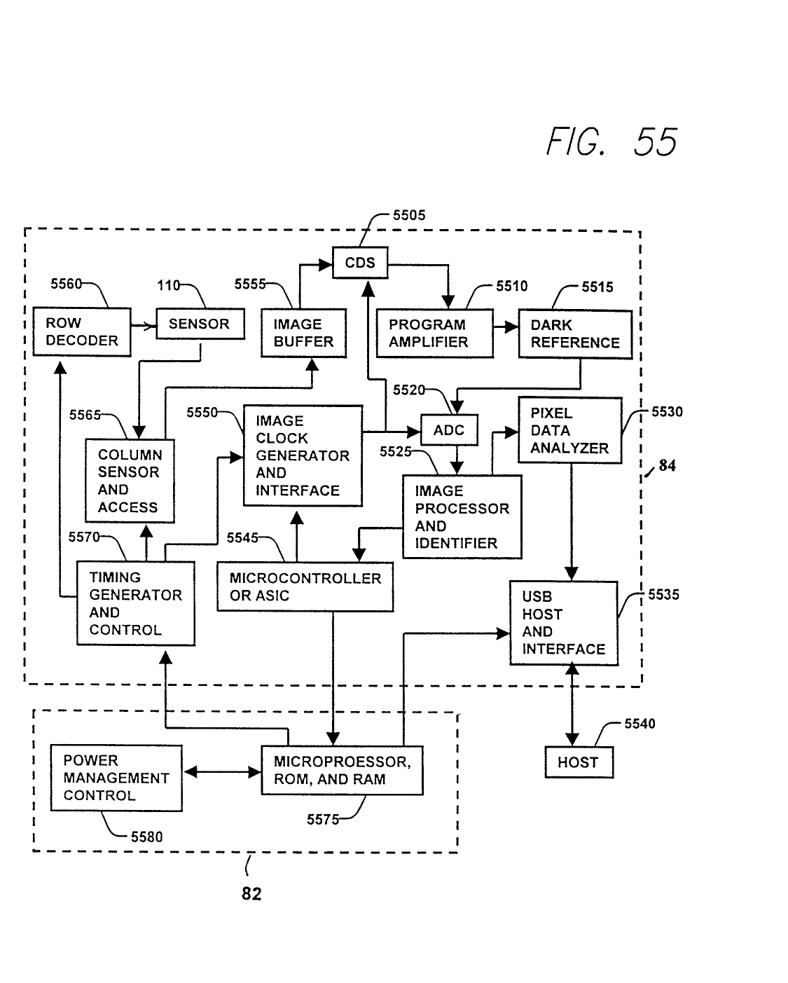

FIG. 55 illustrates an example of a suitable two-chip set, using mixed signals on the sense and capture blocks. Further integration as described in this invention, can reduce the number of chips to only one. In the illustrated embodiment, the sensor 110 is integrated on chip 82. Row decoder 5560 and column decoder 5565 (also labeled column sensor and access), along with timing generator 5570 provide vertical and horizontal address information to sensor 110 and image clock generator 5550. The sensor data is buffered in image buffer 5555 and transferred to the CDS 5505 and video amplifier, indicated by boxes 5510 and 5515. The video amplifier compares the image data to a dark reference for accomplishing shadow correction. The output is sent to ADC 5520 and received by the image processing and identification unit 5525 which works with the pixel data analyzer 5530. The ASIC or microcontroller 5545 processes the image data, as received from image identification unit 5525 and optionally calculates threshold values and the result is decoded by processor unit 5575, such as on a second chip 84. It is noted that processor unit 5575 also may include associated memory devices, such as ROM or RAM memory and the second chip is illustrated as having a power management control unit 5580. The decoded information is also forwarded to interface 5535, which communicates with the host 5540. It is noted that any suitable interface may be used for transferring the data between the system and host 5540. In handheld and battery operated embodiments of the present invention, the power management control 5580 control power management of the entire system, including chips 82 and 84. Preferably only the chip that is handling processing at a given time is powered, reducing energy consumption during operation of the device.

Many imagers employ an optical pre-filter, behind the lens and in front of the image sensor. The pre-filter is a piece of quartz that selectively blurs the image. This pre-filter conceptually serves the same purpose as a low-pass audio filter. Because the image sensor contains fixed spacing between pixels, light wavelengths shorter than twice this distance can produce aliasing distortion if they strike the sensor. We should notice the similarity to the Nyquist audio-sampling frequency.

A similar type of distortion comes from taking a picture containing edge transitions that are too close together for the sensor to accurately resolve them. This distortion often manifests itself as color fringes around an edge or as a series of color rings known as a “moire pattern”.

### Foveated Sensors

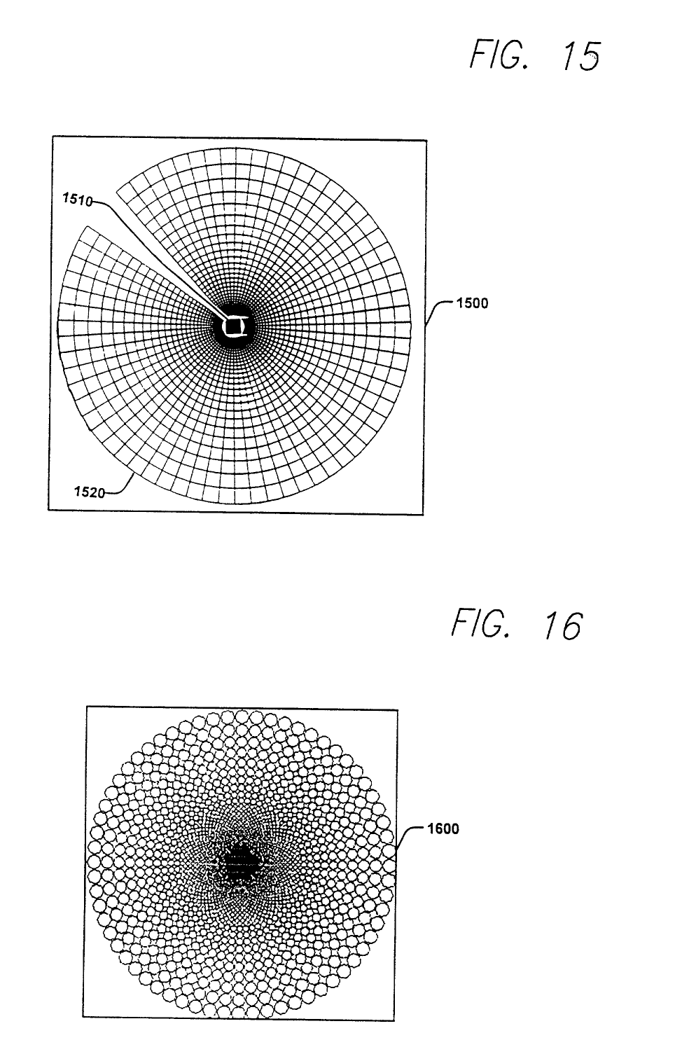

Visible light sensors, such as CCD or CMOS sensors, which can emulate the human eye retina can reduce the amount of data. Most commercially available CCD or CMOS image sensors use arrays of square or rectangular regularly spaced pixels to capture images. Although this results in visually acceptable images with linear resolution, the amount of data generated can overwhelm all but the most sophisticated processors. For example, a 1K×1K pixels array provides over one million pixels representing data to be processed. Particularly in pattern-recognition applications, visual sensors that mimic the human retina can reduce the amount of data while retaining a high resolution and wide field of view. Such space-variant devices known as foveated sensors have been developed at the University of Genoa (Genoa, Italy) in collaboration with IMEC (Belgium) using CCD and CMOS technologies. Foveated vision reduces the amount of processing required and lends itself to image processing and pattern-recognition tasks that are currently performed with uniformly spaced imagers. Such devices closely match the way human beings focus on images. Retina-like sensors have a spatial distribution of sensing elements that vary with eccentricity. This distribution, which closely matches the distribution of photoreceptors in the human retina, is useful in machine vision and pattern recognition applications. In robotic systems, the low-resolution periphery of the fovea locates areas of interest and directs the processor 150 to the desired portion of the image to be processed. In the CCD design built for experimentation 1500, the sensor has a central high-resolution rectangular region 1510 and successive circular outer layers 1520 with decreasing resolution. In the circular region, the sensor implements a log-polar mapping of Cartesian coordinates to provide scale-and rotation-invariant transformations. The prototype sensor comprises pixels arranged on 30 concentric circles, each with 64 photosensitive sites. Pixel size increase from 30×30 micrometer at the inner circle to 412×412 micrometer at the periphery. With a video rate of 50 frames per second, the CCD sensor generates images with 2Kbytes per frame. This allows the device to perform computations such as the impact time of a target approaching the device with un-matching performance. The pixel size, number of rings, and number of pixels per ring depends on the resolution required by the application. FIG. 15 provides a simplified example of retina-like CCD 1500, with a spatial distribution of sensing elements that vary with eccentricity. Note that a “slice” is missing from the full circle. This allows for the necessary electronics to be connected to the interior of the retinal structure. FIG. 16 provides a simplified example of a retina-like sensor 1600 (such as CMD or CMOS) that does not require a missing “slice.”

### Back-lit CCD

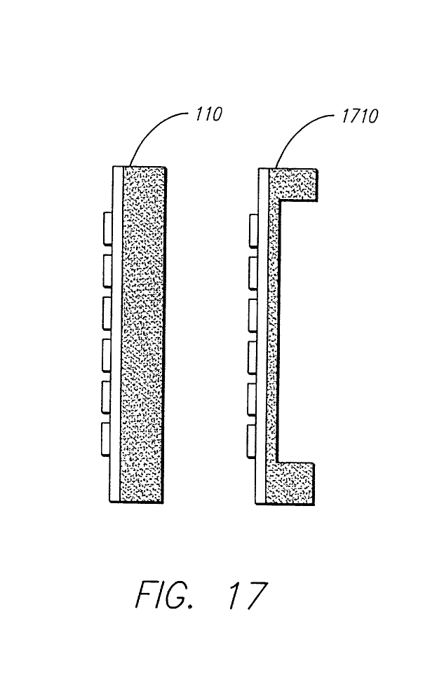

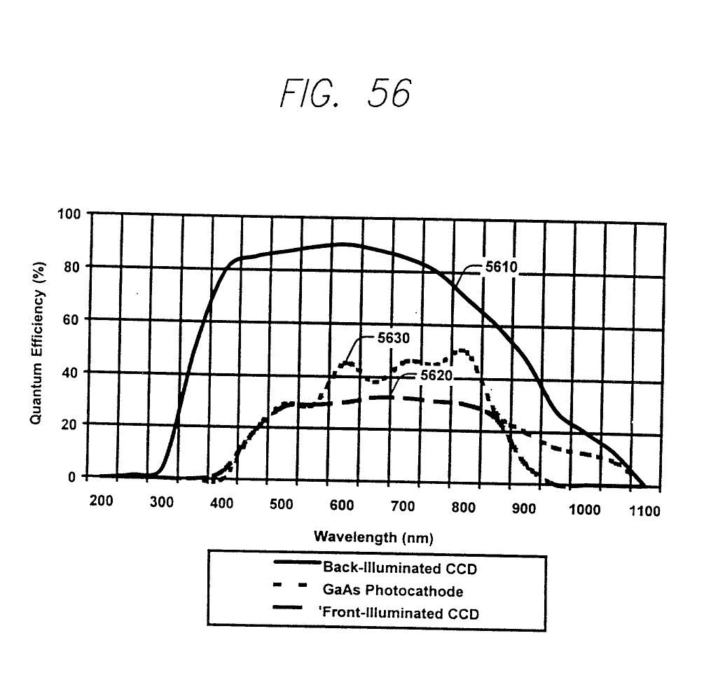

The spectral efficiency and sensitivity of a conventional front-illuminated CCD 110 typically depends on the characteristics of the polysilicon gate electrodes used to construct the charge integrating wells. Because polysilicon absorbs a large portion of the incident light before it reaches the photosensitive portion of the CCD, conventional front-illuminated CCD imagers typically achieve no better than 35% quantum efficiency. The typical readout noise is in excess of 100 electrons, so the minimum detectable signal is no better than 300 photon per pixel, corresponding to 10-2 lux (1/100 lux), or twilight conditions. The majority of CCD sensors are manufactured for the camcorder market, compounding the problem as the economics of the camcorder and video-conferencing markets drives manufacturing toward interline transfer devices that are increasingly smaller in area. The interline transfer (called also interlaced technique versus progressive or frame transfer techniques) CCD architecture is less sensitive than the frame transfer CCD because metal shields approximately 30% of the CCD. Thus, users requiring low light-level performance (toward the far end edge of the depth of field) are witnessing a shift in the marketplace that is moving toward low-fill-factor, smaller area CCDs that are less useful for low-light level imaging. To increase the low-light-level imaging capability of the CCDs, image intensifiers are commonly used to multiply incoming photons so that they can be passed through a device such as a phosphor-coated fiber optic face plate to be detected by a CCD. Unfortunately, noise introduced by the microchannel plate of the image-intensifiers degrades the signal-to-noise ratio of the imager. In addition, the poor dynamic range and contrast of the image intensifier can degrade the quality of the intensified image. Such a system must be operated at high gain thereby increasing the noise. It is not suitable for Automatic identification or multimedia markets where the suit spot is considered to be between 5 to 15 inches (very long range applications requires 5 to 900 inches). Thinned, back illuminated CCDs overcome the performance limits of the conventional front-illuminated CCD by illuminating and collecting charge through the back surface away from polysilicon electrodes. FIG. 17 illustrates side views of a conventional CCD 110 and a thinned back-illuminated CCD 1710. When the CCD is mounted face down on a substrate and the bulk silicon is removed, only a thin layer of silicon containing the circuit's device structures remains. By illuminating the CCD in this manner, quantum efficiency greater than 90% can be achieved. As the first link in the optical chain, the responsivity is the most important feature in determining system S/N performance. The advantages of back illumination are 90% quantum efficiency, allowing the sensor to convert nearly every incident photon into an electron in the CCD well. Recent advantages in CCD design and semiconductor processing have resulted in CCD readout amplifiers with noise levels of less than 25 electrons per pixel at video rates. Several manufacturers have reported such low-noise performance with high definition video amplifiers operating in excess of 35 MHz. The 90% quantum efficiency of a back illuminated CCD, in combination with low-noise amplifiers provides noise-equivalent sensitivities of approximately 30 photons per pixels, 10-4 lux without any intensification. This low-noise performance will not suffer the contrast degradation commonly associated with an image intensifier. FIG. 56 is a plot of quantum efficiency v. wavelength of back-illuminated CCD sensor compared to front illumination CCD and to the response of a Gallium Arsenide photo-cathode. Line 5610 represents a back-illuminated CCD, line 5630 represents a GaS photocathode and line 5620 represents a front illuminated CCD.

### Per pixel processing

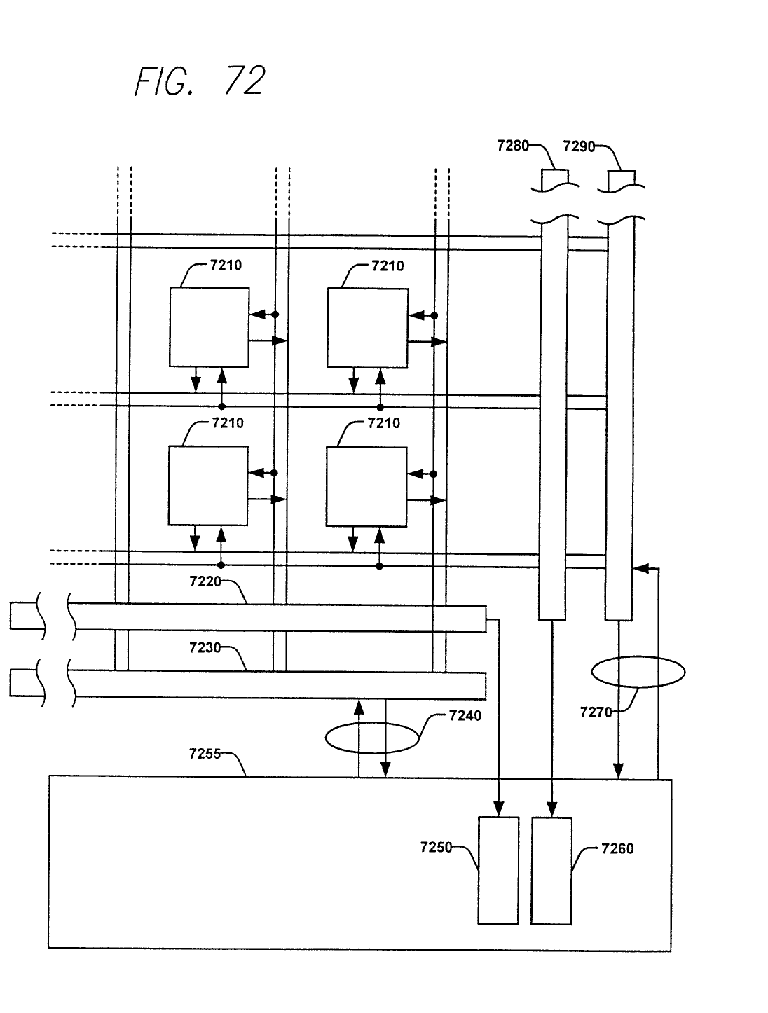

Per pixel processors also can be used for real time motion detection in an embodiment of the invention. Mobile robots, self-guided vehicles, and imagers used to capture motion images often use image motion information to track targets and obtain depth information. Traditional motion algorithms running on Von-Neumann processing architecture are computationally intensive, preventing their use in real-time applications. Consequently, researchers developing image motion systems are looking to faster, more unconventional processing architecture. One such architecture is the processor per-pixel design, an approach that assigns a processor (or processor task) to each pixel. In operation, pixels signal their position when illumination changes are detected. Smart-pixels can be fabricated on 1.5-mm CMOS and 0.8-mm BiCMOS. Low-resolution prototypes currently integrate a 50×50 smart sensor array with integrated signal processing capabilities. An exemplary embodiment of an example of the invention is illustrated in FIG. 72. In this illustrated embodiment, each pixel 7210 of the sensor 110 is integrated on chip 70. Each pixel can integrate a photo detector 7210, an analog signal-processing module 7250 and a digital interface 7260. Each sensing element is connected to a row bus 7280 and column bus 7220, as well as row logic 7290 and column logic 7230. Data exchange between pixels 7210, module 7250 and interface 7260 is secured as indicated with reference numerals 7270 and 7240. The substrate 7255 also may include an analog signal processor, digital interface and various sensing elements.

Each pixel can integrate a photo detector, an analog signal-processing module and a digital interface. Pixels are sensitive to temporal illumination changes produced by edges in motion. If a pixel detects an illumination change, it signals its position to an external digital module. In this case, time stamps from a temporal reference are assigned to each sensor request. These time stamps are then stored in local RAM and are later used to compute velocity vectors. The digital module also controls the sensor's analog Input and Output (“I/O”) signals and interfaces the system to a host computer through the communication port (i.e., USB port).

### Illumination

An exemplary optical scanner 100 incorporates a target illumination device 1110 operating within visible spectrum. In a preferred embodiment, the illumination device includes plural LEDs. Each LED would have a peak luminous intensity of 6.5 lumens/steradian (such as the HLMT-CL00 from Hewlett Packard) with a total field angle of 8 degrees, although any suitable level of illumination may be selected. In the preferred embodiment, three LEDs are placed on both sides of the lens barrel and are oriented one on top of the other such that the total height is approximately 15 mm. Each set of LEDs is disposed with a holographic optical element that serves to homogenize the beam and to illuminate a target area corresponding to the wide field of view.

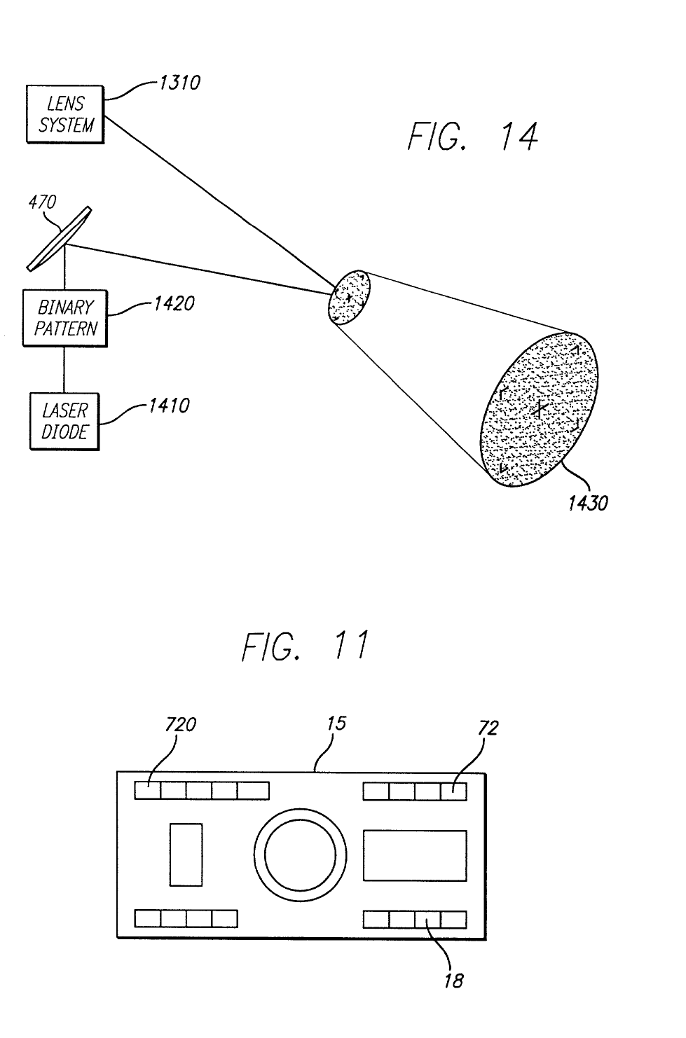

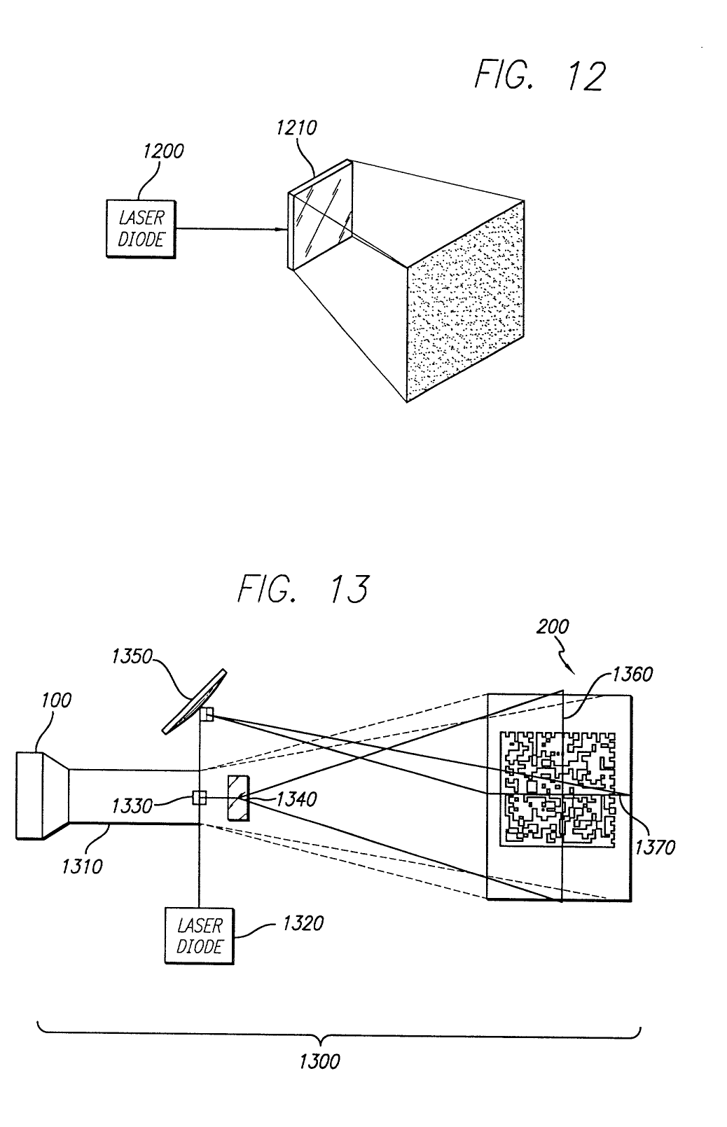

FIG. 12 illustrates an alternative system to illuminate the target 200. Any suitable light source can be used, including a flash light (strobe) 1130, halogen light (with collector/diffuser on the back) 1120 or a battery of LEDs 1110 mounted around the lens system 1310 (with or without collector/diffuser on the back or diffuser on the front) making it more suitable because of the MTBF of the LEDs. A laser diode spot 1200 also can be used combined with a holographic diffuser to illuminate the target area called the Field Of View (This method is described in previous applications of the current inventor, listed before. Briefly, the holographic diffuser 1210 receives and projects the laser light according to the predetermined holographic pattern angles in both X and Y direction toward the target as indicated by FIG. 12).

### Frame Locator

FIG. 14 illustrates an exemplary apparatus for framing the target 200. This frame locator can be any binary optics with pattern or grading. The first order beam can be preserved to indicate the center of the target, generating the pattern 1430 of four corners and the center of the aimed area. Each beamlet is passing through a binary pattern providing “L” shape image, to locate each corner of the field of view and the first order beam was locating the center of the target. A laser diode 1410 provides light to the binary optics 1420. A mirror 1350 can, but does not need to be, used to direct the light. Lens system 1310 is provided as needed.

In an alternative embodiment shown in FIG. 13, the framing locator mechanism 1300 utilizes a laser diode 1320, a beam Splitter 1330 and a mirror 1350 or diffractive optical element 1350 that produces two spots. Each spot will produce a line after passing through the holographic diffuser 1340 with an spread of 1×30 along the X and/or Y axis, generating either a horizontal line 1370 or a crossing vertical line 1360 across the filed of view or target 200, indicating clearly the field of view of the zoom lens 1310. The diffractive optic 1350 is disposed along with a set of louvers or blockers (not shown) which serve to suppress one set of two spots such that only one set of two spots is presented to the operator.

We could also cross the two parallel narrow sheets of light (as described in my previous applications and patents as listed above) in different combinations parallel on X or Y axis and centered, left or right positioned crossing lines when projected toward the target 200.

### Data Storage Media

FIG. 20 illustrates a form of data storage 2000 for an imager or a camera where space and weight are critical design criteria. Some digital cameras accommodate removable flash memory cards for storing images and some offer a plug-in memory card or two. Multimedia Cards (“MMC”) can be used as they offer solid-state storage devices. Coin-size 2M and 4Mbyte MMC is a good solution for hand held devices such as digital imagers or digital cameras. The MMC technology was introduced by Siemens (Germany), late in 1996 and uses vertical 3-D transistor cells to pack about twice as much storage in an equivalent die compared with conventional planar-masked ROM and is also 50% less expensive. SanDisk (Sunnyvale, Calif.), the father of CompactFlash, joined Siemens in late 1997 in moving MMC out of the lab and into the production. MMC has a very low power dissipation (20 milliwatt @20 MHz operation and under 0.1 milliwatt in standby). The originality of MMC is the unique stacking design, allowing up to 30 MMC to be used in one device. Data rates range from 8 megabits/second up to 16 megabits/second, operating over a 2.7 V to 3.6 V range. Software-emulated interfaces handle low-end applications. Mid and high-end applications require dedicated silicon.

### Low-cost Radio Frequency (RF) on a Silicon chip

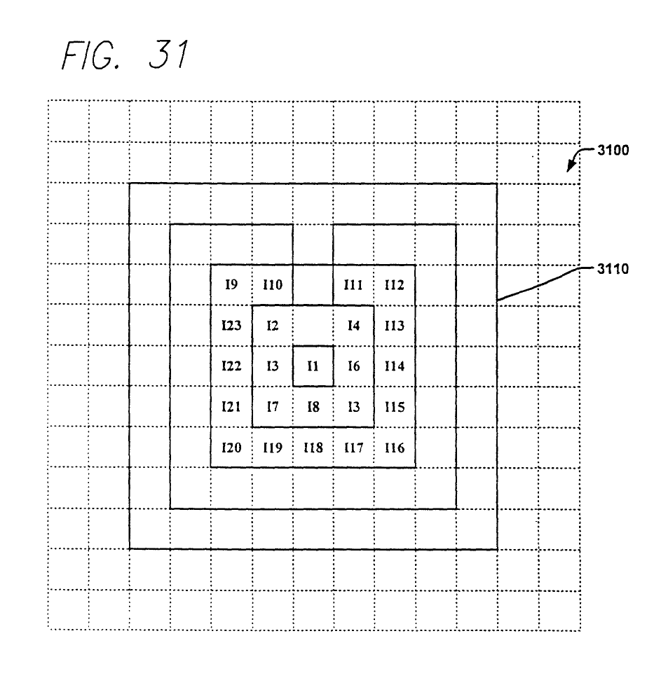

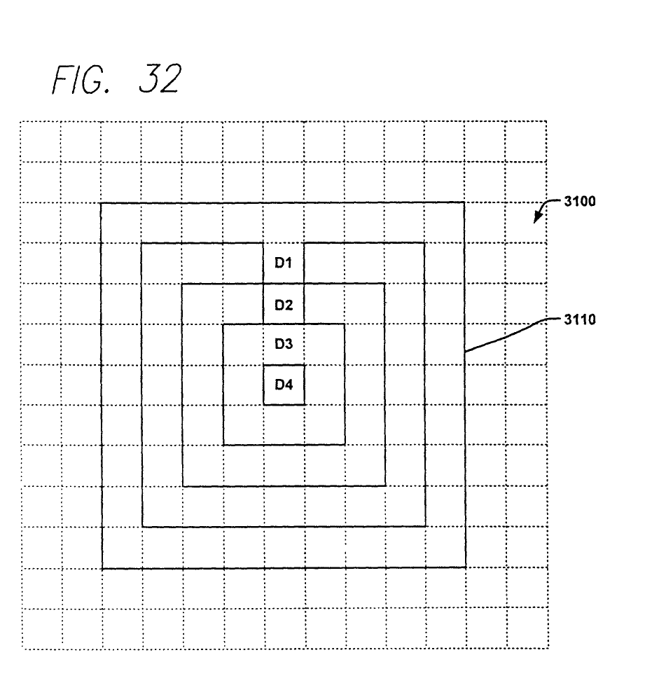

In many applications, a single read of a Radio Frequency Identification (“RFID”) tag is sufficient to identify the item within the field of a RF reader. This RF technique can be used for applications such as Electronic Article Surveillance (“EAS”) used in retail applications. After the data is read, the imager sends an electric current to the coil 2100. FIG. 22 illustrates a device 2210 for creating an electromagnetic field in front of the imager 100 that will deactivate the tag 2220, allowing the free passage of article from the store (usually, store doors are equipped with readers allowing the detection of a non-deactivated tag). Imagers equipped with EAS feature are used in libraries as well as in book, retail, and video stores. In the growing number of uses, the simultaneous reading of several tags in the same RF field is an important feature. Examples of multiple tag reading applications include reading grocery items at once to reduce long waiting lines at checkout points, airline-baggage tracking tags and inventory systems. To read multiple tags 2220 simultaneously the tag 2220 and the reader 2210 must be designed to detect the condition that more than one tag 2220 is active. With a bidirectional interface for programming and reading the content of a user memory, tags 2220 are powered by an external RF transmitter through the tag's 2220 inductive coupling system. In read mode, these tags transmit the contents of their memory, using damped amplitude modulation (“AM”) of an incoming RF signal. The damped modulation (dubbed backscatter), sends data content from the tag's memory back to the reader for decoding. Backscatter works by repeatedly “de-Qing” the tag's coil through an amplifier (see FIG. 31). The effect causes slight amplitude fluctuations in the reader's RF carrier. With the RF link behaving as a transformer, the secondary winding (tag coil), is momentarily shunted, causing the primary coil to experience a temporarily voltage drop. The detuning sequentially corresponds to the data being clocked out of the tag's memory. The reader detects the AM data and processes the bit-stream according to selected encoding and data modulation methods (data bits are encoded or modulated in a number of ways).

The transmission between the tag and the reader is usually on a hand shake basis. The reader continuously generates an RF sine wave and looks for modulation to occur. The modulation detected from the field indicates the presence of a tag that has entered the reader's magnetic field. After the tag has received the required energy to operate, it separates the carrier and begins clocking its data to an output of the tag's amplifier, normally connected across the coil inputs. If all the tags backscatter the carrier at the same time, data would be corrupted without being transferred to the reader. The tag to reader interface is similar to a serial bus, but the bus is the radio link. The RFID interface requires arbitration to prevent bus contention, so that only one tag transmits data. Several methods are used for preventing collisions, to making sure that only one tag speaks at any one time.

### Battery on a Silicon chip

In many battery operated and wireless applications, energy capacity of the device and number of hours of operation before the batteries are to be replaced or charged is very important. The use of solar cells to provide voltage to rechargeable batteries has been known for many years (used mainly in the calculators). However, this conventional technique, using the crystal silicon for re-charging the main batteries, has not been successful because of the low current generated by solar cells. Integrated-type amorphous silicon cells 2300, called “Amorton”, can be made into modules 2300 which, when connected in a sufficient number in series or in parallel on a substrate during cell formation, can generate sufficient voltage output level with high current to operate battery operated and wireless devices for more then 10 hours. Amorton can be manufactured in a variety of forms (square, rectangular, round, or virtually any shape).

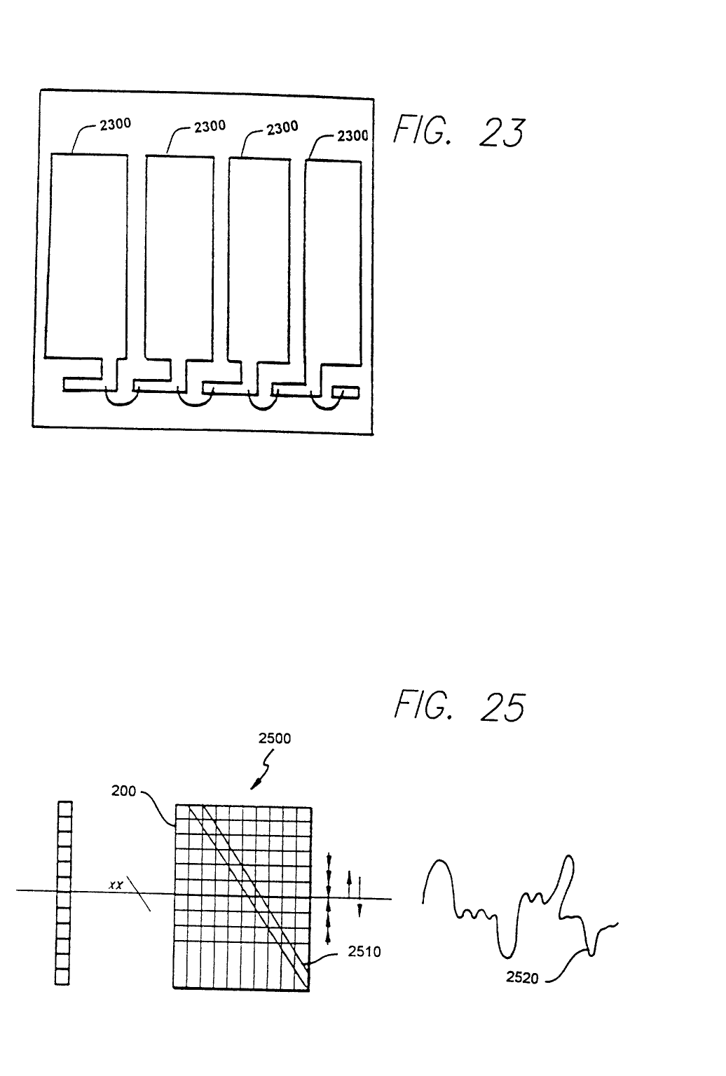

These silicon solar cells are formed using a plasma reaction of silane, allowing large area solar cells to be fabricated much more easily than the conventional crystal silicon. Amorphous silicon cells 2300 can be deposited onto a vast array of insulation materials including glass and ceramics, metals and plastics, allowing the exposed solar cells to match any desired area of the battery operated devices (for example; cameras, imagers, wireless cellular phones, portable data collection terminals, interactive wireless headset, etc.) while they provide energy (voltage and current) for its operations. FIG. 23 is an example of amorphous silicon cells 2300 connected together.

### Chameleon

The present invention also relates to an optical code which is variable in size, shape, format and color; that uses one, two and three-dimensional symbology structures. The present invention describing the optical code is referred to herein with the shorthand term “Chameleon”.

One example of such optical code representing one, two, and three dimensional symbologies is described in patent application Ser. No. 8/058,951, filed May 7, 1993 which also discloses a color superimposition technique used to produce a three dimensional symbology, although it should be understood that any suitable optical code may be used.

Conventional optical codes, i.e., two dimensional symbologies, may represent information in the form of black and white squares, hexagons, bars, circles or poles, grouped to fill a variable-in-size area. They are referenced by a perimeter formed of solid straight lines, delimiting at least one side of the optical code called pattern finder, delimiter or data frame. The length, number, and or thickness of the solid line could be different, if more than one is used on the perimeter of the optical code. The pattern representing the optical code is generally printed in black and white. Examples of known optical codes also called two-dimensional symbologies, are Code 49 (not shown), Code 16k (not shown), PDF-417 2900, Data Matrix 2900, MaxiCode 3000, Code 1 (now shown), VeriCode 2900 and SuperCode (not shown). Most of these two dimensional symbologies have been released in the public domain to facilitate the use of two-dimensional symbologies by the end users.

The optical codes described above are easily identified by the human eye because of their well-known shapes and (usually) black and white pattern. When printed on a product they affect the appearance and attraction of packages for consumer, cosmetic, retail, designer, high fashion, and high value and luxury products.

The present invention would allow for optical code structures and shapes, which would be virtually unnoticeable to the human eye when the optical code is embedded, diluted or inserted within the “logo” of a brand.

The present invention provides flexibility to use or not use any shape of delimiting line, solid or shaded block or pattern, allowing the optical code to have virtually any shape and use any color to enhance esthetic appeal or increase security value. It therefore increases the field of use of optical codes, allowing the marking of an optical code on any product or device.

The present invention also provides for storing data in a data field of the optical code, using any existing codification structure. Preferably it is stored in the data field without a “quiet zone.”

The Chameleon code contains an “identifier” 3110 which is an area composed of a few cells, generally in a form of square or rectangle, containing the following information relative to the stored data (however an identifier can also be formed using a polygonal, circular or polar pattern). These cells indicate the code's 3100:

Direction and orientation as shown in FIGS. 31-32;

Number of rows and columns;

Type of symbology codification structure (i.e., DataMatrix 2900, Code 1 (not shown), PDF-417 2900);

Density and ratio;

Error correction information;

Shape and topology;

Print contrast and color information; and

Information relative to its position within the data field as the identifier can be located anywhere within the data field.

The Chameleon code identifier contains the following variables:

D1-D4, indicate the direction and orientation of the code as shown in FIG. 32;

X1-X5 (or X6) and Y1-Y5 (or Y6), indicate the number of rows and columns;

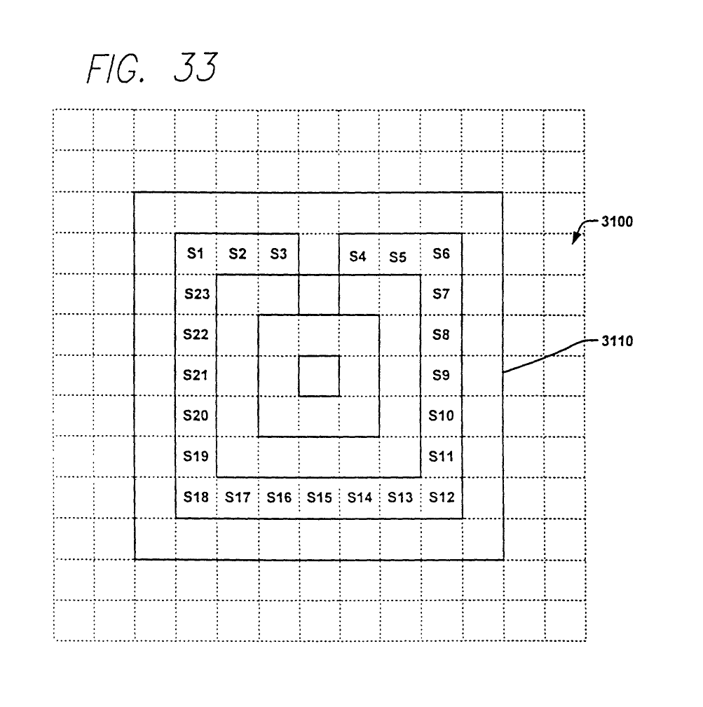

S1-S23, indicate the white guard illustrated in FIG. 33;

C1 and C2, indicate the type of symbology (i.e., DataMatrix 2900, Code 1 (not shown), PDF-417 2900)

C3, indicates density and ratio (C1, C2, C3 can also be combined to offer additional combinations);

E1 and E2, indicate the error correction information;

T1-T3, indicate the shape and topology of the symbology;

P1 and P2, indicate the print contrast and color information; and

Z1-Z5 and W1-W5, indicate respectively the X and the Y position of the identifier within the data field (the identifier can be located anywhere within the symbology).

All of these sets of variables (C1-C3, X1-X5, Y1-Y5, E1-E2, R1-R2, Z1-Z5, W1-W5, T1-T2, P1-P2) are use binary values and can be either “0” (i.e., white), or “1” (i.e., black).

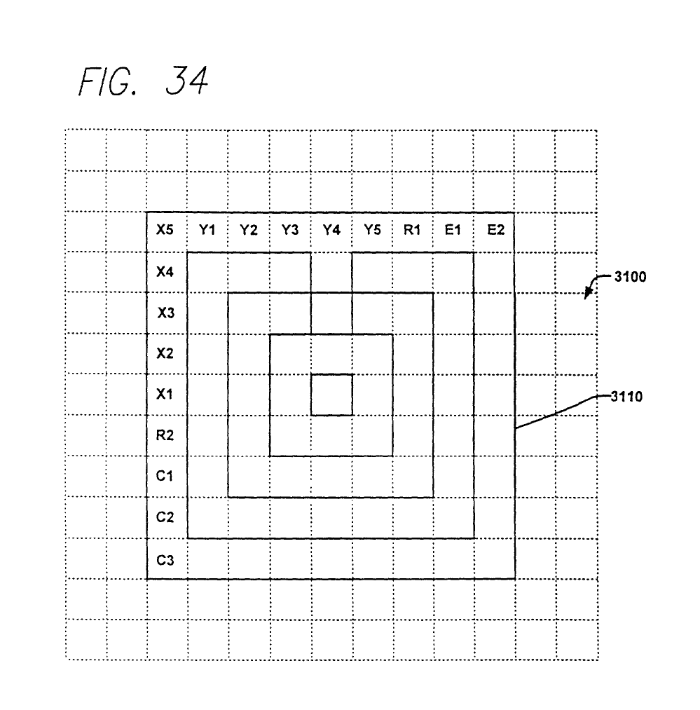

Therefore the number of combination for C1-C3 (FIG. 34) is:

| C1 | C2 | C3 | # | |
|---|---|---|---|---|
| 0 | 0 | 0 | 1 | i.e., DataMatrix |
| 0 | 0 | 1 | 2 | i.e., PDF-417 |
| 0 | 1 | 0 | 3 | i.e., VeriCode |
| 0 | 1 | 1 | 4 | i.e., Code 1 |
| 1 | 0 | 0 | 5 | |
| 1 | 0 | 1 | 6 | |
| 1 | 1 | 0 | 7 | |
| 1 | 1 | 1 | 8 | |

The number of combination for X1-X6 (illustrated in FIG. 34) is:

| X1 | X2 | X3 | X4 | X5 | X6 | # |
|---|---|---|---|---|---|---|
| 0 | 0 | 0 | 0 | 0 | 0 | 1 |
| 0 | 0 | 0 | 0 | 0 | 1 | 2 |
| 0 | 0 | 0 | 0 | 1 | 0 | 3 |
| 0 | 0 | 0 | 0 | 1 | 1 | 4 |
| 0 | 0 | 0 | 1 | 0 | 0 | 5 |
| 0 | 0 | 0 | 1 | 0 | 1 | 6 |
| 0 | 0 | 0 | 1 | 1 | 0 | 7 |
| 0 | 0 | 0 | 1 | 1 | 1 | 8 |
| 0 | 0 | 1 | 0 | 0 | 0 | 9 |
| 0 | 0 | 1 | 0 | 0 | 1 | 10 |
| 0 | 0 | 1 | 0 | 1 | 0 | 11 |
| 0 | 0 | 1 | 0 | 1 | 1 | 12 |
| 0 | 0 | 1 | 1 | 0 | 0 | 13 |
| 0 | 0 | 1 | 1 | 0 | 1 | 14 |
| 0 | 0 | 1 | 1 | 1 | 0 | 15 |
| 0 | 0 | 1 | 1 | 1 | 1 | 16 |
| 0 | 1 | 0 | 0 | 0 | 0 | 17 |
| 0 | 1 | 0 | 0 | 0 | 1 | 18 |
| 0 | 1 | 0 | 0 | 1 | 0 | 19 |
| 0 | 1 | 0 | 0 | 1 | 1 | 20 |
| 0 | 1 | 0 | 1 | 0 | 0 | 21 |
| 0 | 1 | 0 | 1 | 0 | 1 | 22 |
| 0 | 1 | 0 | 1 | 1 | 0 | 23 |
| 0 | 1 | 0 | 1 | 1 | 1 | 24 |
| 0 | 1 | 1 | 0 | 0 | 0 | 25 |
| 0 | 1 | 1 | 0 | 0 | 1 | 26 |
| 0 | 1 | 1 | 0 | 1 | 0 | 27 |
| 0 | 1 | 1 | 0 | 1 | 1 | 28 |
| 0 | 1 | 1 | 1 | 0 | 0 | 29 |
| 0 | 1 | 1 | 1 | 0 | 1 | 30 |
| 0 | 1 | 1 | 1 | 1 | 0 | 31 |
| 0 | 1 | 1 | 1 | 1 | 1 | 32 |
| 1 | 0 | 0 | 0 | 0 | 0 | 33 |
| 1 | 0 | 0 | 0 | 0 | 1 | 34 |
| 1 | 0 | 0 | 0 | 1 | 0 | 35 |
| 1 | 0 | 0 | 0 | 1 | 1 | 36 |
| 1 | 0 | 0 | 1 | 0 | 0 | 37 |
| 1 | 0 | 0 | 1 | 0 | 1 | 38 |
| 1 | 0 | 0 | 1 | 1 | 0 | 39 |
| 1 | 0 | 0 | 1 | 1 | 1 | 40 |
| 1 | 0 | 1 | 0 | 0 | 0 | 41 |
| 1 | 0 | 1 | 0 | 0 | 1 | 42 |
| 1 | 0 | 1 | 0 | 1 | 0 | 43 |
| 1 | 0 | 1 | 0 | 1 | 1 | 44 |
| 1 | 0 | 1 | 1 | 0 | 0 | 45 |
| 1 | 0 | 1 | 1 | 0 | 1 | 46 |
| 1 | 0 | 1 | 1 | 1 | 0 | 47 |
| 1 | 0 | 1 | 1 | 1 | 1 | 48 |
| 1 | 1 | 0 | 0 | 0 | 0 | 49 |
| 1 | 1 | 0 | 0 | 0 | 1 | 50 |
| 1 | 1 | 0 | 0 | 1 | 0 | 51 |
| 1 | 1 | 0 | 0 | 1 | 1 | 52 |
| 1 | 1 | 0 | 1 | 0 | 0 | 53 |
| 1 | 1 | 0 | 1 | 0 | 1 | 54 |
| 1 | 1 | 0 | 1 | 1 | 0 | 55 |
| 1 | 1 | 0 | 1 | 1 | 1 | 56 |
| 1 | 1 | 1 | 0 | 0 | 0 | 57 |
| 1 | 1 | 1 | 0 | 0 | 1 | 58 |
| 1 | 1 | 1 | 0 | 1 | 0 | 59 |
| 1 | 1 | 1 | 0 | 1 | 1 | 60 |
| 1 | 1 | 1 | 1 | 0 | 0 | 61 |
| 1 | 1 | 1 | 1 | 0 | 1 | 62 |
| 1 | 1 | 1 | 1 | 1 | 0 | 63 |
| 1 | 1 | 1 | 1 | 1 | 1 | 64 |

The number of combination for Y1-Y6 (FIG. 34) would be:

| Y1 | Y2 | Y3 | Y4 | Y5 | Y6 | # |
|---|---|---|---|---|---|---|
| 0 | 0 | 0 | 0 | 0 | 0 | 1 |
| 0 | 0 | 0 | 0 | 0 | 1 | 2 |
| 0 | 0 | 0 | 0 | 1 | 0 | 3 |
| 0 | 0 | 0 | 0 | 1 | 1 | 4 |
| 0 | 0 | 0 | 1 | 0 | 0 | 5 |
| 0 | 0 | 0 | 1 | 0 | 1 | 6 |
| 0 | 0 | 0 | 1 | 1 | 0 | 7 |
| 0 | 0 | 0 | 1 | 1 | 1 | 8 |
| 0 | 0 | 1 | 0 | 0 | 0 | 9 |
| 0 | 0 | 1 | 0 | 0 | 1 | 10 |
| 0 | 0 | 1 | 0 | 1 | 0 | 11 |
| 0 | 0 | 1 | 0 | 1 | 1 | 12 |
| 0 | 0 | 1 | 1 | 0 | 0 | 13 |
| 0 | 0 | 1 | 1 | 0 | 1 | 14 |
| 0 | 0 | 1 | 1 | 1 | 0 | 15 |
| 0 | 0 | 1 | 1 | 1 | 1 | 16 |
| 0 | 1 | 0 | 0 | 0 | 0 | 17 |
| 0 | 1 | 0 | 0 | 0 | 1 | 18 |
| 0 | 1 | 0 | 0 | 1 | 0 | 19 |
| 0 | 1 | 0 | 0 | 1 | 1 | 20 |
| 0 | 1 | 0 | 1 | 0 | 0 | 21 |
| 0 | 1 | 0 | 1 | 0 | 1 | 22 |
| 0 | 1 | 0 | 1 | 1 | 0 | 23 |
| 0 | 1 | 0 | 1 | 1 | 1 | 24 |
| 0 | 1 | 1 | 0 | 0 | 0 | 25 |
| 0 | 1 | 1 | 0 | 0 | 1 | 26 |
| 0 | 1 | 1 | 0 | 1 | 0 | 27 |
| 0 | 1 | 1 | 0 | 1 | 1 | 28 |
| 0 | 1 | 1 | 1 | 0 | 0 | 29 |
| 0 | 1 | 1 | 1 | 0 | 1 | 30 |
| 0 | 1 | 1 | 1 | 1 | 0 | 31 |
| 0 | 1 | 1 | 1 | 1 | 1 | 32 |
| 1 | 0 | 0 | 0 | 0 | 0 | 33 |
| 1 | 0 | 0 | 0 | 0 | 1 | 34 |
| 1 | 0 | 0 | 0 | 1 | 0 | 35 |
| 1 | 0 | 0 | 0 | 1 | 1 | 36 |
| 1 | 0 | 0 | 1 | 0 | 0 | 37 |
| 1 | 0 | 0 | 1 | 0 | 1 | 38 |
| 1 | 0 | 0 | 1 | 1 | 0 | 39 |
| 1 | 0 | 0 | 1 | 1 | 1 | 40 |
| 1 | 0 | 1 | 0 | 0 | 0 | 41 |
| 1 | 0 | 1 | 0 | 0 | 1 | 42 |
| 1 | 0 | 1 | 0 | 1 | 0 | 43 |
| 1 | 0 | 1 | 0 | 1 | 1 | 44 |
| 1 | 0 | 1 | 1 | 0 | 0 | 45 |
| 1 | 0 | 1 | 1 | 0 | 1 | 46 |
| 1 | 0 | 1 | 1 | 1 | 0 | 47 |
| 1 | 0 | 1 | 1 | 1 | 1 | 48 |
| 1 | 1 | 0 | 0 | 0 | 0 | 49 |
| 1 | 1 | 0 | 0 | 0 | 1 | 50 |
| 1 | 1 | 0 | 0 | 1 | 0 | 51 |
| 1 | 1 | 0 | 0 | 1 | 1 | 52 |
| 1 | 1 | 0 | 1 | 0 | 0 | 53 |
| 1 | 1 | 0 | 1 | 0 | 1 | 54 |
| 1 | 1 | 0 | 1 | 1 | 0 | 55 |
| 1 | 1 | 0 | 1 | 1 | 1 | 56 |
| 1 | 1 | 1 | 0 | 0 | 0 | 57 |
| 1 | 1 | 1 | 0 | 0 | 1 | 58 |
| 1 | 1 | 1 | 0 | 1 | 0 | 59 |
| 1 | 1 | 1 | 0 | 1 | 1 | 60 |
| 1 | 1 | 1 | 1 | 0 | 0 | 61 |
| 1 | 1 | 1 | 1 | 0 | 1 | 62 |
| 1 | 1 | 1 | 1 | 1 | 0 | 63 |
| 1 | 1 | 1 | 1 | 1 | 1 | 64 |

The number of combination for E1 and E2 (FIG. 34) is:

| E1 | E2 | # | |
|---|---|---|---|
| 0 | 0 | 1 | i.e., Reed-Soloman |
| 0 | 1 | 2 | i.e., Convolution |
| 1 | 0 | 3 | i.e., Level 1 |
| 1 | 1 | 4 | i.e., Level 2 |

The number of combination for R1 and R2 (FIG. 34) is:

| R1 | R2 | # |
|---|---|---|
| 0 | 0 | 1 |
| 0 | 1 | 2 |
| 1 | 0 | 3 |
| 1 | 1 | 4 |

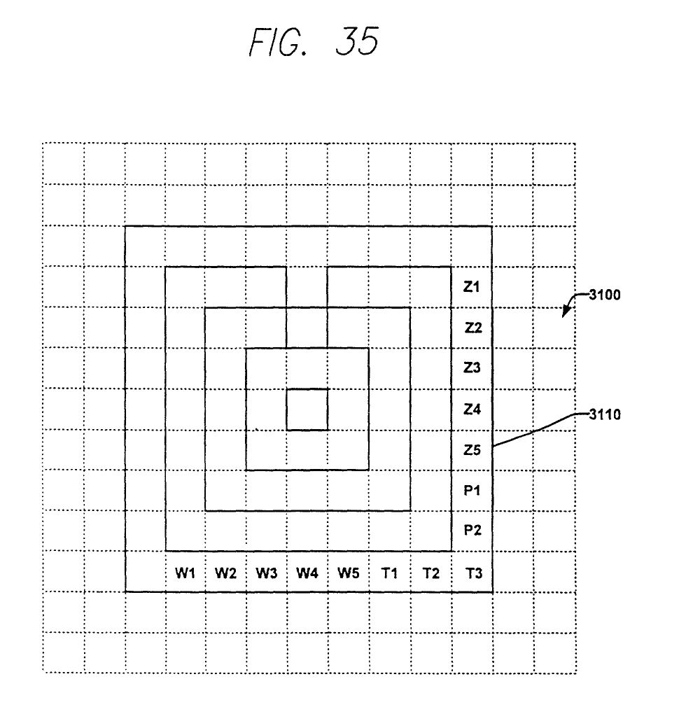

The number of combination for Z1-Z5 (FIG. 35) is:

| Z1 | Z2 | Z3 | Z4 | Z5 | # |
|---|---|---|---|---|---|
| 0 | 0 | 0 | 0 | 0 | 1 |
| 0 | 0 | 0 | 0 | 1 | 2 |
| 0 | 0 | 0 | 1 | 0 | 3 |
| 0 | 0 | 0 | 1 | 1 | 4 |
| 0 | 0 | 1 | 0 | 0 | 5 |
| 0 | 0 | 1 | 0 | 1 | 6 |
| 0 | 0 | 1 | 1 | 0 | 7 |
| 0 | 0 | 1 | 1 | 1 | 8 |
| 0 | 1 | 0 | 0 | 0 | 9 |
| 0 | 1 | 0 | 0 | 1 | 10 |
| 0 | 1 | 0 | 1 | 0 | 11 |
| 0 | 1 | 0 | 1 | 1 | 12 |
| 0 | 1 | 1 | 0 | 0 | 13 |
| 0 | 1 | 1 | 0 | 1 | 14 |
| 0 | 1 | 1 | 1 | 0 | 15 |
| 0 | 1 | 1 | 1 | 1 | 16 |
| 1 | 0 | 0 | 0 | 0 | 17 |
| 1 | 0 | 0 | 0 | 1 | 18 |
| 1 | 0 | 0 | 1 | 0 | 19 |
| 1 | 0 | 0 | 1 | 1 | 20 |
| 1 | 0 | 1 | 0 | 0 | 21 |
| 1 | 0 | 1 | 0 | 1 | 22 |
| 1 | 0 | 1 | 1 | 0 | 23 |
| 1 | 0 | 1 | 1 | 1 | 24 |
| 1 | 1 | 0 | 0 | 0 | 25 |
| 1 | 1 | 0 | 0 | 1 | 26 |
| 1 | 1 | 0 | 1 | 0 | 27 |
| 1 | 1 | 0 | 1 | 1 | 28 |
| 1 | 1 | 1 | 0 | 0 | 29 |
| 1 | 1 | 1 | 0 | 1 | 30 |
| 1 | 1 | 1 | 1 | 0 | 31 |
| 1 | 1 | 1 | 1 | 1 | 32 |

The number of combination for W1-W5 (FIG. 35) is:

| W1 | W2 | W3 | W4 | W5 | # |
|---|---|---|---|---|---|
| 0 | 0 | 0 | 0 | 0 | 1 |
| 0 | 0 | 0 | 0 | 1 | 2 |
| 0 | 0 | 0 | 1 | 0 | 3 |
| 0 | 0 | 0 | 1 | 1 | 4 |
| 0 | 0 | 1 | 0 | 0 | 5 |
| 0 | 0 | 1 | 0 | 1 | 6 |
| 0 | 0 | 1 | 1 | 0 | 7 |
| 0 | 0 | 1 | 1 | 1 | 8 |
| 0 | 1 | 0 | 0 | 0 | 9 |
| 0 | 1 | 0 | 0 | 1 | 10 |
| 0 | 1 | 0 | 1 | 0 | 11 |
| 0 | 1 | 0 | 1 | 1 | 12 |
| 0 | 1 | 1 | 0 | 0 | 13 |
| 0 | 1 | 1 | 0 | 1 | 14 |
| 0 | 1 | 1 | 1 | 0 | 15 |
| 0 | 1 | 1 | 1 | 1 | 16 |
| 1 | 0 | 0 | 0 | 0 | 17 |
| 1 | 0 | 0 | 0 | 1 | 18 |
| 1 | 0 | 0 | 1 | 0 | 19 |
| 1 | 0 | 0 | 1 | 1 | 20 |
| 1 | 0 | 1 | 0 | 0 | 21 |
| 1 | 0 | 1 | 0 | 1 | 22 |
| 1 | 0 | 1 | 1 | 0 | 23 |
| 1 | 0 | 1 | 1 | 1 | 24 |
| 1 | 1 | 0 | 0 | 0 | 25 |
| 1 | 1 | 0 | 0 | 1 | 26 |
| 1 | 1 | 0 | 1 | 0 | 27 |
| 1 | 1 | 0 | 1 | 1 | 28 |
| 1 | 1 | 1 | 0 | 0 | 29 |
| 1 | 1 | 1 | 0 | 1 | 30 |
| 1 | 1 | 1 | 1 | 0 | 31 |
| 1 | 1 | 1 | 1 | 1 | 32 |

The number of combination for T1-T3 (FIG. 35) is:

| T1 | T2 | T3 | # | |
|---|---|---|---|---|
| 0 | 0 | 0 | 1 | i.e., Type A = Square or rectangle |
| 0 | 0 | 1 | 2 | i.e., Type B |
| 0 | 1 | 0 | 3 | i.e., Type C |
| 0 | 1 | 1 | 4 | i.e., Type D |
| 1 | 0 | 0 | 5 | |
| 1 | 0 | 1 | 6 | |
| 1 | 1 | 0 | 7 | |
| 1 | 1 | 1 | 8 | |

The number of combination for P1 and P2 (FIG. 35) is:

| P1 | P2 | # | |
|---|---|---|---|
| 0 | 0 | 1 | i.e., More than 60%, Black & White |
| 0 | 1 | 2 | i.e., Less than 60%, Black & White |
| 1 | 0 | 3 | i.e., Color type a (i.e., Blue, Green, Violet) |
| 1 | 1 | 4 | i.e., Color type B (i.e., Yellow, Red) |

The identifier can change size by increasing or decreasing the combinations on all variables such as X, Y, S, Z, W, E, T, P to accommodate the proper data field, depending on the application and the symbology structure used.

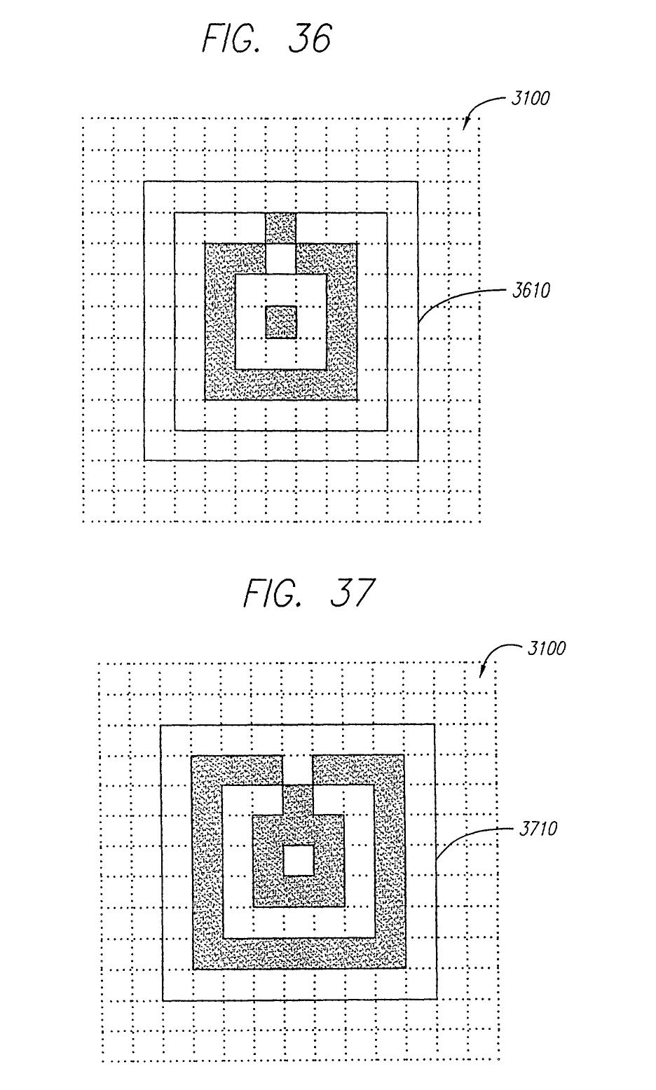

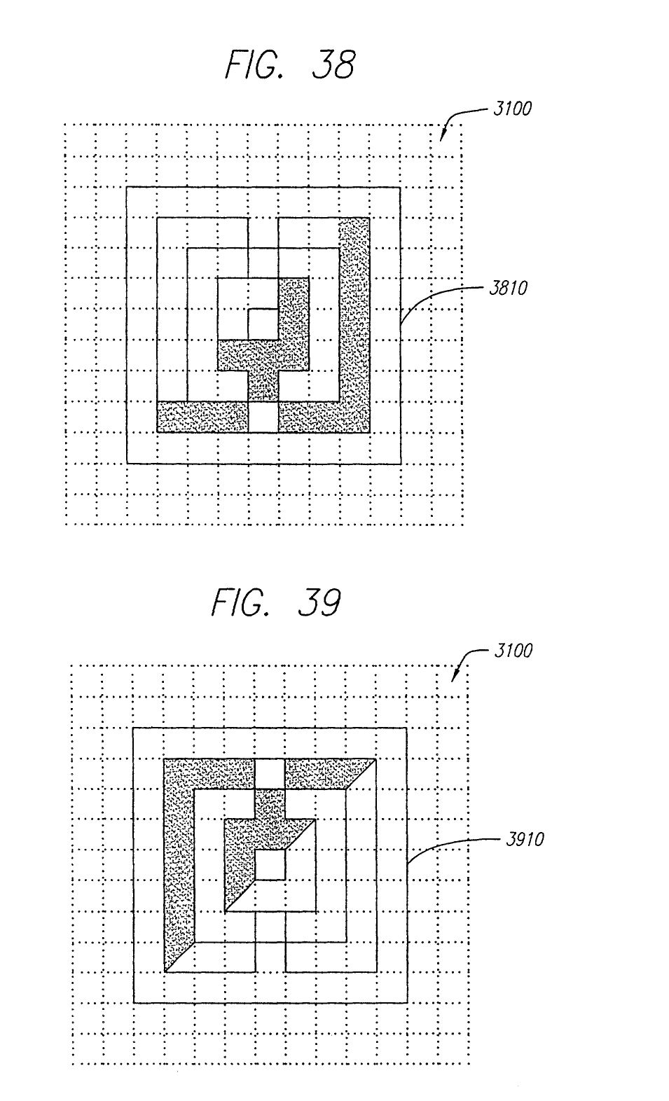

Examples of chameleon code identifiers 3110 are provided in FIGS. 36-39. The chameleon code identifiers are designated in those figures with reference numbers 3610, 3710, 3810 and 3910, respectively.

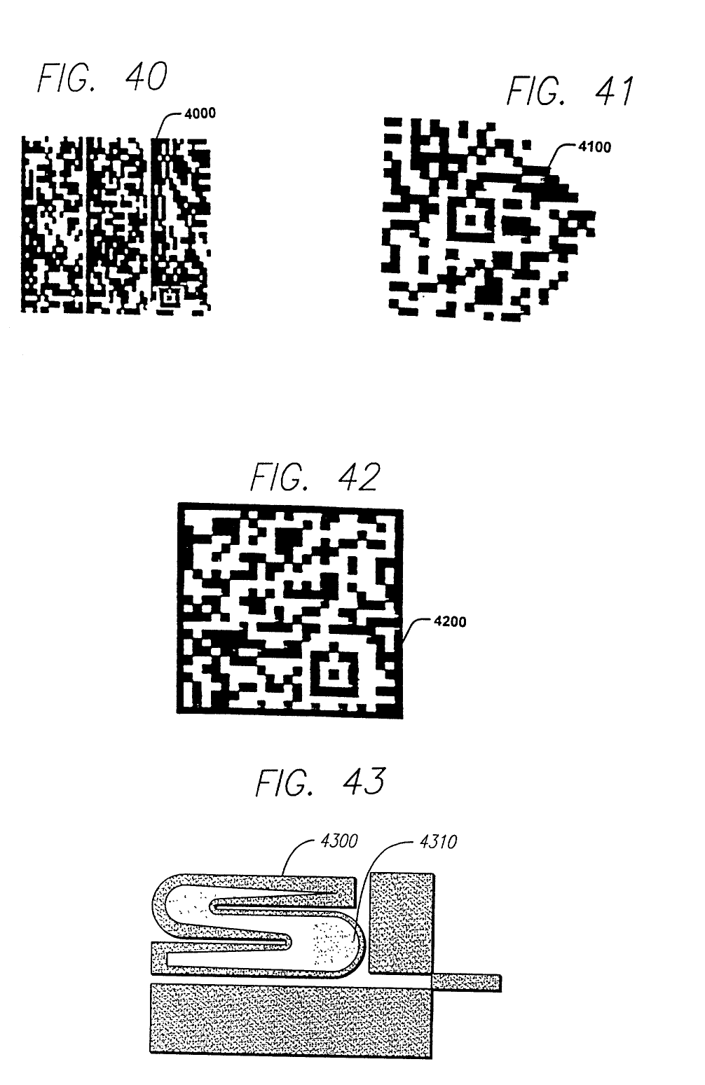

FIG. 40 illustrates an example of PDF-417 code structure 4000 with an identifier;

FIG. 41 provides an example of identifier being positioned in a VeriCode Symbology 4100 of 23 rows and 23 columns, at Z=12, and W=09 (in this example, Z and W indicate the center cell position of the identifier), printed with a black and white color with no error correction and with a contrast superior of 60%, having a “D” shape, and normal density.

FIG. 42 illustrates an example of DataMatrix or VeriCode code structure 4200 using a Chameleon identifier. FIG. 43 illustrates a two-dimensional symbology 4310 embedded in a logo using the Chameleon identifier.

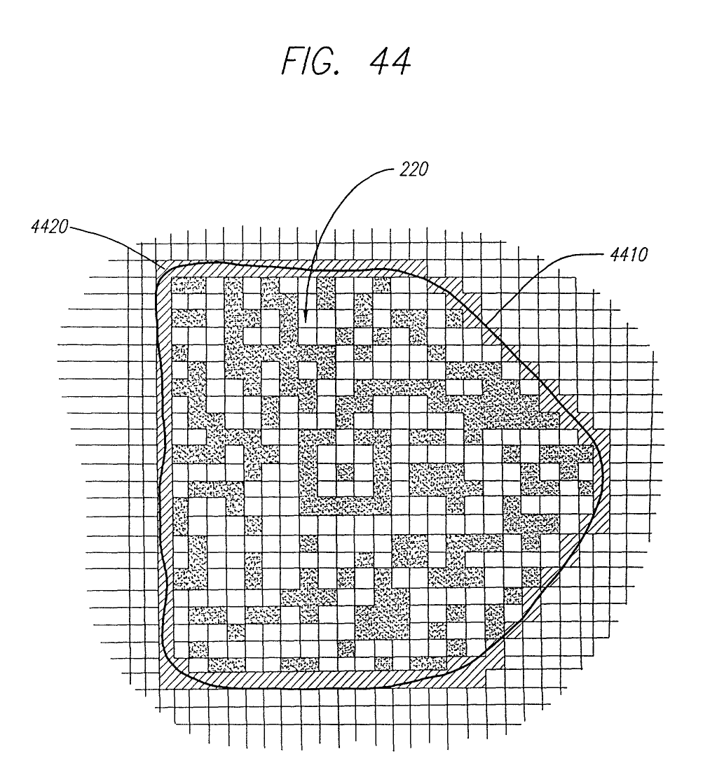

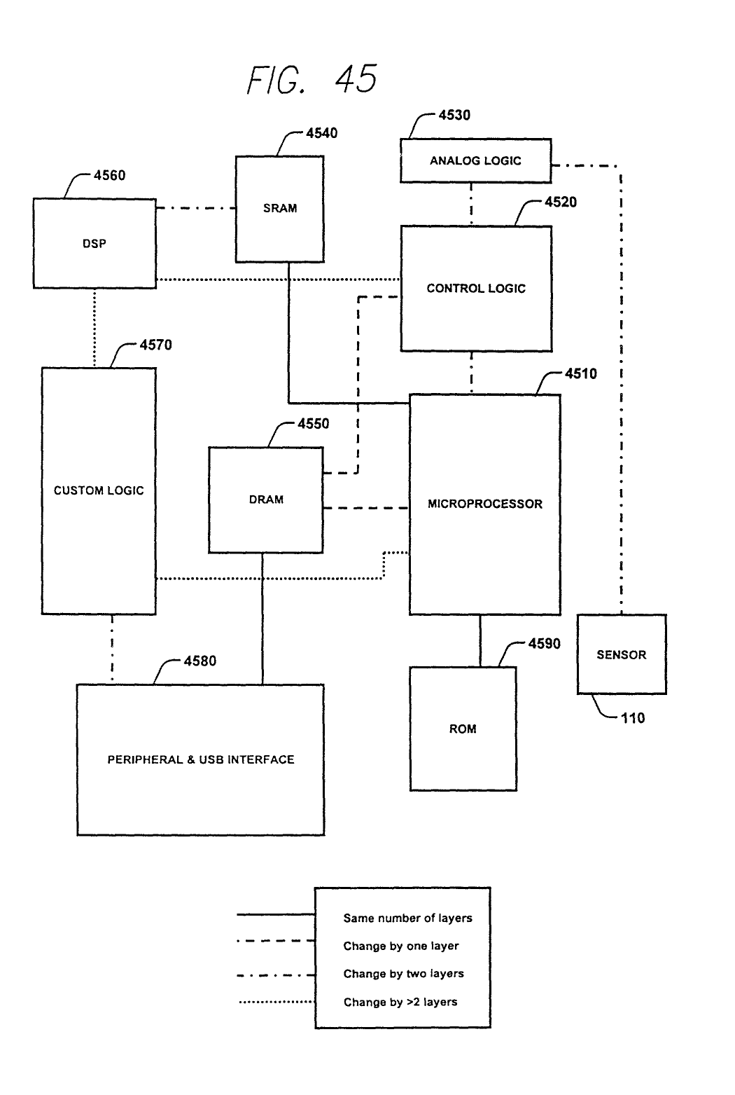

Examples of chameleon identifiers used in various symbologies 4000, 4100, 4200, and 4310 are shown in FIGS. 40-43, respectively. FIG. 43 also shows an example of the identifier used in a symbology 4310 embedded within a logo 4300. Also in the examples of FIGS. 41, 43 and 44, the incomplete squares 4410 are not used as a data field, but are used to determine periphery 4420.

Printing techniques for the Chameleon optical code should consider the following: selection of the topology (shape of the code); determination of data field (area to store data); data encoding structure; number of data to encode (number of characters, determining number of rows and columns.); density, size, fit; error correction; color and contrast; and location of Chameleon identifier.

The decoding methods and techniques for the chameleon optical code should include the following steps: Find the Chameleon identifier; Extract Code features from the identifier, i.e., topology, code structure, number of rows and columns, etc.; and decode the symbology.

Error correction in a two dimensional symbology is a key element to the data integrity stored in the optical code. Various error correction techniques such as Reed-Soloman or convolutional technique have been used to provide readability of the optical code if it is damaged or covered by dirt or spot. The error correction capability will vary depending on the code structure and the location of the dirt or damage. Each symbology usually has different error correction level, which could be different, depending to the user application. Error corrections are usually classified by level or ECC number.

### Digital Imaging

In addition to scanning symbologies, the present invention is capable of capturing images for general use. This means that the imager 100 can act as a digital camera. This capability is directly related to the use of improved sensors 110 that are capable of scanning symbologies and capturing images.

The electronic components, functions, mechanics, and software of digital imagers 100 are often the result of tradeoffs made in the production of a device capable of personal computer based image processing, transmitting, archiving, and outputting a captured image.

The factors considered in these tradeoffs include: base cost; image resolution; sharpness; color depth and density for color frame capture imager; power consumption; ease of use with both the imager's 100 user interface and any bundled software; ergonomics; stand-alone operation versus personal computer dependency; upgradability; delay from trigger press until the imager 100 captures the frame; delay between frames depending on processing requirements; and the maximum number of storable images.

A distinction between cameras and imagers 100 is that cameras are designed for taking pictures/frames of a subject either in or out of doors, without providing extra lighting illumination other than a flash strobe when needed. Imagers 100, in contrast, often illuminate the target with a homogenized and coherent or incoherent light, prior to grabbing the image. Imagers 100, contrary to cameras, are often faster in real time image processing. However, the emerging class of multimedia teleconferencing video cameras has removed the “real time” notion from the definition of an imager 100.

### Optics

The process of capturing an image begins with the use of a lens. In the present invention, glass lenses generally are preferable to plastic, since plastic is more sensitive to temperature variations, scratches more easily, and is more susceptible to light-caused flare effects than glass, which can be controlled by using certain coating techniques.

The “hyper-focal distance” of a lens is a function of the lens-element placement, aperture size, and lens focal length that defines the in focus range. All objects from half the hyper-focal distance to infinity are in focus. Multimedia imaging usually uses a manual focus mode to show a picture of some equipment or content of a frame, or for still image close-ups. This technique is not appropriate, however, in the Automatic Identification (“Auto-ID”) market and industrial applications where a point and shoot feature is required and when the sweet spot for an imager, used by an operator, is often equal or less than 7 inches. Imagers 100 used for Auto-ID applications must use Fixed Focus Optics (“FFO”) lenses. Most digital cameras used in photography also have an auto-focus lens with a macro mode. Auto-focus adds cost in the form of lens-element movement motors, infrared focus sensors, control-processor, and other circuits. An alternative design could be used wherein the optics and sensor 110 connect to the remainder of the imager 100 using a cable and can be detached to capture otherwise inaccessible shots or to achieve unique imager angles.

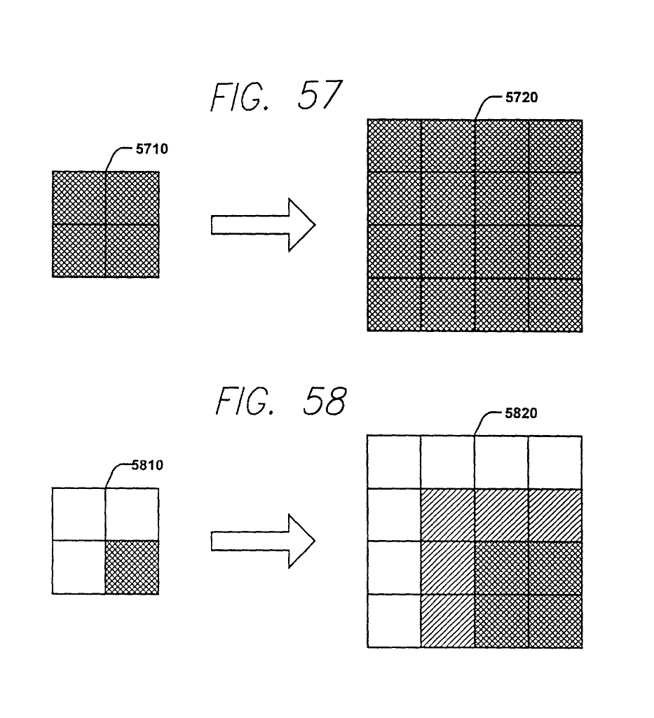

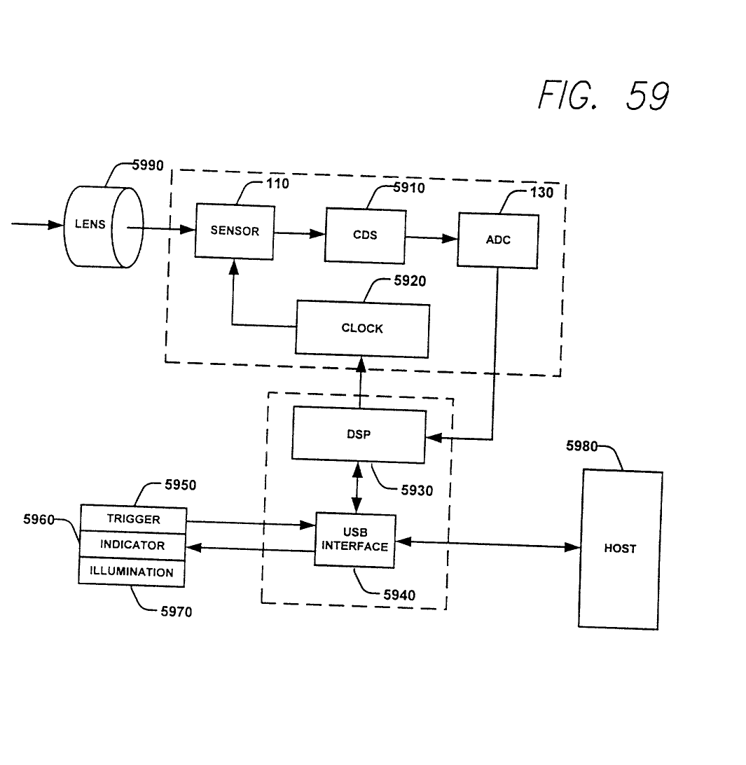

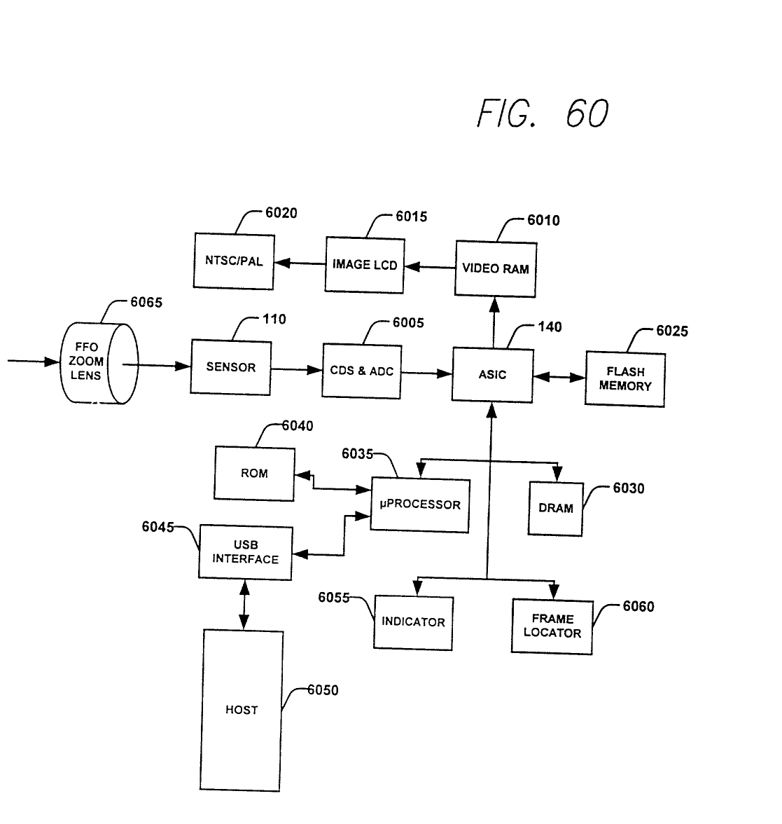

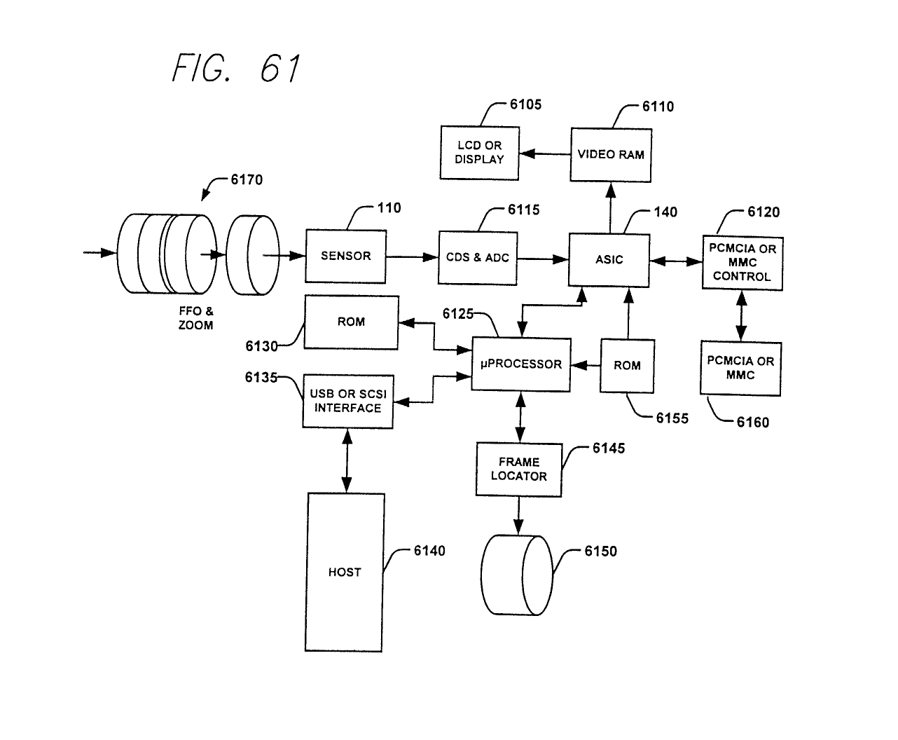

The expensive imagers 100 and cameras offer a “digital zoom” and an “optical zoom”, respectively. A digital zoom does not alter the orientation of the lens elements. Depending on the digital zoom setting, the imager 100 discards a portion of the pixel information that the image sensor 110 captures. The imager 100 then enlarges the remainder to fill the expected image file size. In some cases, the imager 100 replicates the same pixel information to multiple output file bytes, which can cause jagged image edges. In other cases, the imager creates intermediate pixel information using nearest neighbor approximation or more complex gradient calculation techniques, in a process called “interpolation” (see FIGS. 57 and 58). Interpolation of four solid pixels 5710 to sixteen solid pixels 5720 is relatively straightforward. However, interpolating one solid pixel in a group of four 5810 to a group of sixteen 5820 creates a blurred edge where the intermediate pixels have been given intermediate values between the solid and empty pixels. This is the main disadvantage of interpolation; that the images it produces appear blurred when compared with those captured by a higher resolution sensor 110. With optical zooms, the trade-off is between manual and motor assisted zoom control. The latter incurs additional cost, but camera users might prefer it for its easier operation.

### View Finder

In embodiments of the present invention providing a digital imager 100 or camera, a viewfinder is used to help frame the target. If the imager 100 provides zoom, the viewfinder's angle of view and magnification often adjust accordingly. Some cameras use a range-finder configuration, in which the viewfinder has a different set of optics (and, therefore, a slightly different viewpoint) from that of the lens used to capture the image. Viewfinder (also called Frame Locator) delineates the lens-view borders to partially correct this difference, or “parallax error”. At extreme close-ups, only the LCD gives the most accurate framing representation of the framed area in the sensor 110. Because the picture is composed through the same lens that takes it, there is no parallax error, but such an imager 100 requires a mirror, a shutter, and other mechanics to redirect the light to the viewfinder prism 6210. Some digital cameras or digital imagers incorporate a small LCD display that serves as both a view finder and a way to display captured images or data.

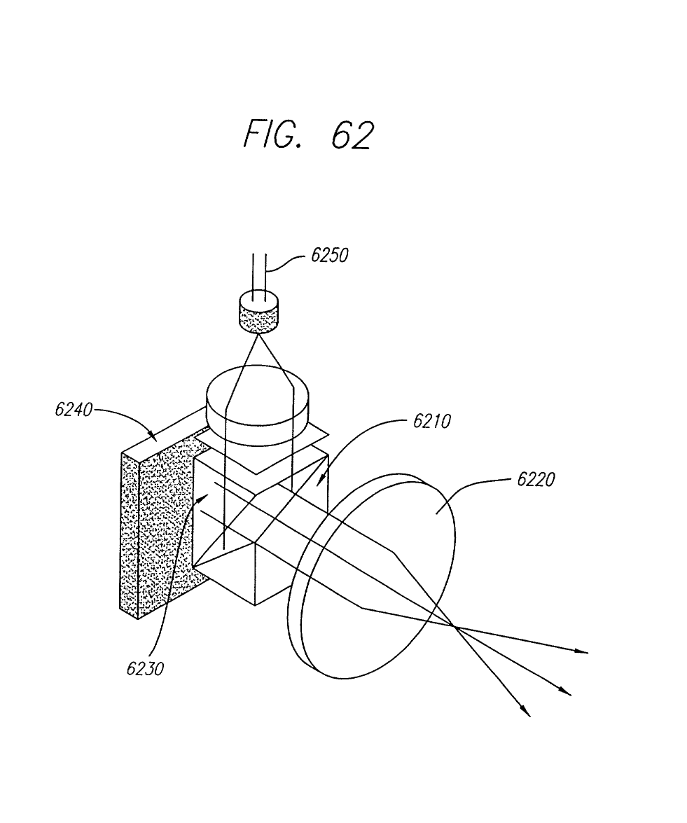

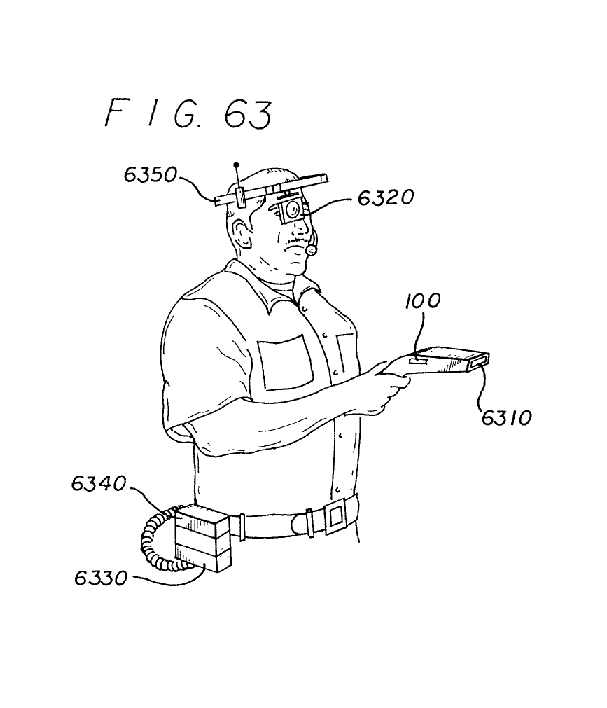

Handheld computers and data collector embodiments are equipped with a LCD display to help the data entry. The LCD can also be used as a viewfinder. However, in wearable and interactive embodiments where hands-free wearable devices provide comfort, conventional display can be replaced by wearable microdisplay, mounted on a headset (called also personal display). A microdisplay LCD 6230 embodiment of a display on chip is shown in FIG. 62. Also illustrated are an associated CMOS backplane 6240, illumination source 6250, prism system 6210 and lens or magnifier 6220. The display on chip can be brought to the eye, in a camera viewfinder (not shown) or mounted in a headset 6350 close to the eye, as illustrated in FIG. 63. As shown in FIG. 63, the reader 6310 is handheld, although any other construction also may be used. The magnifier 6220 used in this embodiment produces virtual images and depending on the degree of magnification, the eye sees the image floating in space at specific size and distance (usually between 20 to 24 inches).

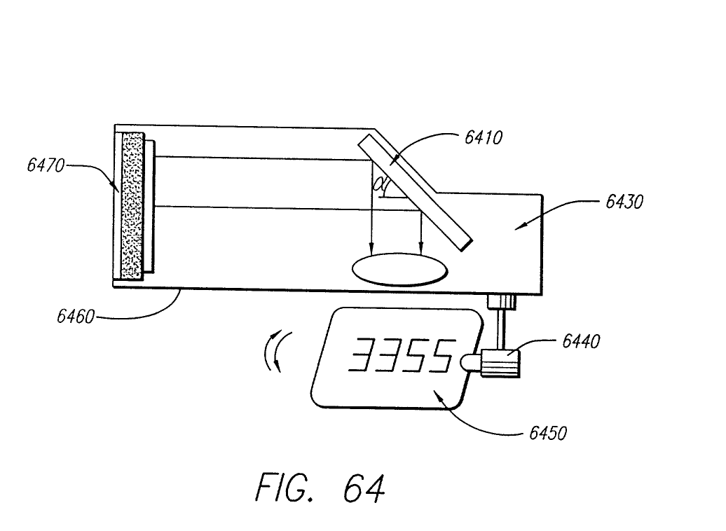

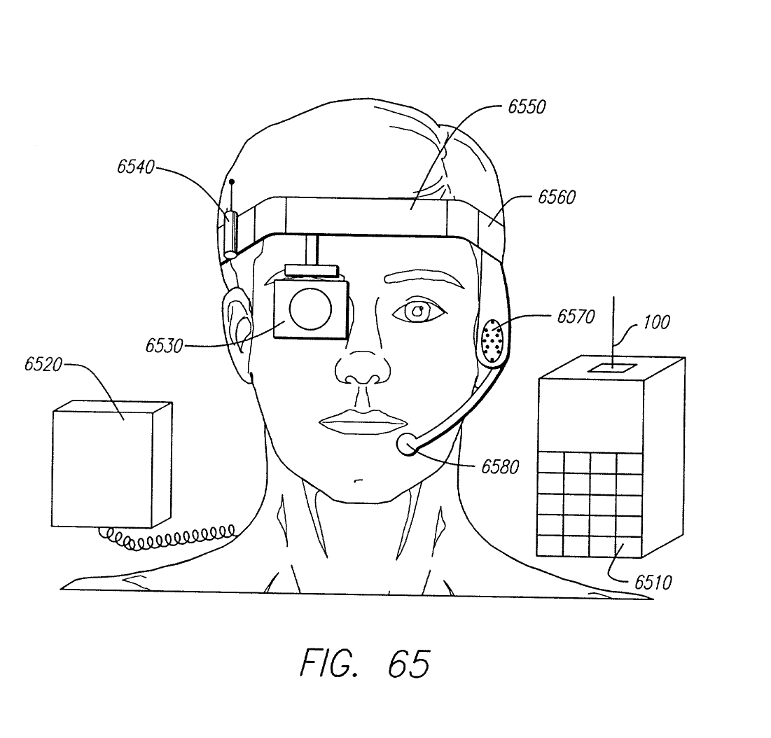

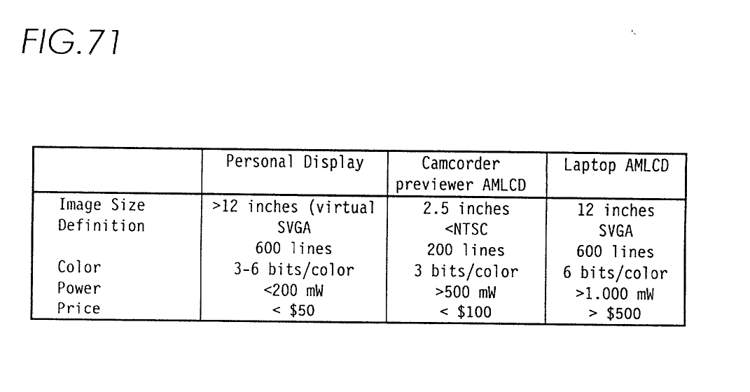

Micro-displays also can be used to provide a high quality display. Single imager field-sequential systems, based on reflective CMOS backplanes have significant advantages in both performance and cost. FIG. 71 provides a comparison between different personal displays. LED arrays, scanned LED, and backlit LCD displays can also be used as personal displays. FIG. 64 represents a simplified assembly of a personal display, used on a headset 6350. The exemplary display 6420 in FIG. 64 includes a hinged 6440 mirror 6450 that reflects image from optics 6430 that was reflected from an internal mirror 6410 from an image projected by the microdisplay 6460. Optionally the display 6470 includes a backlight 6470. Some examples of applications for hands-free, interactive, wearable devices are material handling, warehousing, vehicle repair, and emergency medical first aid. FIGS. 63 and 65 illustrate wearable embodiments of the present invention. The embodiment in FIG. 63 includes a headset 6350 with mounted display 6320 viewable by the user. The image grabbing device 100 (i.e. reader, data collector, imager, etc.) is in communication with headset 6350 and/or control and storage unit 6340 either via wired or wireless transmission. A battery pack 6330 preferably powers the control and storage unit 6340. The embodiment in FIG. 65 includes antenna 6540 attached to headset 6560. Optionally, the headset includes an electronics enclosure 6550. Also mounted on the headset is a display panel 6530, which preferably is in communication with electronics within the electronics enclosure 6550. An optional speaker 6570 and microphone 6580 are also illustrated. Imager 100 is in communication 6510 with one or more of the headset components, such as in a wireless transmission received from the data collection device via antenna 6540. Alternatively, a wired communication system is used. Storage media and batteries may be included in unit 6520. It should be understood that these and the other described embodiments are for illustration purposes only and any arrangement of components may be used in conjunction with the present invention.

### Sensing & Editing

Digital film function capture occurs in two areas: in the flash memory or other image-storage media and in the sensing subsystem, which comprises the CCD or CMOS sensor 110, analog processing circuits 120, and ADC 130. The ADC 130 primarily determines an imager's (or camera's) color depth or precision (number of bits per pixel), although back-end processing can artificially increase this precision. An imager's color density, or dynamic range, which is its ability to capture image detail in light ranging from dark shadows to bright highlights, is also a function of the sensor sensitivity. Sensitivity and color depth improve with larger pixel size, since the larger the cell, the more electrons available to react to light photons (see FIG. 54) and the wider the range of light values the sensor 110 can resolve. However, the resolution decreases as the pixel size increases. Pixel size must balance with the desired number of cells and cell size, called also the “resolution” and the percentage of the sensor 110 devoted to cells versus other circuits called “area efficiency”, or “fill factor”. As with televisions, personal computer monitors, and DRAMs, sensor cost increases as sensor area increases because of lower yield and other technical and economic factors related to the manufacturing.

Digital imagers 100 and digital cameras contain several memory types in varying densities to match usage requirements and cost targets. Imagers also offer a variety of options for displaying the images and transferring them to a personal computer, printer, VCR, or television.

### COLOR SENSORS

As previously noted, a sensor 110, normally a monochrome device, requires pre-filtering since it cannot extract specific color information if it is exposed to a full-color spectrum. The three most common methods of controlling the light frequencies reaching individual pixels are:

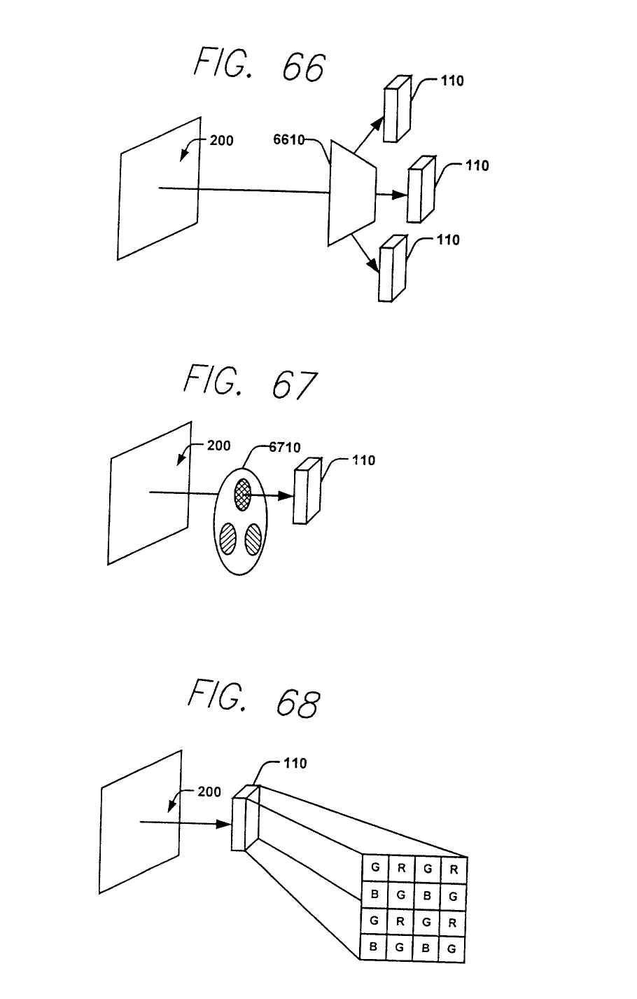

1) Using a prism 6610 and multiple sensors 110 as illustrated in FIG. 66, the sensors preferably including blue, green and red sensors;

2) Using rotating multicolor filters 6710 (for example including red, green and blue filters) with a single sensor 110 as illustrated in FIG. 67; or

3) Using per-pixel filters on the sensor 110 as illustrated in FIG. 68. In FIG. 68, respective re, green and blue pixels are designated with the letters “R”, “G”, and “B”, respectively.

In each case, the most popular filter palette is the Red, Green, Blue (RGB) additive set, which color displays also use. The RGB additive set is so named because these three colors are added to an all-black base to form all possible colors, including white.

The subtractive color set of cyan-magenta-yellow is another filtering option (starting with a white base, such as paper, subtractive colors combine to form black). The advantage of subtractive filtration is that each filter color filters through a portion of two additive colors (yellow filters allow both green and red light to pass through them, for example). For this reason, cyan-magenta-yellow filters give better low-light sensitivity, an ideal characteristic for video cameras. However, the filtered results must subsequently convert to RGB for display. Lost color information and various artifacts introduced during conversion can produce non-ideal still-image results. Still imagers 100, unlike video cameras, can easily supplement available light with a flash.

The multi-sensor color approach, where the image is reflected from the target 200 to a prism 6610 with three separate filters and sensors 110, produces accurate results but also can be costly (FIG. 66). A color-sequential- rotating filter (FIG. 67) requires three separate exposures from the image reflected off the target 200 and, therefore, suits only still-life photography. The liquid-crystal tunable filter is a variation of this second technique that uses a tricolor LCD, and promises much shorter exposure times, but is only offered by very expensive imagers and cameras. The third and most common approach, where the image is reflected off the target 200 and passes through an integral color-filter array on the sensor 110 is an integral color-filter array. This places an individual red, green, or blue (or cyan, magenta, or yellow) filter above each sensor pixel, relying on back-end image processing to approximate the remainder of each pixel's light-spectrum information from nearest neighbor pixels.

In the embodiment illustrated in FIG. 68, in the visible-light spectrum, silicon absorbs red light at a greater average depth (level 5440 in FIG. 54) than it absorbs green light (level 5430 in FIG. 54), and blue light releases more electrons near the chip surface (level 5420 in FIG. 54). Indeed, the yellow polysilicon coating on CMOS chips absorbs part of the blue spectrum before its photons reach the photodiode region. Analyzing these factors to determine the optimal way to separate the visible spectrum into the three-color bands is a science beyond most chipmakers' capabilities.

Depositing color dyes as filters on the wafer is the simplest way to achieve color separation. The three-color pattern deposited on the array covers each pixel with one primary-color-system (“RGB”) or two complementary color system colors (cyan, magenta, yellow, or “CyMY”) so that the pixel absorbs only those colors' intensities in that part of the image. CyMY colors let more light through to each pixel, so they work better in low-light images than do RGB colors. But ultimately, images have to convert to RGB for display, and we lose color accuracy in the conversion. RGB filters reduce the light going to the pixels but can more accurately recreate the image color. In either case, reconstructing the true color image by digital processing somewhat offsets the simplicity of putting color filters directly on the sensor array 110. But integrating DSP with the image sensor enables more processing-intensive algorithms at a lower system cost to achieve color images. Companies such as Kodak and Polaroid develop proprietary filters and patterns to enhance the color transitions in applications such as Digital Still Photography (DSP).

In FIG. 68, there are twice as many green pixels (“G”) as red (“R”) or blue (“B”). This structure, called a “Bayer pattern”, after scientist Bryce Bayer, results from the observation that the human eye is more sensitive to green than to red or blue, so accuracy is most important in the green portion of the color spectrum. Variations of the Bayer pattern are common but not universal. For instance, Polaroid's PDC-2000 uses alternating red-, blue- and green-filtered pixel columns, and the filters are pastel or muted in color, thereby passing at least a small percentage of multiple primary-color details for each pixel. Sound Vision's CMOS-sensor-based imagers 100 use red, green, blue, and teal (a blue-green mix) filters.

The human eye notices quantization errors in the shadows, or dark areas, of a photograph more than in the highlights, or light, sections. Greater-than-8-bit ADC precision allows the back-end image processor to selectively retain the most important 8 bits of image information for transfer to the personal computer. For this reason, although most personal computer software and graphics cards do not support pixel color values larger than 24 bits (8 bits per primary color), we often need a 10-bit, 12-bit, and even larger ADCs in digital imagers.

High-end digital imagers offer variable sensitivity, akin to an adjustable ISO rating for traditional film. In some cases, summing multiple sensor pixels' worth of information to create one image pixel accomplishes this adjustment. Other imagers 100, however, use an analog amplifier to boost the signal strength between the sensor 110 and ADC 130, which can distort and add noise. In either case, the result is the appearance of increased grain at high-sensitivity settings, similar to that of high-ISO silver-halide film. In multimedia and teleconferencing applications, the sensor 110 could also be integrated within the monitor or personal display, so it can reproduce the “eye-contact” image (called also “face-to-face” image) of the caller/receiver or object, looking at or in front of the display.

### Image Processing

Digital imager 100 and cameras hardware designs are rather straightforward and in many cases benefit from experience gained with today's traditional film imagers and video equipment. Image processing, on the other hand, is the “most” important feature of an imager 100 (our eye and brain can quickly discern between “good” and “bad” reproduced images or prints). It is also the area in which imager manufacturers have the greatest opportunity to differentiate themselves and in which they have the least overall control. Image quality depends highly on lighting and other subject characteristics. Software and hardware inside the personal computer is not the only thing that can degrade the imager output. The printer or other output equipment can as well. Because capture and display devices have different color-spectrum-response characteristics, they should calibrate to a common reference point, automatically adjusting a digital image passed to them by other hardware and software to produce optimum results. As a result, several industry standards and working groups have sprung up, the latest being the Digital Imaging Group. However, In the Auto-Id, major symbologies have been normalized and the difficulties will reside in both hardware and software capabilities of the imager 100.

A trade-off in the image-and-control-processor subsystem is the percentage of image processing that takes place in the imager 100 (on a real-time basis, i.e., feature extraction) versus in a personal computer. Most, if not all, image processing for low-end digital cameras is currently done in the personal computer after transferring the image files out of the camera. The processing is personal computer based; the camera contains little more than a sensor 110, an ADC 1930 connected to an interface 1910 that is connected to a host computer 1920.

Other medium priced cameras can compress the sensor output and perform simple processing to construct a low-resolution and minimum-color tagged-image-format-file (TIFF) image, used by the LCD (if the camera has one) and by the personal computer's image-editing software. This approach has several advantages:

1) The imager's processor 150 can be low-performance and low-cost, and minimal between-picture processing means the imager 100 can take the next picture faster. The files are smaller than their fully finished loss-less alternatives, such as TIFF, so the imager 100 can take more pictures before “reloading”. Also, no image detail or color quality is lost inside the imager 100 because of the conversion to an RGB or other color gamut or to a glossy file format, such as JPEG. For example, Intel, with its Portable PC Imager '98 Design Guidelines strongly recommends a personal computer based-processing approach. 971 PC Imager, including an Intel developed 768×576 pixel CMOS sensor 110, also relies on the personal computer for most image-processing tasks.

2) The alternative approach to image processing is to complete all operations within the camera, which then outputs pictures in one of several finished formats, such as JPEG, TIFF, and FlashPix. Notice that many digital-camera manufacturers also make photo-quality printers. Although these companies are not precluding a personal computer as an intermediate image-editing and-archiving device, they also want to target the households that do not currently own personal computers by providing a means of directly connecting the imager 100 to a printer. If the imager 100 outputs a partially finished and proprietary file format, it puts an added burden on the imager manufacturer or application developer to create personal computer based software to complete the process and to support multiple personal computer operating systems. Finally, nonstandard film formats limit the camera user's ability to share images with others (e-mailing our favorite pictures to relatives, for example), unless they also have the proprietary software on their personal computers. In industrial applications, the imager's processor 150 should be high performance and low-cost to complete all processing operations within the imager 100, which then outputs decoded data which was encoded within the optical code. No perceptible time (less than a second) should be taken to provide the decoded data from the time the trigger is pulled. A color imager 100 can also be used in the industrial applications where three dimensional optical codes, using a color superimposition technique are employed.

Regardless of where the image processing occurs, it contains several steps:

1) If the sensor 110 uses a selective color-filtering technique, interpolation reconstructs eight or more bits each of red, blue, and green information for each pixel. In an imager 100 for the two dimensional optical code, we could simply use a monochrome sensor 110 with FFO.

2) Processing modifies the color values to adjust for differences in how the sensor 110 responds to light compared with how the eye responds (and what the brain expects). This conversion is analogous to modifying a microphone's output to match the sensitivity of the human ear and to a speaker's frequency-response pattern. Color modification can also adjust to variable-lighting conditions; daylight, incandescent illumination, and fluorescent illumination all have different spectral frequency patterns. Processing can also increase the saturation, or intensity, of portions of the color spectrum, modifying the strictly accurate reproduction of a scene to match what humans “like” to see. Camera manufacturers call this approach the “psycho-physics model.” Which is an inexact science (because color preferences highly depend on the user's cultural background and geographic location, i.e., people who live in forests like to see more green, and those who live in deserts might prefer more yellows. The characteristics of the photographed scene also complicate this adjustment. For this reason, some imagers 100 actually capture multiple images at different exposure (and color settings), sampling each and selecting the one corresponding to the camera's settings. Similar approach is currently used during the setup, in industrial applications, in which, the imager 100 will not use the first few frames (because during that time the imager 100 calibrates itself for the best possible results depending on user's settings), after the trigger is activated (or simulated).

3) Image processing will extract all-important features of the frame through a global and a local feature determination. In industrial applications, this step should be executed “real time” as data is read from the sensor 110, as time is a critical parameter. Image processing can also sharpen the image. Simplistically, the sharpening algorithm compares and increases the color differences between adjacent pixels. However, to minimize jagged output and other noise artifacts, this increase factor varies and occurs only beyond a specific differential threshold, implying an edge in the original image. Compared with standard 35-mm film cameras, we may find it difficult to create shallow depth of field with digital imagers 100; this characteristic is a function of both the optics differences and the back-end sharpening. In many applications, though, focusing improvements are valuable features that increase the number of usable frames. In a camera, the final processing steps are image-data compression and file formatting. The compression is either loss-less, such as the Lempel-Zif-Welsh compression in TIFF, or glossy (JPEG or variants), whereas in imagers 100, this final processing is the decode function of the optical data.

Image processing can also partially correct non-linearities and other defects in the lens and sensor 110. Some imagers 100 also take a second exposure after closing the shutter, then subtract it from the original image to remove sensor noise, such as dark-current effects seen at long exposure times.

Processing power fundamentally derives from the desired image resolution, the color depth, and the maximum-tolerated delay between successive shots or trigger pulls. For example, Polaroid's PDC-2000 processes all images internally in the imager's high-resolution mode but relies on the host personal computer for its super-high-resolution mode. Many processing steps, such as interpolation and sharpening, involve not only each target pixel's characteristics but also a weighted average of a group of surrounding pixels (a 5×5 matrix, for example). This involvement contrasts with pixel-by-pixel operations, such as bulk-image color shifts.

Image-compression techniques also make frequent use of Discrete Cosine Transforms (“DCTs”) and other multiply-accumulate convolution operations. For these reasons, fast microprocessors with hardware-multiply circuits are desirable, as are many on-CPU registers to hold multiple matrix-multiplication coefficient sets.

If the image processor has spare bandwidth and many I/O pins, it can also serve double duty as the control processor running the auto-focus, frame locator and auto-zoom motors and illumination (or flash), responding to user inputs or imager's 100 settings, and driving the LCD and interface buses. Abundant I/O pins also enable selective shutdown of imager subsystems when they are not in use, an important attribute in extending battery life. Some cameras draw all power solely from the USB connector 1910, making low power consumption especially critical.

The present invention provides an optical scanner/imager 100 along with compatible symbology identifiers and methods. One skilled in the art will appreciate that the present invention can be practiced by other than the preferred embodiments which are presented in this description for purposes of illustration and not of limitation, and the present invention is limited only by the claims which follow. It is noted that equivalents for the particular embodiments discussed in this description may practice the invention as well.

What is claimed is:

1. An optical image reading apparatus comprising:
at least one sensor, the sensor including a plurality of pixel elements, the pixel elements arranged in a substantially rectangular configuration;
an optical processor structured to convert the electrical signal into output data;
an image processor structured to receive the output data; and
a data processing unit structured to produce data representative of information located in the image, the data processing unit being responsive to the output data.

2. The apparatus of claim 1, wherein the pixel elements of the sensor are arranged in a substantially square configuration.

3. The apparatus of claim 1, wherein the pixel elements of the sensor are arranged in a 1K×1K pixel array.

4. The apparatus of claim 1 wherein the pixel elements of the at least one sensor are arranged in an array comprising columns and rows of pixels, each row having a same number of pixel elements as each column.

5. The apparatus of claim 1 having a horizontal resolution and a vertical resolution, the horizontal resolution being substantially the same as the vertical resolution.

6. The apparatus of claim 1, further including a communication interface transmitting the output data to another system.

7. The apparatus of claim 1, wherein the output data describes a multi-bit digital value for each pixel element corresponding to discrete points within the image.

8. The apparatus of claim 1, wherein the data processing unit produces data representative of information located in an area of interest within the image.

9. The apparatus of claim 1, wherein the image processor is capable of generating indicator data from only a portion of the output data;

10. The apparatus of claim 1 further comprising a memory for storing the output data.

11. The apparatus of claim 1 wherein the apparatus is configured to perform the function of a digital camera.

12. The apparatus of claim 6 wherein the communication interface transmits at least one of raw image data, processed image data, and decoded information that was located in an area of interest within the image.

13. The apparatus of claim 6 wherein the communication interface receives data from another system.

14. The apparatus of claim 6 wherein the communication interface consists of at least one of an infra-red transceiver, a RF transceiver, and a transmitter for placing data onto an optical fiber and for receiving data from an optical fiber, or for placing data onto and receiving data from any other wired or wireless transmission system.

15. The apparatus of claim 1 wherein the image processor compresses the output data.

16. The apparatus of claim 15 wherein the compression includes binarization.

17. The apparatus of claim 15 wherein the compression includes run length coding.

18. The apparatus of claim 15 wherein the compression includes both binarization and run length coding.

19. The apparatus of claim 8 wherein by utilizing the indicator data the data processing unit can identify the type of information that exists in an area of interest.

20. The apparatus of claim 8 wherein by utilizing the indicator data the data processing unit can determine an angle that an area of interest makes with an orientation of the sensor.

21. The apparatus of claim 1 wherein the sensor and the optical processor are integrated on a single chip.

22. The apparatus of claim 1 wherein the sensor, the optical processor, and the image processor are integrated onto a single chip.

23. The apparatus of claim 1 wherein the sensor, the optical processor, the image processor, and the data processing unit are integrated onto a single chip.

24. The apparatus of claim 23 wherein the single chip is an ASIC.

25. The apparatus of claim 23 wherein the single chip is an FPGA.

26. The apparatus of claim 1 wherein the optical processor includes at least one analog to digital converter.

27. The apparatus of claim 1 further comprising an optical assembly comprising at least one lens, the optical assembly focusing light reflected from the image.

28. The apparatus of claim 27 wherein the at least one lens comprises a plurality of microlenses.

29. The apparatus of claim 1 further comprising a light source for projecting light onto the target image field.

30. An optical reading apparatus for reading machine readable code contained within a target image field, the optical reading apparatus comprising:
a light source projecting an incident beam of light onto the target image field;
an optical assembly comprising at least one lens disposed along an optical path, the optical assembly structured to focus the light reflected from the target field; and
a sensor positioned substantially within the optical path, the sensor having a plurality of sensor elements configured in a substantially rectangular array, and structured to sense an illumination level of the focused reflected light.

31. The optical reading apparatus of claim 30, wherein the sensor comprises a plurality of sensor elements arranged in a substantially square array.

32. The optical reading apparatus of claim 30, wherein each sensor element comprises at least one pixel element.

33. The optical reading apparatus of claim 30, wherein the sensor elements of the sensor are arranged in a 1K×1K pixel array.

34. The optical reading apparatus of claim 30 wherein the pixel elements of the at least one sensor are arranged in an array comprising columns and rows of pixels, each row having a same number of pixel elements as each column.

35. The optical reading apparatus of claim 30 having a horizontal resolution and a vertical resolution, the horizontal resolution being substantially the same as the vertical resolution.

36. The optical reading apparatus of claim 30, further including an optical processor for processing the machine readable code using an electrical signal proportional to the illumination level received from the sensor, the optical processor structured to convert the electrical signal into output data.

37. The optical reading apparatus of claim 36, further including a data processing unit coupled with the optical processor, the data processing unit including a processing circuit for processing the output data to produce data representing the machine readable code.

38. The optical reading apparatus of claim 30, wherein the optical reading apparatus can read machine readable codes information selected from the group consisting of: optical codes, one-dimensional symbologies, two-dimensional symbologies and three-dimensional symbologies.

39. The apparatus of claim 30 further comprising a frame locator means for directing the sensor to an area of interest in the target image field.

40. The apparatus of claim 30 wherein the data processing unit further comprises an integrated function means for high speed and low power digital imaging.

41. The apparatus of claim 37 wherein the optical assembly further includes an image processing means having auto-zoom and auto-focus means controlled by the data processing unit for determining an area of interest at any distance, using high frequency transition between black and white.

42. The apparatus of claim 37 wherein the data processing unit further comprises a pattern recognition means for global feature determination.

43. The apparatus of claim 30 wherein the optical processor includes an analog to digital converter circuit.

44. An optical reading apparatus for reading image information selected from a group consisting of optical codes, one-dimensional symbologies, two-dimensional symbologies and three-dimensional symbologies, the image information being contained within a target image field, the optical reading apparatus comprising:
a light source means for projecting an incident beam of light onto the target image field;
an optical assembly means for focusing the light reflected from the target field at a focal plane;
a substantially square sensor means for sensing an illumination level of the focused reflected light;
an optical processing means for processing the sensed target image to an electrical signal proportional to the illumination level received from the substantially square sensor and for converting the electrical signal into output data, the output data describing a multi-bit illumination level for each pixel element corresponding to discrete points within the target image field;
a logic device means for receiving data from the optical processing means and producing target image data; and
a data processing unit coupled with the logic device for processing the targeted image data to produce decoded data or raw data representing the image information.

45. The optical reading apparatus of claim 44, wherein the sensor means comprises a plurality of sensor elements arranged in a substantially square array.

46. The optical reading apparatus of claim 44, wherein each sensor element comprises at least one pixel element.

47. The apparatus of claim 44, wherein the sensor means comprises a plurality of pixel elements arranged in a 1K×1K pixel array.

48. The optical reading apparatus of claim 44 wherein the pixel elements of the at least one sensor are arranged in an array comprising columns and rows of pixels, each row having a same number of pixel elements as each column.

49. The optical reading apparatus of claim 44 having a horizontal resolution and a vertical resolution, the horizontal resolution being substantially the same as the vertical resolution.

50. An optical image reading apparatus comprising:
at least one sensor, the sensor including a plurality of pixel elements, the pixel elements arranged in a first substantially circular configuration;
an optical processor structured to convert the electrical signal into output data;
an image processor structured to receive the output data; and
a data processing unit structured to produce data representative of information located in an image, the data processing unit being responsive to the output data.

51. The apparatus of claim 50, further comprising a second substantially circular configuration of the pixel elements, the second substantially circular configuration positioned in concentric relation to the first substantially ring shaped configuration, forming two concentric circles.

52. The apparatus of claim 50, further comprising a plurality of substantially circular configurations of the pixel elements, arranged concentrically with respect to each other.

53. The apparatus of claim 50 wherein:
the image comprises machine readable code; and
the output data corresponds to the machine readable code.

54. An optical image reading apparatus comprising:
at least one sensor, the sensor including a plurality of pixel elements, the pixel elements arranged in a substantially rectangular configuration;
a data processing unit structured to produce data representative of information located in an image, the data processing unit being responsive to the output data.

55. The apparatus of claim 50 wherein:
the image comprises machine readable code; and
the data representative of information contained in the image to the machine readable code.
